(19) United States
(12) Patent Application Publication
(10) Pub. No.: US 2017/0210773 A1
(43) Pub. Date: Jul. 27, 2017

(54) Synthesis of Metal Carboxylate Compounds

(71) Applicants: Erika Vreeland, Albuquerque, NM (US); Dale Huber, Albuquerque, NM (US); Gretchen Schober, Clemson, SC (US); SENIOR SCIENTIFIC LLC, Albuquerque, NM (US)

(72) Inventors: Erika Vreeland, Albuquerque, NM (US); Dale Huber, Albuquerque, NM (US); Gretchen Schober, Clemson, SC (US); Andrew Price, Dublin, CA (US)

(21) Appl. No.: 15/328,362

(22) PCT Filed: Jun. 1, 2015
(86) PCT No.: PCT/US15/33514

§ 371 Date: Jan. 23, 2017

Related U.S. Application Data
(60) Provisional application No. 62/006,323, filed on Jun. 2, 2014.

(51) Int. Cl. C07F 15/02; C01G 49/02

(52) U.S. Cl. CPC C07F 15/025; C01G 49/02; C01P 2004/64; C01P 2004/04; C01P 2006/42; B82Y 30/00

(57) ABSTRACT

A method of producing a metal carboxylate compound, comprising (a) combining an organometallic compound with a stoichiometric excess of carboxylic acid; (b) heating the combination to a temperature sufficient to lead to thermal decomposition of the organometallic compound, until the metal carboxylate compound is formed; (c) cooling the combination.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### TECHNICAL FIELD

The present invention is related to the synthesis of metal carboxylate compounds, such as are commonly used as precursors in the synthesis of organometallic compounds.

### BACKGROUND ART

Nanoscience encompasses an emerging area of research concerning the study of objects with dimensions ranging from 1-100 nanometers. Nanoscale phenomena are not new to either nature or science, but recent advances in instrumentation and analytical techniques have provided scientists with the tools required to understand and exploit their behavior. In essence, these phenomena are based on quantum effects that reflect the properties of atoms and molecules that are obscured by classical behavior of materials at the macroscopic level. These effects, combined with physical effects such as a high surface-to-volume ratio, produce chemical, mechanical, electronic, optical, and magnetic properties unique with respect to those seen in the bulk material. Thus, a great deal of research has been devoted to controlling the size, morphology, structure, and composition of nanomaterials as a mechanism for tuning their unique properties. Nanomaterials have found broad applications in catalysis, fuel cells, photonics, pollution remediation, and biotechnology, among others.

Organometallic compounds are used extensively in materials science, including the fabrication of optoelectronic and microelectronic devices, as well as a number of nanoscale materials. Thermal decomposition of metal carboxylate precursors is common for the synthesis of metal or metal oxide compounds that comprise these materials. In spite of their utility, metal carboxylate precursor compounds are not commercially available and must be custom synthesized for this purpose. The standard reaction to form a metal carboxylate involves mixing of carboxylate and metal salts followed by a number of purification steps. Because carboxylate anions bind to metal atoms through a number of coordination schemes, a variety of possible stoichiometries result. Further, the resultant material resists crystallization, making purification challenging and resulting in a compound lacking a precisely quantifiable amount of metal species. Batch-to-batch differences in the metal carboxylate precursor can dramatically impact the quality and reproducibility of synthesized materials.

### DESCRIPTION OF INVENTION

The present invention provides a novel, solution-based synthesis for metal carboxylate compounds that requires no additional purification steps and results in a material with a known quantity of metal species. Subsequent use of this precursor eliminates the variability introduced by the composition, purity, and stoichiometry of the conventionally prepared metal carboxylate precursor, thus offering a significant improvement in the quality and reproducibility of the resulting materials.

An organometallic compound is combined with a stoichiometric excess of carboxylic acid. The mixture is heated to a temperature required for thermal decomposition of the particular organometallic compound under a nitrogen atmosphere with vigorous stirring. The liberated iron cations combine with the carboxylate anions and the metal carboxylate compound is formed in situ. Upon formation of the compound, the mixture is allowed to cool to room temperature and can be used without further purification or handling. Formation of the metal carboxylate is verified using Fourier Transform Infrared Spectroscopy (FTIR).

An example embodiment of the present invention provides a method of producing a metal carboxylate compound, comprising: (a) combining an organometallic compound with a stoichiometric excess of fatty acid; (b) heating the combination to a temperature sufficient to lead to thermal decomposition of the organometallic compound, until the metal carboxylate compound is formed; (c) cooling the combination. In an example embodiment, step (b) can be performed under a nitrogen atmosphere. In an example embodiment, wherein step (b) can be performed with vigorous stirring. In an example embodiment, step (b) can be performed with vigorous stirring. In an example embodiment, the method can further comprise monitoring the temperature of the combination. In an example embodiment, the method can further comprise controlling the temperature of the combination responsive to the monitored temperature. In an example embodiment, the monitoring and control can be performed continuously. In an example embodiment, the monitoring and control can be performed in real time. In an example embodiment, the combination is heated to a temperature below the temperature at which the compound would undergo further decomposition. An example embodiment provides a method of producing an organometallic compound, comprising producing a metal carboxylate compound according to the previously mentioned methods, and then producing the organometallic compound using the metal carboxylate compound. An example embodiment provides a method of producing metal oxide nanoparticles, comprising producing a metal carboxylate compound according to the the previously mentioned methods, and then producing the metal oxide nanoparticles using the metal carboxylate compound. In an example embodiment, producing the metal oxide nanoparticles comprises continuous addition of the metal carboxylate compound until a desired nanoparticle size is attained. In an example embodiment, the method can further comprise monitoring the size of the nanoparticles as the metal carboxylate compound is added.

### BRIEF DESCRIPTION OF THE DRAWINGS

The accompanying drawings, which are incorporated in and form part of the specification, illustrate the present invention and, together with the description, describe the invention.

FIG. 1 is an illustration of the LaMer mechanism.

FIG. 2 Left: schematic illustration of the diffusion layer near a nanoparticle (NP) with the dashed line indicating the diffusion layer of thickness δ. Right: The plot of the monomer concentration as a function of x.

FIG. 3 is an illustration of the magnetic moment of a diamagnetic material.

FIG. 4 is an illustration of the magnetic moment of a paramagnetic material.

FIG. 5 is an illustration of magnetic dipole alignments.

FIG. 6 is an illustration of the magnetic anisotropy energy of a single domain particle with uniaxial anisotropy as a function of magnetization direction.

FIG. 7 is an illustration of Néel relaxation (τN) and Brownian relaxation (τB) for Fe3O4 nanoparticles in water.

FIG. 8 illustrates primary coordination modes between a carboxylate anion and a metal cation.

FIG. 9 illustrates the effect of water on the stoichiometry of iron(III) carboxylate.

FIG. 10 is an illustration of experimental apparatus.

FIG. 11 shows FTIR spectra of a) conventional iron(III) oleate, and anhydrous iron (III) oleate b) before and c) after atmospheric exposure.

FIG. 12 shows raw SAXS data and fits for samples corresponding to Table 6. a) Sample 1, b) Sample 2, c) Sample 3.

FIG. 13 shows TEM images and accompanying histograms for samples corresponding to Table 6.

FIG. 14 shows Raw SAXS data and fits for samples corresponding to Table 7. a) Sample 1(a), b) Sample 1(b), c) Sample 1(c).

FIG. 15 shows TEM images and accompanying histograms for samples corresponding to Table 7. a) Sample 1(a), b) Sample 1(b), c) Sample 1(c). The scale bars represent 20 nm.

FIG. 16 shows characteristic carbonyl and carboxylate stretches are visible in the region from 1800-1300 cm^{-1.}

FIG. 17 illustrates a reaction scheme for the formation of iron oxide nanoparticles by the heating and decomposition of the iron precursor, Fe(acac)3; the formation and consumption of an iron oleate intermediate; the formation of oleic acid-stabilized iron oxide nanoparticles.

FIG. 18 shows FTIR spectra of collected aliquots from 3400 cm⁻¹-700 cm⁻¹.

FIG. 19 shows a) Selected IR absorbance of successive reaction aliquots.

FIG. 20 shows a) TEM image of particles isolated from aliquot 16 and b) the accompanying TEM size distribution.

FIG. 21 shows raw SAXS data of particles isolated from aliquot 16 and the fit used to obtain the volume average diameter of 21.0 nm and dispersity of 15.9%.

FIG. 22 shows a) representative TEM image of synthesized iron oxide nanoparticles and b) the accompanying TEM size distribution.

FIG. 23 shows raw SAXS data of particles isolated from a reaction with no aliquots withdrawn and the fit used to obtain the volume average diameter of 27.0 nm and dispersity of 12.2%.

FIG. 24 shows an HRTEM image showing several single crystalline particles with parallel lattice planes extending through the particle, while others appear to be polycrystalline.

FIG. 25 shows XRD diffractograms of a) as-synthesized particles composed predominantly of Fe1−xO with small Fe3O4 peaks and b) oxidized nanoparticles showing the disappearance of the Fe1−xO phase and the emergence and growth of Fe3O4 peaks.

FIG. 26 shows a) Magnetization curves of unoxidized and oxidized particles at 293K. The near quadrupling of the σₛₐₜ reflects conversion of the Fe1−xO particles to Fe3O4 following oxidation. b) ZFC/FC magnetization curves for particles with an applied field of 10 Oe.

FIG. 27 shows the growth of nanoparticles as measured using SAXS.

FIG. 28 shows the raw SAXS data.

FIG. 29 shows TEM images for aliquots taken during particle formation and subsequent growth.

FIG. 30 shows the evolution of particle circularity with reaction time.

FIG. 31 shows the change in the aspect ratio of the particles as the reaction progresses.

FIG. 32 shows the temperature profile for the experiment.

FIG. 33 shows an example embodiment for the “Extended” LaMer Mechanism.

FIG. 34 shows IR spectra of iron oleate precursor material prepared with 0.94M, 0.62M, and 0.32M Fe(acac)3.

FIG. 35 shows a growth curve of iron oxide nanoparticles as measured using SAXS.

FIG. 36 shows the change in standard deviation of particle size as a function of reaction time.

FIG. 37 is an HRTEM image of 20 nm iron oxide nanoparticles.

FIG. 38 shows a growth curve of iron oxide nanoparticles as a 0.22M Fe solution is injected (blue) and then exchanged for a 0.33M Fe solution.

FIG. 39 shows Particle growth curves using increasing precursor addition rates: a) 1.5 mL/hr, b) 3.0 mL/hr, c) 6.0 mL/hr. Particle growth is fastest at a 3.0 mL/hr addition rate and slowest at a 6.0 mL/hr addition rate.

FIG. 40 shows particle growth when no oleic acid is present in the reaction flask.

FIG. 41 shows ∫sat and T_{B} for aliquot numbers 1 (10.21 nm), 5 (15.32 nm), and 11 (20.01 nm).

FIG. 42 shows temperature profile for a typical reaction with continuous addition of precursor.

FIG. 43 is a schematic drawing of heating source used for molten metal bath.

FIG. 44 is an illustration of a brass heating block heated by three cartridge heaters.

### MODES FOR CARRYING OUT THE INVENTION AND INDUSTRIAL APPLICABILITY

The properties of magnetic nanoparticles vary dramatically with size, so reproducibly controlling size is critical for practical applications. This is particularly true when moving into clinical settings, where regulatory approval requires demonstrated reproducibility in efficacy that can only be achieved with excellent size control.

A number of methods for the synthesis of magnetic nanoparticles have been published, although the thermal decomposition of iron(III) precursors in organic solvents has been shown to yield high quality particles with low shape and size dispersity. Currents methods lack reproducibility resulting from non-stoichiometric starting materials, and reliance on reaction parameters, such as temperature ramp rate, that are nearly impossible to replicate between syntheses. Limited control of particle size has been demonstrated, though no truly size-tunable synthetic method has been proposed. The present description removes the sources of reproducibility in the existing methods and achieve size control of synthesized particles while maintaining narrow shape and size dispersity. Further, it can facilitate understanding of the physical mechanisms by which the control of size is achieved.

The present invention provides two approaches to the synthesis of an iron(III) precursor containing a known quantity of iron. These materials are further evaluated for use in the preparation of high quality iron oxide nanoparticles with high magnetic saturation values. Existing synthesis methods are also evaluated, leading to the development of a novel synthetic method that yields tunability of sizes over a broad range with nanometer precision and nearly uniform size and shape dispersity. By manipulating reaction parameters such as temperature and reagent concentration, the kinetics of the reaction can be controlled, revealing new insights into the growth of particles in a highly supersaturated monomer solution.

The following symbols are used in the description.

| Symbol | Unit | Property |
|---|---|---|
| a | Å | lattice parameter |
| A | | the pre-exponential factor in the Arrhenius |
| | | equation |
| B | T | magnetic induction |
| χ | dimensionless | volume susceptibility |
| χρ | cm³/kg | mass susceptibility |
| C | cm³ · K/g | Curie constant per unit mass |
| C | mol/L | concentration |
| | C_{O} | the equilibrium concentration of the monomer |
| | | species in the bulk crystal |
| | C_{b} | the concentration of monomer in bulk solution |
| | Cᵢ | the concentration of the monomer species at the |
| | | liquid/solid interface |
| | C_{∞} | the solubility of a bulk crystal with infinite |
| | | dimensions |
| | Cₘₐₓ | In the LaMer mechanism, this is supersaturation |
| | | limit |
| | Cₘᵢₙ | In the LaMer mechanism, this represents the |
| | | critical supersaturation limit required for |
| | | nucleation to occur |
| | Cᵣ | the solubility of a particle with radius r |
| | Cₛ | In the LaMer mechanism, this is the lower |
| | | solubility limit of the monomer species |
| δ | nm | diffusion layer thickness |
| d | nm | diameter |
| dₚ | μm | in ATR, the penetration depth of the evanescent |
| | | wave into the sample |
| D | cm²/s | temperature dependent diffusion coefficient |
| Eₐ | J | activation energy |
| V | J/m² | surface energy per unit area of a particle surface |
| ΔG | J/mol | the free energy change within a system |
| | ΔG_{V} | the difference between the free energy of the |
| | | monomer in the nucleus and in the solution |
| η | Pa · s | dynamic viscosity |
| H | A/m | magnetic field (strength), sometimes given as |
| | | μ0H in tesla (T) |
| | H_{C} | coercive field |
| I | various units | intensity |
| J | mol/m² | in Fick's law, this is the flux of monomer |
| | | through the diffusion layer |
| k_{B} | J/K | Boltzmann constant |
| k_{d} | s⁻¹ | rate constant for a simple first order deposition |
| | | reaction |
| K | J/m³ | anisotropy constant |
| K_{D} | m³/s | the LSW theory describing diffusion controlled |
| | | growth, this is a |
| | | $\frac{8 γ {DV}_{m}^{2} {C}_{∞}}{9 RT}$ |
| | | constant given by |
| Kᵣ | m²/s | in the LSW theory describing surface reaction |
| | | limited growth, this is |
| | | $\frac{2 γ {V}_{m}^{2} {C}_{∞}}{RT}$ |
| | | a constant given by |
| λ | Å | electromagnetic wavelength |
| μ | J/mol | chemical potential |
| | μ° | the chemical potential of the bulk crystal |
| | η(r) | chemical potential of a particle with radius r |
| μ0 | Dimensionless | permeability |
| | in cgs units | |
| m | A · m² | magnetic moment |
| M | A/m, G | magnetization |
| | M_{R} | remnant magnetization |
| | M_{S} | saturation magnetization |
| v | cm⁻¹ | vibrational frequency, wavenumber |
| n | | refractive index |
| N | | nuclei |
| θ | degrees | angle of incidence |
| | θ_{C} | critical angle in ATR |
| q | 1/Å | scattering vector |
| ρ | g/mL | density |
| r | nm | radius |
| | r | mean particle radius |
| | r* | the critical nucleus size |
| | r_{b} | the particle radius in equilibrium with the bulk |
| | | solution |
| R | J/mol · K | universal gas constant |
| ∫ | A · m²/kg | magnetization per unit mass |
| | ∫sat | saturation magnetization per unit mass |
| τ0 | s | attempt time |
| τB | s | Brownian relaxation time |
| τN | s | Neel relaxation time |
| t | s, min, h | time |
| T | K, ° C. | temperature (K) |
| | T_{B} | blocking temperature |
| | T_{C} | Curie temperature |
| | T_{N} | Neel temperature |
| V | nm³, m³ | volume |
| | Vₕ | hydrodynamic volume |
| Vₘ | m³/mol | Molar volume of a monomer species |
| x | nm | distance |

The following abbreviations are used in the description.

| Abbreviation | Meaning |
|---|---|
| ATR | attenuated total reflectance |
| CVD | chemical vapor deposition |
| DC | direct current |
| DTGS | deuterated triglycine sulfate pyroelectric IR detector FC |
| FC | field-cooled magnetization |
| Fe1 − xO | wustite |
| γ-Fe2O3 | maghemite |
| Fe3O4 | magnetite |
| Fe(acac)3 | Iron(III) acetylacetonate |
| FTIR | Fourier transform infrared spectroscopy |
| GATR | grazing angle attenuated total reflectance |
| HRTEM | high resolution transmission electron microscopy |
| ICDD | International Center for Diffraction Data |
| IR | infrared |
| LSW | Lifshitz-Slyozov-Wagner theory |
| MRI | magnetic resonance imaging |
| PID | proportional-integral-derivative controller |
| SAXS | small angle X-ray scattering |
| SQUID | superconducting quantum interference device |
| TEM | transmission electron microscopy |
| XRD | X-ray diffraction |
| ZFC | zero-field cooled magnetization |

Nanoscale magnetite possesses unique magnetic properties that have found particular utility in biomedical research. Ultimately, the physicochemical properties and resulting usefulness of the particles depends strongly on their size. Achieving precise shape and size control of the particles presents a challenge, but improvements to the state of the art have the potential to significantly improve their practical use, particularly in biomedical diagnostics.

A number of routes for the synthesis of magnetic nanoparticle have been published, although only the most representative examples will be presented here. The methods generally fall into one of three categories: particle size reduction in the solid phase, vapor phase synthesis, or liquid phase synthesis. Particular focus will be given to those methods that are reported to yield nanomaterials with uniform shape and size dispersity. For clarity, NIST defines a population of nanoparticles as monodisperse if at least 90% of the distribution lies within 5% of the median size. However, the Polymer Division of IUPAC regards the term “monodispersed” as a self-contradictory term and “polydisperse” as redundant. The description of particle size distribution will be referred to herein as size dispersity, in accordance with the IUPAC recommendations.

In the solid phase, high-energy ball milling can be used for the generation of magnetic, catalytic, and structural nanoparticles. While this process benefits from scalability for large scale manufacturing of nanoparticles, common drawbacks include low surface area, high size dispersity, and the partially amorphous state of the as-prepared powders.

Vapor phase syntheses include chemical vapor deposition (CVD) and aerosol spray methods such as spray pyrolysis. CVD synthesis is used to deposit thin films of Fe3O4 for use in spintronic devices such as magnetic tunnel junctions and magnetoresistive sensors. In the spray pyrolysis technique, a precursor solution is dispersed as droplets into a carrier gas and then sprayed into a drying chamber. The drying chamber is heated above the vaporization temperature of the carrier solvent, and solid particles are collected. A number of ordered porous metal oxide particles have been prepared using this method, including iron oxides, silica, titania, alumina, zirconia, and yttria. The scalability and high purity yield make spray pyrolysis an attractive option for high throughput manufacturing applications, but because the rate of particle formation cannot be easily controlled, aggregation of particles and a large size dispersity often result.

Several solution methods have been reported for synthesis of high quality magnetite nanoparticles, some of the most common being aqueous co-precipitation, microemulsion, hydrothermal synthesis, and thermolysis.

Aqueous co-precipitation offers a facile, room temperature method for synthesizing iron oxide nanoparticles by aging a stoichiometric mixture of ferrous and ferric salts in aqueous media under basic conditions. This synthesis can yield a large amount of material, and some control over particle size and shape has been demonstrated by adjusting pH, ionic strength and the concentration of the growth solution. However, particles prepared in this fashion tend to have a high degree of asphericity and large size dispersity, making this approach unattractive for the purposes described previously.

The microemulsion technique offers synthesis of nanoparticles in a controlled manner. Microemulsions are stable dispersions containing two immiscible phases that are separated by an interfacial surfactant layer. A water-in-oil microemulsion is made up of water droplets surrounded by a surfactant and dispersed in oil, forming an inverse micelle. The size of the inverse micelle is determined by the molar ratio of water to surfactant, and can form spherical, oblate, or tubular shapes. For the synthesis of nanoparticles, two water-in-oil microemulsions, one containing a metal salt and the other a reducing agent, are combined. Upon mixing, the continuous collision, coalescence, and separation causes precipitation of the metal salt, the formation of nuclei, and the growth of particles. The primary drawbacks of the microemulsion technique are the inability to systematically control nanoparticle size and the low product yield.

Under thermolytic conditions, particles can be synthesized by combining the precursor, solvent, and a stabilizing surfactant in a Teflon-lined, stainless-steel autoclave and performing a high temperature, high pressure reaction. The reaction is conducted above the boiling point of the solvent and the temperature, and typically maintained for 8-72 hours. Shape and size control can be accomplished by altering the surfactant used, but synthesized particles generally suffer from high size dispersity.

Formation of metal oxide nanoparticles by thermolysis provides an approach by which very good shape and size control, along with narrow size dispersity, can be achieved. The precursor is either an inorganic metal salt or an organometallic compound such as a metal carboxylate or acetylacetonate. Thermal decomposition of the metal precursor occurs in a high boiling point solvent, often at temperatures at or above 300° C. Control of nanoparticle morphology, size, and size dispersity is determined by the surfactant used in the system. Typically, long-chain fatty acid molecules prevent agglomeration during synthesis and result in good colloidal stability of the product in organic solvents. There are a number of advantages to thermolytic synthesis, including good crystallinity, narrow size distribution, and shape control.

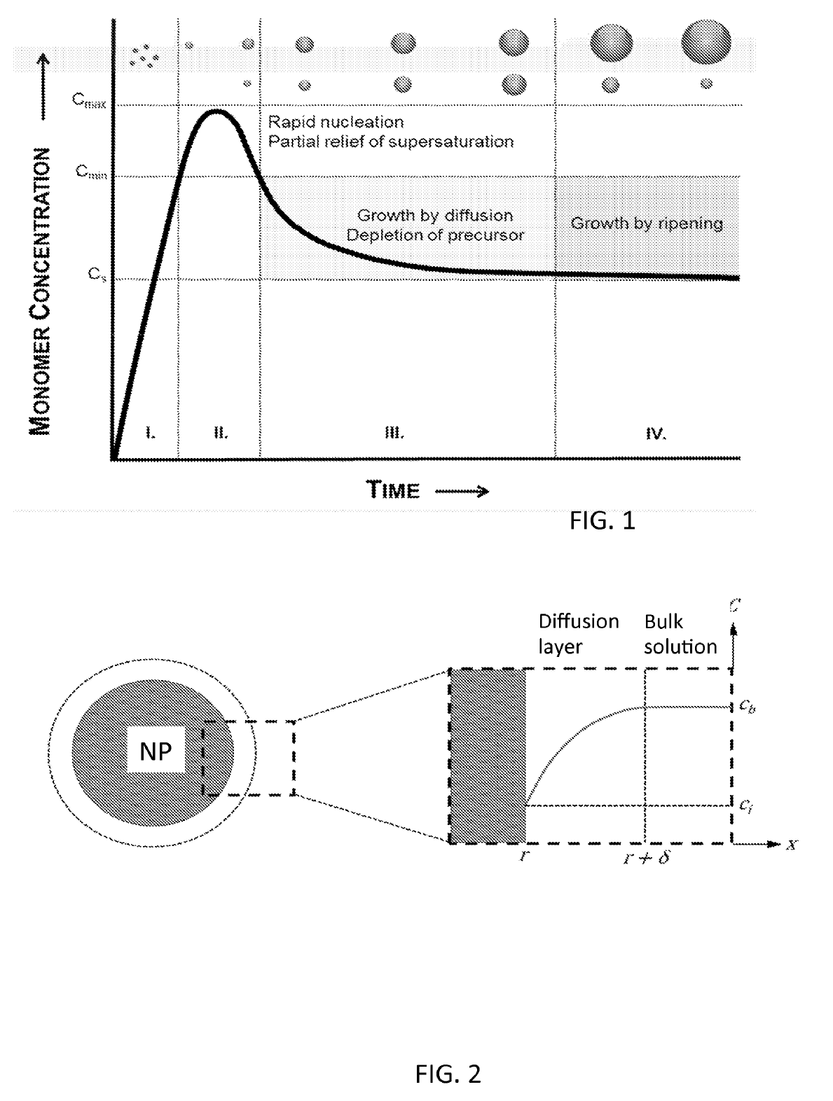

In 1950, LaMer and Dinegar introduced a mechanistic pathway to explain the formation and growth of elemental sulfur colloids. The ‘LaMer mechanism’ describes a closed system where nanoparticle formation and growth depends on monomer concentration. Distinct stages, corresponding to pre-nucleation, nucleation, and growth, can be identified. FIG. 1 illustrates the LaMer mechanism. In phase I, the concentration of monomer species increases until a critical supersaturation concentration (Cmin) is reached. Burst nucleation occurs in phase II, which partially relieves the supersaturation condition, and the concentration of monomer species drops below the nucleation threshold. In phase III, growth of the nuclei takes place by diffusion of the monomer species to the surface of the particle, until it is depleted, indicated by Cmin, the lower limit of solubility of the monomer in solution. In phase IV, additional particle growth takes place by ripening processes. The spheres above the diagram represent the evolution of particle size dispersity.

In phase I, the monomer species increases until a critical supersaturation limit (Cmin) is reached. In phase II, burst nucleation occurs, partially relieving the supersaturation condition and reducing the concentration of the monomer below the threshold for nucleation. In phase III, growth proceeds by diffusion of the monomer to the particle surface until the concentration of the monomer species reaches the lower limit of solubility.

The importance of the LaMer mechanism was that it established the requirement for temporal separation of the elementary steps of nucleation and growth to ensure low size dispersity. In other words, if the nuclei form in a single event of finite duration, and the system is well-mixed so that all nuclei experience the same concentration of monomer species as they grow, the system will have low size dispersity.

Stage IV in FIG. 1 incorporates the Ostwald ripening into the LaMer mechanism, illustrating the change in the particle suspension over time, whereby smaller particles dissolve and redeposit onto larger particles. The Ostwald ripening phenomenon describes the minimization of total interfacial energy that drives the competitive growth between particles of different sizes. The relation between the chemical potential of a particle and its radius is given by the Gibbs-Thomson equation. If μ° represents the chemical potential of the bulk crystal and μ(r) the chemical potential of a particle with radius r, their difference is Δμ:

$$Δμ = \frac{2 γ {V}_{m}}{r} \qquad ( equation 1 \text{-} 1 )$$

γ is the surface energy per unit area of the particle surface and Vm is the molar volume of the monomer species.

Equation 1-1 demonstrates mathematically the dominant role of surface energy with decreasing particle size, thus driving the dissolution of smaller particles in favor of growth of larger particles. While Ostwald ripening is one technique to increase the average size of particles in a sample, it is often undesirable compared to growth from a continuous flux of molecular precursors, as will be explored in the following sections.

FIG. 1 is an illustration of the LaMer mechanism. In phase I, the concentration of monomer species increases until a critical supersaturation concentration (Cmin) is reached. Burst nucleation occurs in phase II, which partially relieves the supersaturation condition, and the concentration of monomer species drops below the nucleation threshold. In phase III, growth of the nuclei takes place by diffusion of the monomer species to the surface of the particle, until it is depleted, indicated by Cs, the lower limit of solubility of the monomer in solution. In phase IV, additional particle growth takes place by ripening processes. The spheres above the diagram represent the evolution of particle size dispersity.

In a supersaturated solution, nucleation can be considered as the phase transition of a monomer from a supersaturated solution to a crystal. Because a supersaturated solution possesses a high Gibbs free energy, the overall energy of the system can be reduced by segregating the solute from solution by forming a second, solid phase and maintaining an equilibrium concentration in the solution. The change in free energy is based on two competing factors: the creation of surface energy, γ, per unit area of the particle surface and the change free energy per unit volume of the particle:

$$Δ G = 4 π {r}^{2} γ + \frac{4}{3} π {r}^{3} Δ {G}_{v} \qquad ( equation 1 \text{-} 2 )$$

The first term in equation (1-2) is always positive, while the second term is negative under conditions of supersaturation, providing the driving force for nucleation. ΔGV can be expressed as the difference between the free energy of the monomer in the nucleus and in the solution:

$$Δ {G}_{v} = \frac{RT ( {lnC}_{b} - {lnC}_{a} )}{{V}_{m}} \qquad ( equation 1 \text{-} 3 )$$

where Cb represents the concentration of the monomer in solution, C0 is the equilibrium concentration in the bulk crystal, and Vm is the molar volume of the monomer. When the concentration of the solute is not supersaturated (C≦C0), ΔGV is ≦0, and nucleation does not occur. When C>C0, ΔGV is negative and nucleation can take place spontaneously. However, the nucleus is only stable when its size is greater than the critical nucleus size, r*, with the following relationship between r*, ΔGV, and γ:

$${r}^{*} = \frac{2 γ}{Δ {G}_{v}} \qquad ( equation 1 \text{-} 4 )$$

In the synthesis and preparation of nanoparticles by nucleation from a supersaturated solution, the critical size (r*) represents the lower limit of a stable nanoparticle. By increasing the temperature and particularly the supersaturation the minimum size of the nuclei can also be decreased.

The rate of nucleation can then be written in the form of Arrhenius kinetics:

$$\frac{dN}{dt} = A exp [ - \frac{Δ {G}_{v}}{{k}_{B} T} ] \qquad ( equation 1 \text{-} 5 )$$

where N is the number of nuclei, A is the pre-exponential factor, k_{B} is the Boltzmann constant, and T is the temperature.

Following the nucleation event, the critical nuclei must gather monomer species from the surrounding matrix, requiring long-range diffusion from the solution to particle surface. When the kinetics of diffusion are the slowest step in the growth of the nanoparticles, the process is considered diffusion limited. The particle can then grow by incorporating atoms or molecules into its solid structure over a short range of molecular motion. In the case where the surface reaction kinetics are slower than the diffusion process, the growth of particles can be considered reaction limited. Here, a model for nanoparticle growth is developed using Fick's law of diffusion. Appropriate boundary conditions can then be applied to describe the growth kinetics in either diffusion or reaction limited growth.

In a supersaturated solution, assuming the monomer species is present in uniform concentration (Cb), it will diffuse from the bulk liquid phase to the surface of a particle with radius r through a diffusion layer to the liquid/solid interface (Ci), as shown in FIG. 2. In FIG. 2: Left: schematic illustration of the diffusion layer near a nanoparticle (NP) with the dashed line indicating the diffusion layer of thickness δ. Right: The plot of the monomer concentration as a function of x.

The flux of the monomer species through the diffusion layer can be described by Fick's law:

$$J = - D \frac{dC}{dx} \qquad ( equation 1 \text{-} 6 )$$

where J is the monomer flux and D is the temperature dependent diffusion coefficient given by D0 exp(−EA/kbT) in cm²/s.

The rate of diffusion of the monomer through a spherical surface with radius x within the diffusion layer is:

$$J = - 4 π {x}^{2} D \frac{dC}{dx} \qquad ( equation 1 \text{-} 7 )$$

At steady state, J is constant for all x. Dividing both sides by x², equation (1-7) can be integrated from r to r+δ and from Ci to Cb for the left and right hand sides, respectively gives

$$J = \frac{4 π Dr ( r + δ )}{δ} ( {C}_{b} … {C}_{i} ) \qquad ( equation 1 \text{-} 8 )$$

This consumption rate of the monomer at the surface of the particle with solubility Cr is equal to the monomer flux, as expressed by:

J=4πr²k_{d}(Cᵢ−Cᵣ) (equation 1-9)

where kd is the rate constant for a simple first order deposition reaction. By equating (1-8) with (1-9), Ci can be eliminated and a linear expression for the growth rate can be obtained assuming that dr/dt=JVₘ/4πr²:

$$\frac{dr}{dt} = \frac{\frac{D}{r} ( 1 + \frac{r}{δ} ) {V}_{m} ( {C}_{b} - {C}_{r} )}{1 + \frac{D}{{k}_{d} r} ( 1 + \frac{r}{δ} )} \qquad ( equation 1 \text{-} 10 )$$

where Vm is the molar volume of the monomer species.

The terms Cb and Cr are related to the particle radius, r, by the Gibbs-Thomson equation:

$${C}_{r} = {C}_{∞} exp ( \frac{2 γ {V}_{m}}{rRT} ) \approx {C}_{∞} ( 1 \vert + \frac{2 γ {V}_{m}}{rRT} ) \qquad ( equation 1 \text{-} 11 )$$

where C∞ is the solubility of a bulk crystal with infinite dimensions. R is the universal gas constant and T is the temperature. The expression on the right is obtained from the expansion of the exponential function and retention of the first two terms, assuming of a small value of 2γVm/rRT.

Similarly, Cb can be expressed as:

$${C}_{b} = {C}_{∞} exp ( \frac{2 γ {V}_{m}}{{r}_{b} RT} ) \approx {C}_{∞} ( 1 + \frac{2 γ {V}_{m}}{{r}_{b} RT} ) \qquad ( equation 1 \text{-} 12 )$$

here rb is the particle radius in equilibrium with the bulk solution.

Diffusion layers are typically on the order of microns, so the assumption can be made that r<<δ. Substituting (1-11) into (1-12) gives:

$$\frac{dr}{dt} = \frac{2 γ {V}_{m}^{2} {C}_{∞}}{RT ( \frac{1}{D} + \frac{1}{{k}_{D} r} )} \frac{( \frac{1}{{r}_{b}} - \frac{1}{r} )}{r} \qquad ( equation 1 \text{-} 13 )$$

Equation (1-13) can now be modified to develop a model of nanoparticle growth in the diffusion limited or reaction limited growth regime.

Lifshitz and Slyozov and Wagner developed a mathematical approach to account for the effect of Ostwald ripening on the evolution of particle size distribution where diffusion of the monomer species is the rate limiting step. Their combined work is well known as the Lifshitz-Slyozov-Wagner (LSW) theory, which describes the growth of non-interacting, spherical clusters in a supersaturated solution. In the diffusion limited growth regime, D<<kDr in equation (1-13), reducing it to:

$$\frac{dr}{dt} = \frac{2 γ {V}_{m}^{2} {C}_{∞}}{RT} \frac{( \frac{r}{{r}_{b}} - 1 )}{{r}^{2}} = {K}_{D} \frac{( \frac{r}{{r}_{b}} - 1 )}{{r}^{2}} \qquad ( equation 1 \text{-} 14 )$$

where KD is a constant, given by 2γDVₘ²C_{∞}/RT. The LSW theory assumes that the mass of the clusters is conserved, making r/rb a constant, giving:

$$\frac{dr}{dt} = \frac{{K}_{D} * constant}{{r}^{2}} \qquad ( equation 1 \text{-} 15 )$$

which can be solved to determine the dependence of particle size on time. Applying the boundary conditions that x=r0 at t=0 and x=r at t∞=t. This relationship is given by:

r³−rₒ=K_{D}t (equation 1-16)

where K is given by:

$${K}_{D} = \frac{8 γ {DV}_{m}^{2} {C}_{∞}}{9 RT} \qquad ( equation 1 \text{-} 17 )$$

The LSW theory provides a straightforward, yet robust approach to model the kinetics of particle growth, and has been applied to a diverse range of systems. This includes precipitate hardening in in Cu—Co and Ni—Fe alloys, growth of TiO₂ and ZnO semiconductor nanoparticles in solution, and sintering of supported Pd and Ni catalysts.

When incorporation of the monomer species into the structure of the particles is the slowest step in the growth process, kDr<<D and equation (1-13) becomes

$$\frac{dr}{dt} = \frac{2 γ {k}_{d} {V}_{m}^{2} {C}_{∞}}{RT} \frac{( \frac{r}{{r}_{b}} - 1 )}{{r}^{2}} = {K}_{R} \frac{( \frac{r}{{r}_{b}} - 1 )}{{r}^{2}} \qquad ( equation 1 \text{-} 18 )$$

Applying the same assumption that mass of the monomer is conserved, r/rb=1, and equation (1-18) can be reduced as before to give the dependence of particle size on time:

r²≈Kᵣt (equation 1-19)

where Kr is a constant, given by:

$${K}_{r} = \frac{2 γ {V}_{m}^{2} {C}_{∞}}{RT} \qquad ( equation 1 \text{-} 20 )$$

Since the diffusion-controlled growth is observed when the surface reaction rate constant is so high that the growth rate is limited by the diffusion rate of the solute to the particle, it is the growth mode with the maximum conceivable growth rate.

The diffusion limited growth rate of the nanoparticle radius derived in equation (1-14) can expressed in an equivalent form as:

$$\frac{dr}{dt} = \frac{{K}_{D}}{r} ( \frac{1}{{r}_{b}} - \frac{1}{r} ) \qquad ( equation 1 \text{-} 21 )$$

Under the assumption of a constant rb, the rate of change of the standard deviation of the size distribution, d(Δr)/dt, is:

$$\frac{d ( Δ r )}{dt} = \frac{{K}_{D} Δ r}{{\overline{r}}^{2}} ( \frac{2}{\overline{r}} - \frac{1}{{r}_{b}} ) \qquad ( equation 1 \text{-} 22 )$$

where r̅ is the mean particle radius. From this equation, it is apparent that the Gibbs-Thomson effect becomes negligible as particle size increases.

We then arrive at:

$$\frac{d ( Δ r )}{dt} > 0 for \frac{\overline{r}}{{r}_{b}} < 2 , \\ \frac{d ( Δ r )}{dt} \leq 0 for \frac{\overline{r}}{{r}_{b}} \geq 2. \qquad ( equation 1 \text{-} 23 )$$

Thus, under conditions of low supersaturation, the size distribution becomes broader, even when the growth of particles is occurring in the diffusion controlled mode. If supersaturation is kept sufficiently high, focusing of the size distribution will occur. For low size-dispersity in the diffusion controlled growth mode, supersaturation should be set as high as possible without exceeding the threshold for nucleation.

For the case of simple, first-order reaction-controlled growth of particles, equation (1-18) can be expressed as:

$$\begin{matrix}\frac{dr}{dt} = {K}_{R} ( \frac{1}{{r}_{b}} - \frac{1}{r} ) & ( equation 1 \text{-} 24 ) \\ and & \\ \frac{d ( Δ r )}{dt} = \frac{{K}_{D} Δ r}{{\overline{r}}^{2}} & ( equation 1 \text{-} 25 )\end{matrix}$$

From (1-25), it is apparent that d(Δr)/dt is positive for all r, so that an increase of the size distribution results from the Gibbs-Thomson effect, although it becomes less pronounced as r̅ increases. The size distribution is independent of rb, so the broadening effect will occur regardless of the level of supersaturation.

Clearly, it is preferable to choose the diffusion controlled growth mode for a given system, since a sharpening of the size distribution can be expected as long as a high level of supersaturation is maintained. In practice, however, particle growth may result from a combination of diffusion and reaction limited growth.

When a material is placed within a magnetic field, the magnetic forces of the electrons within a material will be affected, as described by Faraday's Law of magnetic induction. However, materials will respond quite differently to the external field based on their atomic and molecular structure. For instance, in most atoms, electrons occur in pairs. Because paired electrons spin in opposite directions, their magnetic fields cancel each other and little net magnetic moment exists. Alternatively, in materials with unpaired electrons, there will be a net magnetic moment and the material will have a greater response to an external field. Based on their behavior in an applied magnetic field, materials can be classified as diamagnetic, paramagnetic, ferromagnetic, antiferromagnetic, ferrimagnetic and superparamagnetic. Table 2 lists common magnetic units useful for this study. SI units will be used to describe magnetic properties in this work, but because cgs units are often reported in the literature, their equivalent units are also shown.

TABLE 2

| Magnetic Term | Symbol | SI Unit | CGS Unit | Conversion Factor |
|---|---|---|---|---|
| Magnetic | B | Tesla (T) | Gauss (G) | 1 T = 10⁴ G |
| induction | | | | |
| Magnetic field | H | A/m | Oersted (Oe) | 1 A/m = 4π/10³ Oe |
| Magnetization | M | A/m | emu/cm³ | 1 A/m = 10⁻³ |
| | | | | emu/cm³ |
| Mass | ó | A · m²/kg | emu/g | 1 A · m²/kg = 1 |
| Magnetization | | | | emu/g |
| Magnetic | m | A · m² | emu | 1 A · m² = 10³ emu |
| moment | | | | |
| Permeability | μ | dimen- | H/m, Wb/ | 4π × 10⁻⁷ |
| | | sionless | (A · m) | |
| Volume | χ | dimen- | dimen- | 4π (SI) = 1 (cgs) |
| susceptibility | | sionless | sionless | |
| Mass | χρ | m³/kg | emu/Oe · g | 1 m³/kg = 10³/4π |
| susceptibility | | | | emu/Oe · g |

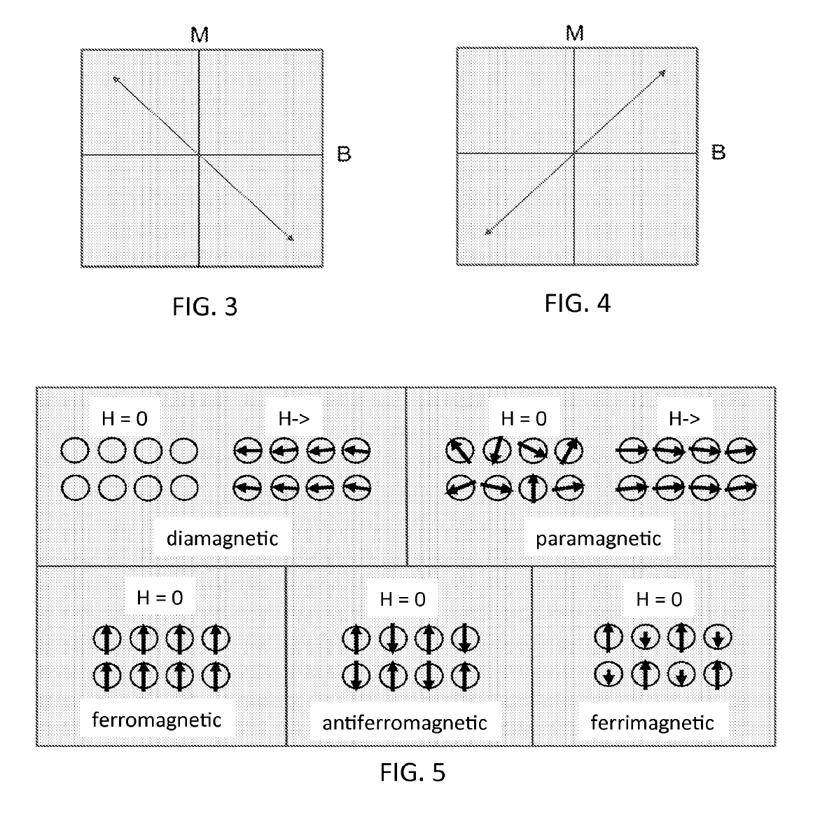

Diamagnetism results from the orbital motion of electrons; consequently, it occurs in all materials. However, the magnitude of the susceptibility (χ) is weak, and becomes insignificant in materials that exhibit other types of magnetism. For materials with closed electron shells, such as inert gases, many metals, most nonmetals, and many organic compounds, diamagnetic behavior is prominent. There is no permanent magnetic dipole moment in these materials, and they possess a small, negative χ that is caused by repulsion of an applied field by the orbital motion of the electrons, independent of temperature (FIG. 3 and FIG. 5). FIG. 3 illustrates that the magnetic moment of a diamagnetic material will slightly repel an applied field at all field strengths. FIG. 4 illustrates that the magnetic moment of a paramagnetic material is slightly attracted to an applied field.

Paramagnetism is observed in materials with unpaired electrons. Paramagnetic materials have a small, positive χ and some of the molecular moments will be slightly attracted to a magnetic field. However, there is no long-range ordering, and the material does not retain its magnetic properties upon removal of the field (FIG. 4 and FIG. 5). Unlike diamagnetism, the χ of paramagnetic materials varies inversely with temperature as described by the Curie law, where C is the Curie constant per gram

$$χ = \frac{C}{T} \qquad ( equation 1 \text{-} 26 )$$

Paramagnetic materials include liquid O₂, rare earth salts, and ferro- and ferrimagnetic materials above the Curie temperature, as described below.

Ferromagnetic materials have a large, positive susceptibility to magnetic fields. They exhibit a strong attraction to magnetic fields and unlike diamagnetic and paramagnetic materials, are able to maintain long-range ordering after the external field is removed. Ferromagnetic materials have some unpaired electrons, so their atoms have a net magnetic moment. Under an applied field below the Curie temperature (TC), the magnetic moments align in parallel, resulting in a strong net magnetic moment (FIG. 5). Above TC, the spins possess the thermal energy to overcome their long range ordering and assume random orientation, yielding paramagnetic behavior. Iron, nickel, and cobalt are some examples of ferromagnetic materials.

Antiferromagnetic materials have a small, positive susceptibility that varies as a function of temperature with a maximum at the Néel temperature (TN). Below TN, the magnetic moments align in a more or less antiparallel arrangement. The tendency to assume the antiparallel arrangement becomes stronger as the temperature is lowered below TN, until at 0K, the antiparallel arrangement is perfect, as depicted in FIG. 5. Antiferromagnetic ordering disappears above TN, where there is sufficient thermal energy to allow the spins to orient randomly, and the material exhibits paramagnetic behavior. There are a large number of antiferromagnetic materials that are often ionic compounds of oxides, sulfides, chlorides, etc.

Ferrimagnetism is similar to antiferromagnetism, in that the magnetic spins oppose each other. However, because the moments of the spins have different magnitudes, they only partially cancel each other out and the material has a net magnetic moment (FIG. 5). As observed in ferromagnetic and antiferromagnetic materials, above TC, thermal energy permits randomization of the spins, and the material becomes paramagnetic. Ferrites have the general formula MO.Fe₂O₃, where M represents Fe, Ni, Mn, Cu, or Mg. FIG. 5 is an illustration of the magnetic dipole alignments described in the text in the presence or absence of an external magnetic field (H).

Superparamagnetism differs from ferro- and ferrimagnetism in that is purely a nanoscale effect. It is observed only particles that are small enough to have a single magnetic domain, unlike the corresponding bulk material, which is made up of many magnetic domains. The maximum size of the magnetic domain depends on the material, but is generally on the order of tens of nanometers.

Superparamagnetism describes the state when there is sufficient thermal energy to overcome the energy barrier to reversal of the magnetic moment on the timescale of the experiment. When the energy barrier is large with respect to the thermal energy, the magnetization is “blocked” and the probability of a spontaneous reversal is negligible. When the energy barrier is low, thermal excitations can result in the reversal of magnetization on very short timescales.

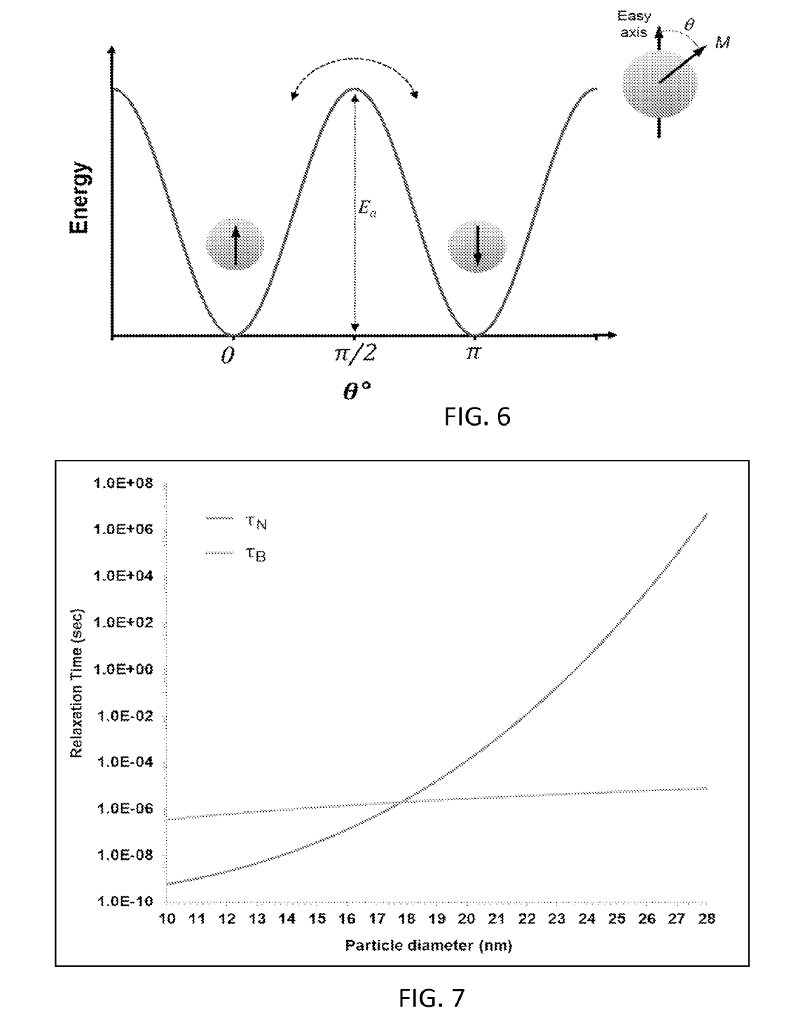

Assuming a uniaxial particle, there are two energy minima with antiparallel orientation separated by an energy barrier, Ea (FIG. 6). The crystallographic axis that represents these energy minima is referred to as the easy axis. The magnetic energy is minimized when the particle's magnetization vector is aligned with the easy axis, and increases with the tilt angle between the magnetization vector and the easy axis. FIG. 6 illustrates the magnetic anisotropy energy of a single domain particle with uniaxial anisotropy as a function of magnetization direction. Ea is the energy barrier to reversal of the magnetization and θ is the tilt angle between the magnetization vector and the easy axis.

The energy barrier, Ea, separating the energy minima at θ=0 and θ=π is termed the anisotropy energy (Ea), and is proportional to the product of the nanoparticle volume V, and the anisotropy constant, K:

Eₐ=KV (equation 1-27)

The timescale on which particle or ensemble of particles can experience a magnetization reversal follows Arrhenius kinetics and is given by the Néel-Brown equation:

$${τ}_{N} = {τ}_{0} exp ( \frac{{E}_{a}}{{k}_{B} T} ) \qquad ( equation 1 \text{-} 28 )$$

where τN is referred to as the Néel relaxation time, τ0 is the attempt time, generally taken to be 10⁻⁹ seconds, k_{B} is the Boltzmann energy, and T is the absolute temperature. τN is very sensitive to the size of the nanoparticle, so with increasing particle size, the energy barrier to magnetic reversal, Ea, will be dominant over thermal contributions, k_{B}T. For small nanoparticles, thermally activated reorientation of the spins away from the easy axis is no longer negligible. Equation (1-28) can be rearranged to solve for the critical temperature that defines the point at which thermal energy allows random reorientation of the spins:

$${T}_{B} = \frac{KV}{ln ( \frac{τ}{{τ}_{0}} ) {k}_{B}} \qquad ( equation 1 \text{-} 29 )$$

T_{B} is the blocking temperature, and is the transition point between ferro- or ferri-magnetic behavior and superparamagnetism. The “super” part of superparamagnetism arises from the net magnetic dipole of the entire particle that is actually greater than the sum of its individual electrons in response to an applied external field. This is in contrast to paramagnetism, as described previously, where only the small moments of single ions align with an applied field. Superparamagnetic materials lack remnant magnetization, so when the external field is removed, the spins relax to a random state and the net magnetic moment is zero.

Iron oxides are varied and widespread in nature. They have served as pigments, catalysts, and precursors in the formation of iron and steel. Wüstite contains only divalent Fe cations and crystallizes in the sodium chloride structure. The unit cell edge length is a=0.430 nm, with four formula units per cell. Vacancies in the Fe site result in a non-stoichiometric compound with the general formula Fe1−xO. Fe1−xO is antiferromagnetic below its T_{N} of ˜198 K. Under ambient conditions, Fe1−xO exists as a metastable compound that can be converted to α-Fe and magnetite (Fe₃O₄) through disproportionation or oxidation.

Fe₃O₄is the most magnetic of all the naturally occurring minerals on Earth. At room temperature and standard atmospheric pressure, magnetite has a face-centered cubic inverse spinel structure with 32 O²⁻ ions in a cubic close packed arrangement, with divalent and trivalent Fe cations occupying interstitial tetrahedral and octahedral sites. 16 Fe³⁺ ions are equally divided between the tetrahedral, or “A” sites and octahedral, or “B” sites. 8 Fe²⁺ ions occupy the octahedral or “B” sites^{63, 68}. At room temperature, an electron can hop between Fe²⁺ and Fe³⁺ ions in the octahedral sites, imparting a half-metallic property to magnetite. The magnetic moment of the unit cell is contributed only by Fe²⁺ ions. The unit cell edge length is a=0.839 nm, with eight formula units per cell. Above temperatures of about 122K, Fe3O4 undergoes a Verwey transition, characterized by a lattice distortion as well as an increase in conductivity attributed to electron hopping processes between Fe²⁺ and Fe³⁺ ions^{70, 71}. Fe3O4 is a ferrimagnetic material that can exhibit superparamagnetism on the nanoscale where particles with single magnetic domains can be synthesized. The upper limit for superparamagnetism in spherical Fe3O4 particles with uniaxial anisotropy is approximately 80 nm. The mass saturation magnetization for bulk Fe3O4 is at 92 A·m²/kg at 293K.

Maghemite γ-Fe2O3 has a structure very similar to Fe₃O₄, with a cubic unit cell length of a=0.834 nm. γ-Fe₂O₃ is made by oxidizing magnetite:

$$2 {Fe}_{3} {O}_{4} + \frac{1}{2} {O}_{2} -> 3 {Fe}_{2} {O}_{3}$$

The primary difference between γ-Fe₂O₃ and Fe₃O₄ is that the iron in γ-Fe₂O₃ is present only in the trivalent state. Like Fe₃O₄, γ-Fe₂O₃ is ferrimagnetic, and at the nanoscale, single magnetic domain nanoparticles also display superparamagnetism. However, the mass saturation magnetization for bulk γ-Fe₂O₃ is significantly lower than that of Fe₃O₄ at 76.0 A·m²/kg at 293K.

Fe₃O₄ nanoparticles have found clinical use as magnetic resonance contrast agents, including use for imaging of the bowel, liver and spleen, lymph node, bone marrow, perfusion imaging, and magnetic resonance angiography. Their low toxicity has made Fe₃O₄ nanoparticles attractive for use as contrast agents. The nanoparticles are metabolized by lysozymes, where after the liberated iron enters the body's plasma iron pool. Eventually, it is excreted from the body as the iron stores turn over. These nanoparticles have been marketed commercially with sizes specific to their particular use (Table 3). Because they have gained FDA approval for clinical use, there is obvious potential for translating their use to other clinical modalities.

TABLE 3

| Generic | Trade | Developing | Size | |
|---|---|---|---|---|
| name | name | Company | (nm) | Use |
| Ferumoxsil | Lumirem | Guerbet | ~300 | Bowel contrast |
| | Gastromark | Advanced | | |
| | | Magnetics | | |
| | Abdoscan | Nycomed | | |
| Ferumoxide | Endorem | Guerbet | 80-150 | Liver/spleen |
| | Feridex IV | Berlex | | imaging |
| | | Laboratories | | |
| | Resovist | Schering | 60 | |
| Ferumoxtran | Sinerem | Guerbet | 20-40 | Lymph node, bone |
| | Combidex | Advanced | nm | marrow imaging |
| | | Magnetics | | |
| | Clariscan | Nycomed | 20 nm | Perfusion imaging, |
| | | | | angiography |

Superconducting Quantum Interference Device (SQUID) relaxometry relies on the mechanism of relaxation of an ensemble of superparamagnetic nanoparticles following the alignment in an external DC magnetic field. Relaxation of the particle moments into a randomly oriented state can occur by either a Brownian or Néel mechanism. For most particle diameters, Brownian and Néel relaxation occur on very different time scales, allowing the specific mode of relaxation to be distinguished. τN and τB for Fe₃O₄ particles in water over the range of diameters from 10-28 nm are plotted in FIG. 7. It can be seen that for diameters less than 18 nm, τN occurs faster than τB. However, as discussed previously, τN is very sensitive to particle size and increases rapidly as particle diameter increases. FIG. 1 illsutrates Néel relaxation (τN) and Brownian relaxation (τB) for Fe₃O₄ nanoparticles in water. τN increases rapidly with respect to τB because of the exp(r³) dependence on particle size.

There is a need for high quality, size controlled nanoparticles if their potential in both research and commercial applications is to be realized. Several claims of size control have been reported in the literature, but to date, only a few discrete sizes over a limited range have been achieved. Also important is the need to maintain reproducibility between syntheses, which presents a serious challenge. For example, a number of magnetite synthesis protocols have adopted the use of a custom-synthesized iron carboxylate precursor designed by the Hyeon group to achieve particles with low shape and size dispersity. However, the nature of the compound and batch-to-batch variability in the preparation method leads to variation in the synthesized nanoparticles.

Example Embodiment—‘Hot Injection’ Method Using Anhydrous Iron Oleate. Iron(III) carboxylates have been used as catalysts for the degradation of plastics and more recently, these compounds have been studied as precursors to the synthesis of magnetite nanoparticles. Due to the low costs of starting materials and relative ease of synthesis, magnetite nanoparticles have been among the most commonly selected magnetic materials for the development of ferrofluids. Their biocompatibility makes these magnetic nanomaterials highly desirable as MRI contrast agents and in early stage cancer detection.

Multiple aspects of the nanoparticles, such as size, shape, dispersity, phase, and surfactant coating determine their efficacy in the aforementioned applications. Controlling these parameters at the nanoscale has been executed using a number of precursors and reaction conditions. For clinical applications, it can be important that the methods used to prepare the nanoparticles maintain reproducibility between batches, as well as laboratories. We have discovered a significant flaw in previous techniques for the synthesis of magnetite in the consistent production of nanoparticles in size, shape, and dispersity: exposure of the precursor to water.

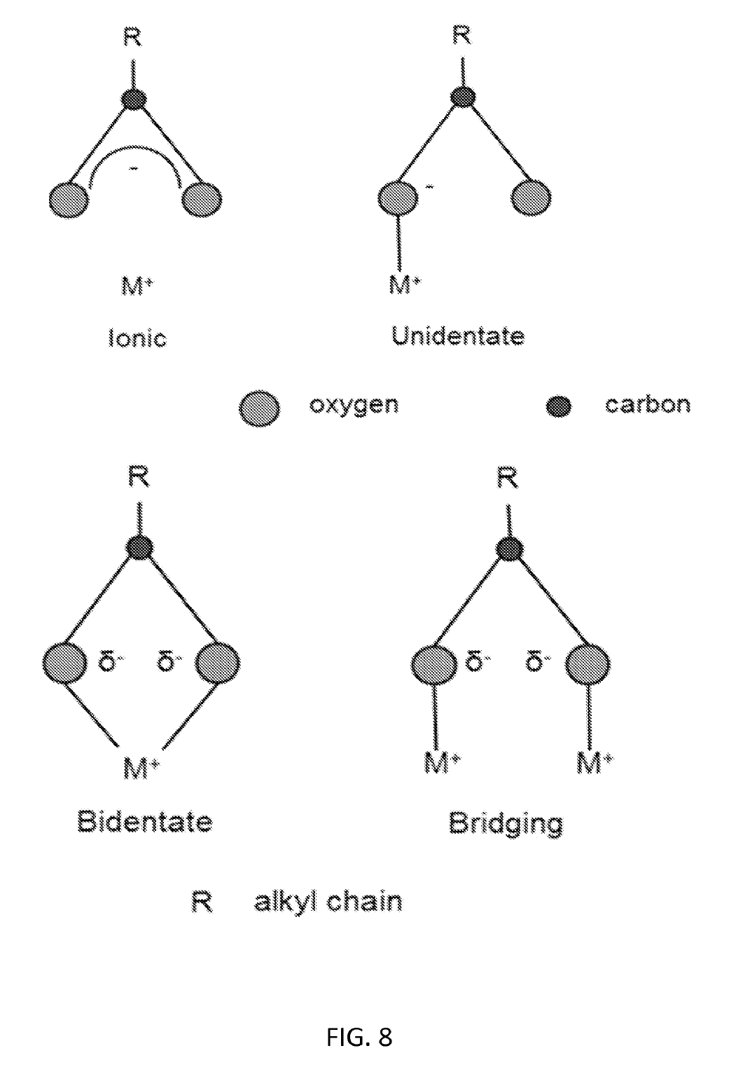

Other publications describing the synthesis of these particles use an iron(III) carboxylate as the precursor to iron oxide particles. The carboxylate ligand has the ability to form an ionic bond, as well serve as bridging or terminal ligands (FIG. 8). FIG. 8 illustrates primary coordination modes between a carboxylate anion and a metal cation. In combination with the oxophilicity of iron(III), the formation and isolation of homoleptic species of iron(III) carboxylates has proven difficult to achieve.

In other preparations, the synthesis of iron(III) carboxylates often produces trimeric iron clusters with ∫—O²⁻ centers as evidenced by elemental analysis. Products are assumed to range from dimeric to polymeric, rather than the single molecules desired for reproducibility. This is thought to result from the synthesis of the iron carboxylate compound in the presence of air and water. In addition, slight variations in the preparation, such as reaction temperature, solvent, or synthetic procedure will often incur stoichiometric changes to the Fe:O ratio in the product.

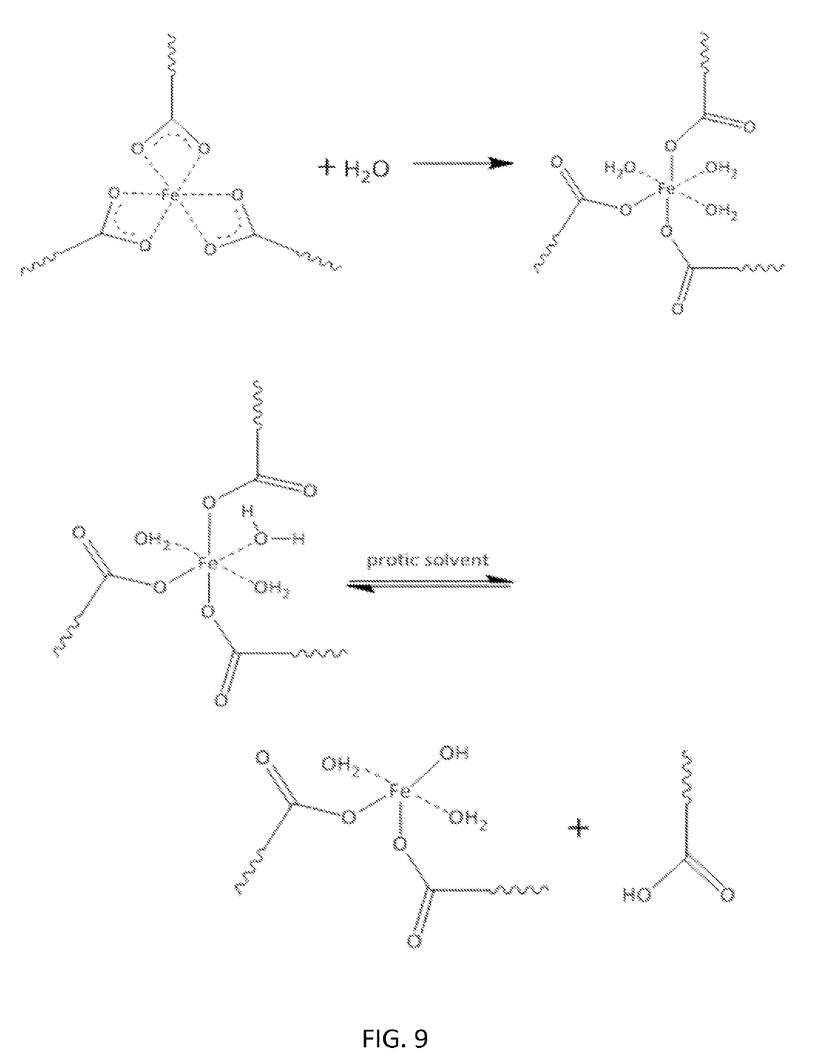

In another preparation, iron(III) oleate was synthesized by combining iron(III) chloride and three molar equivalents of sodium oleate in a water, ethanol, and hexane slurry. Given the Lewis acidity of Fe³⁺, its ability to complex with water may lead to the liberation of oleate as oleic acid and the formation of an iron-hydroxide bond. The poor solubility of an iron hydroxide species would shift the equilibrium of this process in favor of free oleic acid. This scenario would only be exacerbated by the subsequent washing steps of the iron(III) oleate product, leading to a quantitatively unknown composition of the resulting material (FIG. 9). FIG. 9 illustrates the effect of water on the stoichiometry of iron(III) carboxylate, where [symbol] represents a hydrocarbon chain. It has been shown that slight variations in the ratio of iron to surfactant can have material impacts on the size of the resultant particles. For this reason, this material, while well-suited to produce magnetic nanoparticles of various sizes with low size dispersity, is wholly incompatible with precise reproduction desired between batches. It is our intention to utilize a new, anhydrous synthesis of iron(III) oleate, eliminating issues with reproducibility in the synthesis of iron oxide nanoparticles.

We examine the quality of synthesized nanoparticles and reaction reproducibility using the ‘hot injection method,’ which has been demonstrated to produce high quality semiconductor nanoparticles. In the hot injection process, the rapid introduction of reactive precursors into a hot solution creates a condition of high supersaturation. Burst nucleation immediately follows, reducing the supersaturation condition and ending the nucleation event. Additional growth of particles follows by diffusion of monomer species to the particle surface. In an example embodiment, we apply the hot injection method to the synthesis of iron oxide nanoparticles for reproducible synthesis of high quality iron oxide nanoparticles. Because the iron precursor is injected directly into a heated solvent, this method removes the temperature ramp rate dependence that has previously been cited as important for control of particle nucleation. Further, we intend to examine the effect of varying the oleic acid ligand to iron precursor ratio in the reaction, which has been previously been demonstrated as a means by which particle nucleation and growth can be controlled.

All chemical transformations were carried out with the rigorous exclusion of air and water using standard glovebox and Schlenk-line techniques. Pentane, acetonitrile, and toluene were purchased as anhydrous solvents from Sigma-Aldrich (St. Louis, Mo.) and used as received. Oleic acid (99%) was purchased from Alfa Aesar (Ward Hill, Mass.) and dried at 70° C. under vacuum for 24 h. Octadecene was purchased from Acros Organics (Pittsburgh, Pa.) and degassed prior to use. Anhydrous iron(III) chloride was purchased from Strem Chemicals (Newburyport, Mass.) and Alfa Aesar and used as received. Sodium oleate was purchased from Sigma-Aldrich and dried under vacuum (20 mTorr) at 70° C. for approximately 3 days. To ensure dryness, FTIR spectroscopy was used to confirm the disappearance of the broad —OH peak contributed by water at 3400 cm⁻¹.

The conventional material was prepared according to a literature procedure. Specifically, 1.62 g of anhydrous FeCl₃ (10.0 mmol) was dissolved in 10 mL of distilled water. Added to this solution were 9.13 g (30 mmol) of sodium oleate, 20 mL of ethanol, 5 mL of distilled water, and 30 mL of hexane. This mixture was vigorously stirred while the temperature was maintained between 50° C. and 70° C. for 4 hours under an inert gas environment. At that time, the reaction was allowed to cool to room temperature and the deep red organic layer was separated from the aqueous layer. The organic phase was washed three times with 10 mL of distilled water in a separation funnel, followed by evaporation of the hexane solvent under vacuum. The product (a dark red-brown material with a semi-solid consistency) was fully dried under vacuum (20 mTorr) at a temperature below 50° C. for 24 hours.

The anhydrous iron(III) oleate was prepared by the very slow (over 72 hrs), incremental addition of three equivalents of sodium oleate to a magnetically stirred solution of one equivalent of anhydrous iron(III) chloride in toluene. As small amounts of sodium carboxylate dissolved, the solutions became dark green. The solutions were allowed to stir for an additional 24 hours, after which the toluene was completely removed in vacuo over a 12 hour period. Pentane was added to the remaining material with stirring to dissolve the iron(III) oleate. The mixture was centrifuged and decanted to remove any precipitated NaCl. The solution was thoroughly washed with anhydrous acetonitrile to remove all traces of NaCl. After removing the pentane under vacuum, the anhydrous iron(III) oleate was characterized using FTIR spectroscopy. Three separate samples were prepared in this fashion to test the batch-to-batch variation in synthetic method.

Reproducibility of the iron(III) oleate precursors was tested by three separate nanoparticle synthesis experiments. To briefly describe the reaction methodology, a flask containing solvent was heated to the desired temperature, at which point the iron precursor solution was rapidly injected. The first three experiments tested three prepared anhydrous iron(III) oleate compounds, while the following three experiments looked at the effect of varying oleic acid concentration in the reaction. The details of the reaction set up are described below.

Preparation of iron precursor solution for injection. Iron (III) oleate, as prepared, is a semi-solid compound that is not amenable to injection by a syringe. Therefore, it was necessary to use a carrier solvent that the iron oleate compound could be suitably dispersed in for injection. For these reactions, oleic acid was chosen as the carrier. In a typical reaction, a stock solution was prepared that contained approximately 200 mg (0.22 mmol) of iron(III) oleate in 0.5 mL (1.59 mmol) of oleic acid. Any deviance from these exact quantities was compensated for by maintaining the oleic acid to iron oleate molar ratio of 7.07:1. The iron oleate was fully dispersed in oleic acid with magnetic stirring and gentle heating (60° C.).

Reaction set up. For the first series of experiments, 3.47 g (11.11 mmol) of docosane solvent (4.0 mL volume) was added to a 100 mL 3-neck flask (Table 4). In the subsequent set of experiments testing the effect of oleic acid in solution, a 2.0 mL reaction volume with different amounts of docosane and oleic acid were added to the flask (Table 5).

TABLE 4

| | Reaction Flask | | Precursor | |
|---|---|---|---|---|
| Anhydrous Iron | Docosane | Oleic acid | Iron oleate | Oleic acid |
| Oleate Sample | (mmol) | (mmol) | (mmol) | (mmol) |
| 1 | 11.11 | — | 0.222 | 1.57 |
| 2 | 11.11 | — | 0.226 | 1.59 |
| 3 | 11.11 | — | 0.223 | 1.58 |

TABLE 5

| | Reaction Flask | | Precursor | | Total |
|---|---|---|---|---|---|
| Anhydrous | | Oleic | Iron (III) | | oleic |
| Iron Oleate | Docosane | acid | oleate | Oleic acid | acid |
| Sample | (mmol) | (mmol) | (mmol) | (mmol) | (mmol) |
| 1 05-83 | 4.96 | — | 0.224 | 1.58 | 1.58 |
| 1 05-85 | 3.72 | 1.57 | 0.223 | 1.58 | 3.15 |
| 1 05-91 | 2.48 | 3.15 | 0.223 | 1.58 | 4.73 |

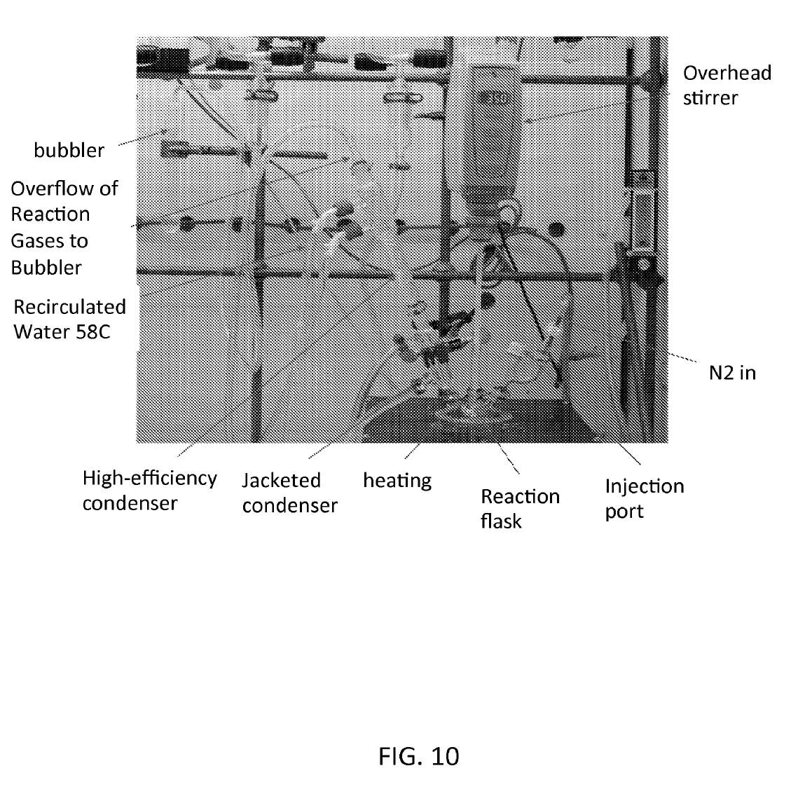

The experimental apparatus is shown in FIG. 10. One neck of the reaction flask was fitted with a Claisen adapter to provide connection of a flow adapter for inflow of N₂ gas and a port sealed with a rubber stopper for later injection of iron precursor. The opposite neck of the flask was fitted with a jacketed condenser, on top of which, a second, high efficiency coil condenser was added, and a hose adapter for connection to a bubbler for outflow of N₂ from the reaction. The center neck of the reaction flask was fitted with a stirrer bearing, through which a precision ground glass stir rod with a Teflon stir blade was attached. To ensure a rigorously air-free atmosphere during synthesis, the reaction vessel was assembled in a glovebox, sealed, and rapidly connected to a Schlenk line with flowing N₂. The ground glass stir rod was connected to a compact overhead stirrer (Caframo,) and stirring was set to 350 RPM. The condensers were connected in series to a recirculating water reservoir heated to 58° C. to allow docosane vapors to reflux while preventing solidification in the condenser. The reaction flask was rapidly heated to 360° C. using a molten metal bath (Bolton 175F low melting point alloy) heated by cartridge heaters using a custom designed National Instruments temperature control interface. As soon as the molten metal temperature was stable, 0.5 mL of the prepared iron precursor solution was rapidly injected into the reaction flask. Nucleation of nanoparticles was observed by a darkening of the reaction solution from dark brown to black, and the reaction was allowed to age for several minutes before an aliquot was withdrawn for characterization. Aliquots withdrawn from the reaction vessel were suspended in hexanes and loaded into borosilicate glass capillaries for size analysis using SAXS.

Iron Oleate Precursor. To better understand the role of the iron oleate precursor in the formation of iron oxide nanoparticles, it was necessary to prepare homoleptic iron(III) oleate. This material would have to be anhydrous, unlike the conventionally prepared material, to prevent the influence of water on the stoichiometry and decomposition pathways of the pure compound. Different binding modes of the carboxylate ligand in the conventional and anhydrous iron(III) oleate are expected, and can be used to differentiate between two compounds.

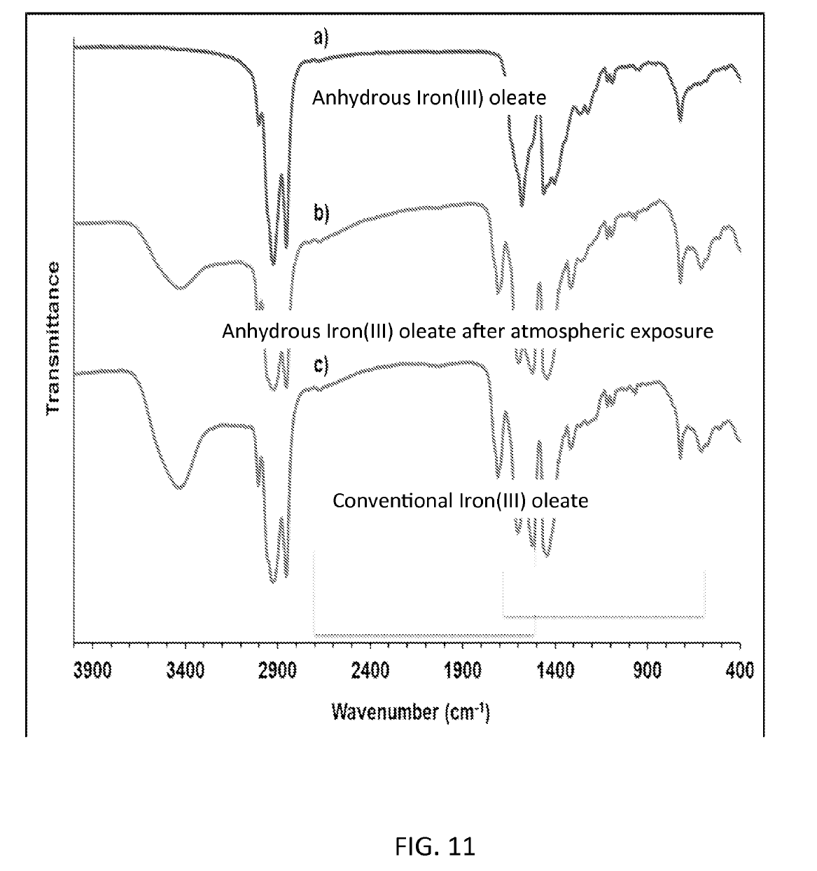

FTIR Spectroscopy. FIG. 11 shows FTIR spectra of a) conventional iron(III) oleate, and anhydrous iron (III) oleate b) before and c) after atmospheric exposure. From FIG. 11, the FTIR spectrum of conventional iron(III) oleate reveals three areas of interest: first, there is a wide band at 3440 cm⁻¹ that can be assigned to v(O—H) vibrations, five bands in 1400-1700 cm⁻¹ region due to v(C—O) vibrations coupled to v(C—C) vibrations, and the small band at 604 cm⁻¹ assigned to δ(Fe3O) or δ(FeOH) vibrations. In addition, there are expected peaks from v(C—H) vibrations at 2856 cm⁻¹ and 2927 cm⁻¹. The v(O—H) vibrations at 3440 cm⁻¹ manifest the presence of water in the material, whereas the peak at 1711 cm⁻¹ is indicative of the presence of free oleic acid. FTIR of the anhydrous iron(III) oleate could only be performed under rigorously dry conditions. This green material would quickly become yellow-orange on nominally dry KBr plates, necessitating extensive drying of the KBr. The spectrum of this material, shown in FIG. 11, demonstrates the absence of v(O—H) vibrations and simpler pattern of v(C—O) stretches, including the absence of 1711 cm⁻¹ band, implying that no unbound oleic acid is present in the sample. The anhydrous material would rapidly change color upon exposure to air and the resulting FTIR spectrum was compared to that of the conventional material (FIG. 11). These spectra are remarkably similar, suggesting the same metal-ligand bonding modes for both materials. It is therefore critical to prevent the exposure of the anhydrous iron(III) oleate to air/moisture, as it rapidly undergoes the transformation to the conventional material.

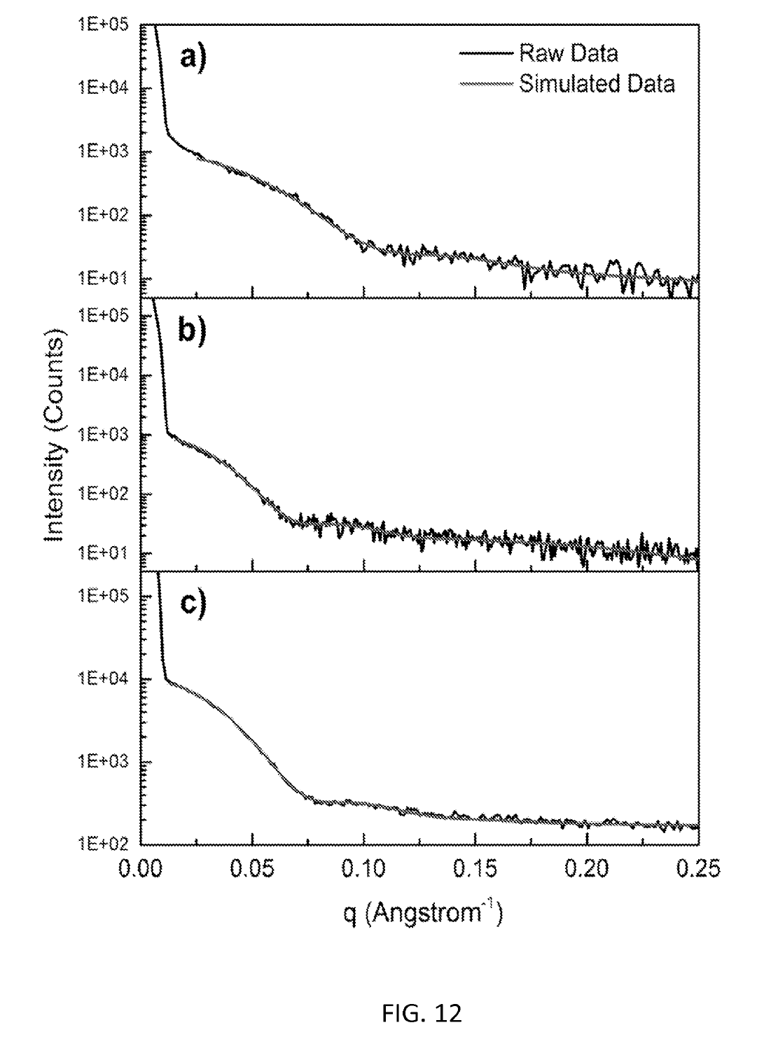

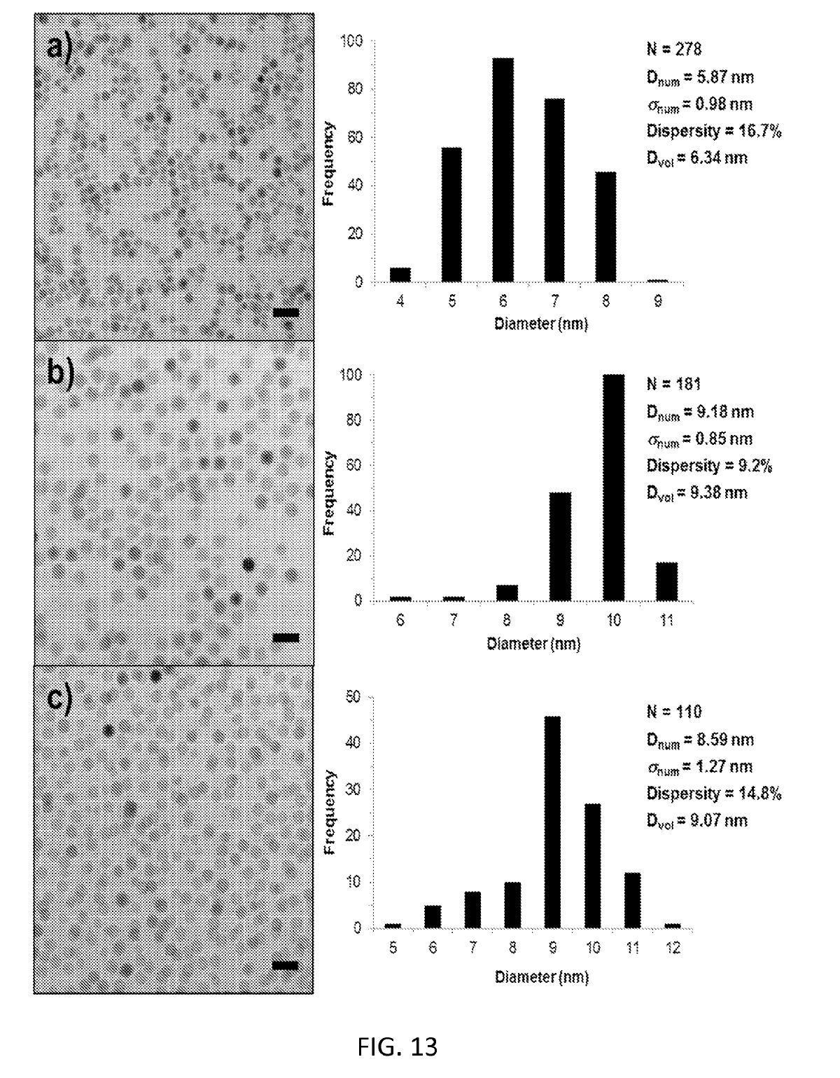

Nanoparticle syntheses. Three anhydrous iron oleate samples, labeled ‘1,’ ‘2,’ and ‘3’ were used for all studies. The first set of experiments was performed to determine the batch-to-batch reproducibility of iron oxide nanoparticle synthesis by injecting 0.5 mL precursor solution into 4.0 mL of docosane solvent. The results of these experiments as characterized by SAXS are presented in Table 6. The raw SAXS data and fits are given in FIG. 12, and the corresponding TEM images in FIG. 13. FIG. 13 shows TEM images and accompanying histograms for samples corresponding to Table 6. (a) Sample 1, (b) Sample 2, (c) Sample 3. The scale bars represent 20 nm. There is a 15-20% difference between the volume average diameter calculated using SAXS and the volume average diameter calculated from TEM measurements. This number would be expected to be in better agreement if more particles were sampled using TEM image analysis.

TABLE 6

| | Observed | Aliquot | SAXS | |
|---|---|---|---|---|
| Sample | nucleation | withdrawal | Diameter | Size |
| (Experiment) | (min) | (min) | (nm) | Dispersity |
| 1 | 10 | 11.5 | 7.8 | 15.1% |
| 2 | 13.5 | 15 | 12.0 | 12.8% |
| 3 | 12.5 | 15 | 10.9 | 12.3% |

Table 6 illustrates that the time required for particles to nucleate is significantly different for each sample, with an apparent correlation between nucleation time and particle size at the time the aliquot was withdrawn. The earliest nucleation time was observed for Sample 1, which produced particles of the smallest size and the highest size dispersity. The longest nucleation time was observed for Sample 2, which produced the largest particles with reduced size dispersity.

Each anhydrous precursor and nanoparticle synthesis was carried out in the same manner, so it is not clear why such a variation in nucleation times and resulting particle sizes should be observed. One possibility is that by mixing the anhydrous iron oleate with oleic acid prior to injection, the structure of the synthesized iron oleate complex changed in a non-reproducible way (e.g., the number and binding of oleate molecules to an iron ion or ions). The stability of the overall precursor complex could ultimately result in variation of nucleation times. A less ambiguous study of iron(III) oleate decomposition might be accomplished if a non-interacting solvent, such as octadecene, was used to prepare the stock solution for injection.

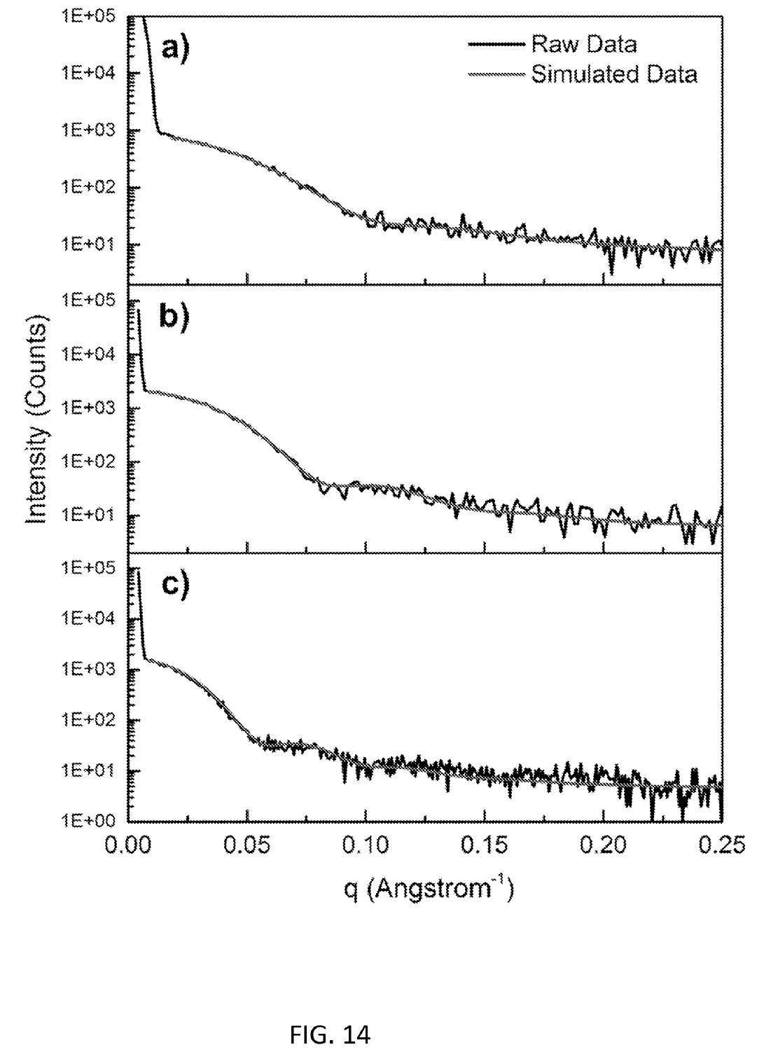

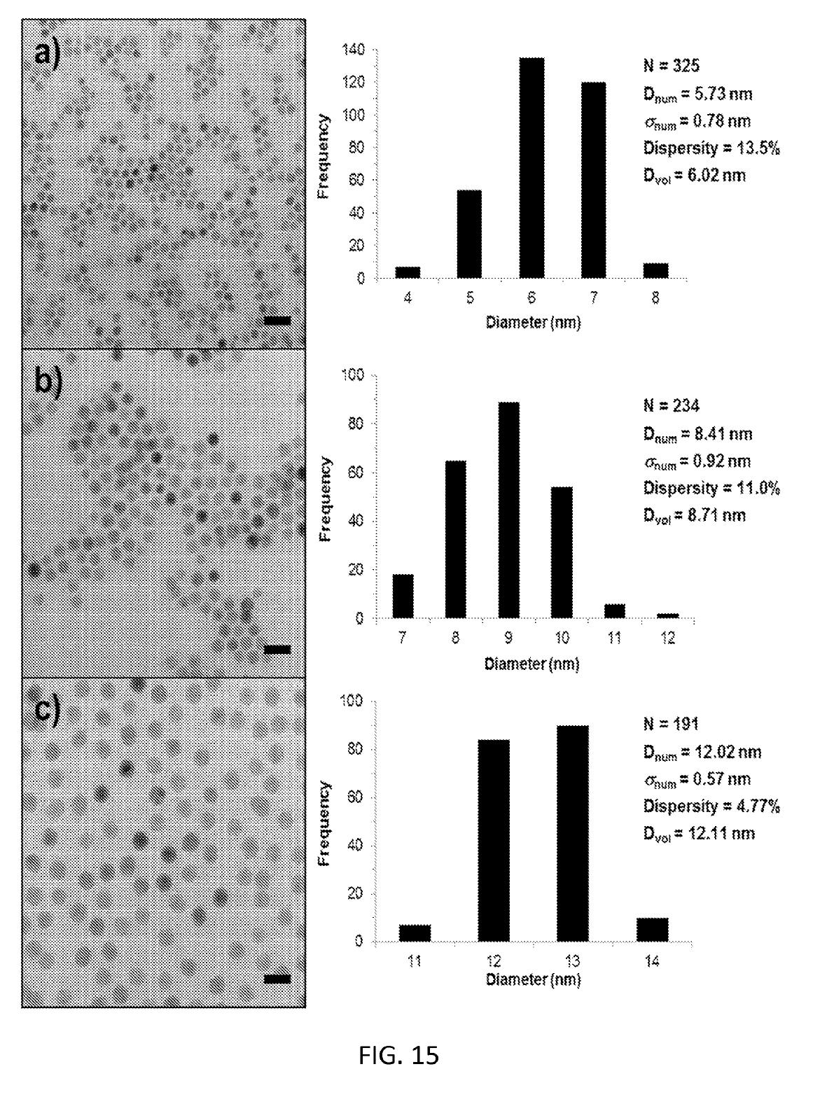

The second series of experiments used the same iron(III) oleate sample to demonstrate the effect of oleic acid concentration on the properties of the synthesized particles. The volume for all reactions was decreased from 4 mL in the previous set of experiments to 2 mL in the current set of experiments, effectively increasing the molarity of oleic acid in the reaction. The results of those experiments as characterized by SAXS are presented in Table 7. The raw SAXS data and fits are given in FIG. 14, and the corresponding TEM images in FIG. 15.

TABLE 7

| | Total oleic | Observed | Aliquot | SAXS | |
|---|---|---|---|---|---|
| Sample | acid | nucleation | withdrawal | Diameter | Size |
| (Experiment) | (mmol) | (min) | (min) | (nm) | Dispersity |
| 1(a) | 1.58 | 20 | 24.5 | 8.0 | 15.4% |
| 1(b) | 3.15 | 39 | 42 | 10.2 | 10.2% |
| 1(c) | 4.73 | 82.5 | 86 | 14.9 | 9.2% |

From Table 7, it is clear that each increase in oleic acid resulted in a doubling of nucleation time and an increase in the resulting particle size. This is indicative of the role oleic acid has in increasing the energy barrier to nucleation. The presence of excess oleic acid likely increases the equilibrium solubility of the iron species in solution. This could, in turn, require an increase in the minimum size of the critical nucleus that can resist dissolution. Increasing the oleic acid concentration also appears to have a favorable effect on size dispersity, which decreased significantly from over 15% to nearly 9% as confirmed by SAXS measurements. Additional studies with increased oleic acid concentration would confirm the trend seen in these experiments. However, the results imply that the concentration of free oleic acid in solution is important for achieving size control in this system.

The purity of the precursor used to synthesize magnetite nanoparticles has been discovered to be important to achieving reproducibility in nanoparticle synthesis. Iron(III) oleate prepared by any method that has included atmospheric exposure results in the formation of a non-stoichiometric compound. As a result, published results of magnetite nanoparticles using this material as a precursor are certainly less reproducible than those using a stoichiometric precursor. True, stoichiometric iron(III) oleate was prepared using an air- and moisture-free procedure. The hot injection method, previously applied to semiconductor nanoparticle synthesis, was used to synthesize iron oxide nanoparticles. The iron(III) oleate precursor was demonstrated to be sensitive to mixing with oleic acid prior to injection, making the results of the reproducibility study difficult to interpret. However, there was a demonstrable effect of excess oleic acid in the reaction solution on the size and resulting size dispersity of synthesized nanoparticles. Oleic acid concentration can be used tune the size of spherical particles with low shape and size dispersity important for controlling the resulting magnetic properties.

Example Embodiment. In Situ Generation of Iron Oleate for Synthesis of High Quality Iron Oxide Nanoparticles. Iron oxide nanoparticles have been studied extensively and are among a small class of nanomaterials that have found utility outside of the laboratory. Owing to their unique magnetic properties at the nanoscale and ease of synthesis, iron oxide nanoparticles have found a number of novel applications in industrial and biomedical applications. However, reproducibly maintaining control of particle size, morphology, and magnetic properties between reactions limits their potential in applications sensitive to these attributes. A number of synthetic approaches for nanoparticle iron oxide have been reported, with thermolysis of iron-containing precursors yielding nanoparticles with superior properties (e.g., low size dispersity, single crystal, shape control). Thermolytic synthesis of iron oxide nanoparticles involves the decomposition of an iron-containing precursor in a high boiling point solvent. The morphology, size, and colloidal stability of the synthesized iron oxide nanoparticles are in part determined by the ligand(s) used in the reaction, which are typically long-chain hydrocarbons with carboxylic acid, alcohol or amine functionalities that bind to and stabilize the nanoparticles. Our goal is to identify a synthetic method that reproducibly yields high quality nanoparticles specifically by eliminating the variability introduced by the composition, purity, and stoichiometry of the iron precursor. Here, we present a systematic study of the thermal decomposition of iron acetylacetonate (Fe(acac)₃) in oleic acid, identify the formation of iron oleate as an intermediate compound, and characterize the resulting iron oxide nanoparticles.

One of the most popular methods of iron oxide nanoparticle synthesis is the thermal decomposition of iron oleate in a high boiling point solvent. However, iron oleate is not commercially available and must be custom synthesized for this reaction. The standard reaction to form iron oleate is deceptively simple, involving the mixing of sodium oleate with iron chloride. The resultant material, however, resists crystallization making purification challenging. Carboxylate anions can bind to metal atoms through various coordination schemes including mono-, bi-, tri-, or tetradentate interactions, implying that different stoichiometries are possible for the combination of iron and oleic acid. Bronstein et al. have verified spectroscopically that the amount of oleate coordinated to the iron ions varies depending on the preparation method and is sensitive to factors including washing, aging and storage conditions of the prepared iron oleate compound. Differences in stoichiometry of the iron precursor used to synthesize magnetic nanoparticles obviously impact the reproducibility of iron oxide nanoparticle syntheses.

Despite the challenges associated with reproducibly synthesizing an iron oleate precursor, it is an extremely advantageous material for the synthesis of iron oxide nanoparticles. Nanoparticles synthesized through the high temperature thermal decomposition of iron oleate can be made to have narrow size dispersity and excellent magnetic properties; moreover, the reaction is highly scalable. An ideal reaction would keep the advantages of the iron oleate precursor, but use only commercially available, stoichiometric compounds. Here, we explore the in situ generation of iron oleate to remove the non-stoichiometric starting material from the reaction.

Iron acetylacetonate (Fe(acac)3) is commercially available as a high purity, crystalline material that is safe, air-stable, inexpensive, and has been used as an iron precursor in the thermolytic synthesis of high quality iron oxide nanoparticles using a variety of solvents and ligands. Li et al. demonstrated the synthesis of 24 nm iron oxide particles with narrow size and shape dispersity by thermolysis of Fe(acac)₃ in oleic acid. In this reaction, oleic acid acts as both a high boiling point solvent and a stabilizing ligand for the iron oxide nanoparticles. Li et al. postulate that the reaction proceeds with oleic acid reducing Fe(acac)₃ to form Fe(II) oxide particles. Using a similar synthetic approach, we propose that synthesis of iron oxide nanoparticles under such conditions proceeds via the generation of an iron oleate intermediate. This approach provides stoichiometric control over the reaction precursors, while providing a high quality nanocrystalline product from the intermediate iron oleate compound.

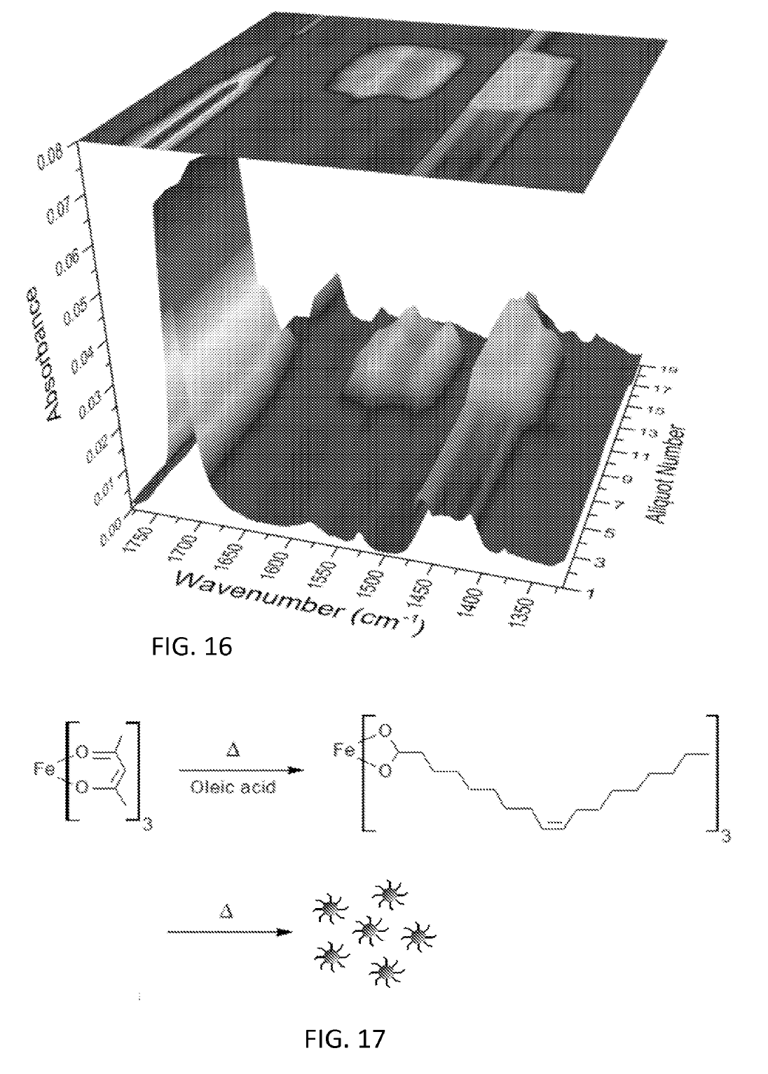

Here, we use Fourier transform infrared (FTIR) spectroscopy to confirm that the decomposition of Fe(acac)3 in oleic acid results in the formation of an intermediate iron oleate compound (FIG. 16). FIG. 16 shows characteristic carbonyl and carboxylate stretches are visible in the region from 1800-1300 cm⁻¹. Early in the reaction, the dominant peak arises from unbound oleic acid (vC═O at 1710 cm⁻¹). As the reaction progresses, oleic acid is converted to iron oleate and strong carboxylate stretches (vasym COO— at 1578 cm⁻¹, and vsymCOO— at 1444 cm⁻¹) emerge. Upon formation of particles, iron oleate is consumed and carboxylate stretches disappear. We believe that this is the first detailed spectroscopic study performed over the course of an entire synthesis. Further, we show that thermal decomposition of the iron oleate intermediate results in the formation of wüstite (Fe1−xO), which can be controllably converted to magnetite (Fe3O4) by oxidation at relatively low temperature under ambient atmosphere.

The one-pot synthesis method of Li et al. for the growth of 24 nm magnetite nanoparticles was adapted for the reported experiments. For FTIR studies, a 100 mL three-necked round bottom flask was charged with 3.6 g (10.2 mmol) Fe(acac)3 (99+%, Acros Organics, Fair Lawn, N.J.) and 15 mL (47.3 mmol) oleic acid (technical grade, 90%, Sigma-Aldrich, St. Louis, Mo.). Reaction flasks were equipped with a magnetic stir bar, a reflux condenser, and a thermocouple for monitoring the reaction temperature. Reactions were performed with vigorous stirring under a nitrogen atmosphere, and heated to 320° C. using a heating mantle controlled by a J-KEM 210T PID temperature controller (J-KEM, St. Louis, Mo.). For FTIR analysis of reaction intermediates, 19 aliquots of approximately 100 μL each were withdrawn at selected time intervals and measured neat. To understand the effect of reagent removal on nanoparticle synthesis, additional reactions without aliquot removal were also performed under the same conditions.

Infrared spectra were collected on a Bruker IFS 66v5 vacuum evacuated infrared spectrophotometer (Bruker Optik GmbH, Germany). Aliquots were characterized using a grazing angle attenuated total reflectance (GATR) accessory with a fixed 65° incidence angle and a hemispherical germanium crystal (Harrick Scientific Products Inc., Pleasantville, N.Y.). 256 scans of each sample were collected at 2 cm⁻¹ resolution from 3400 cm⁻¹ to 700 cm⁻¹ using a liquid nitrogen cooled MCT detector. Extended ATR correction was performed on the collected spectra using Opus 6.5 software assuming an index of refraction of 1.5 for the aliquots. No additional baseline corrections were performed.

Powder diffraction samples were prepared by placing several drops of concentrated nanoparticle suspension onto a silicon substrate and allowing the solvent to evaporate. Powder X-ray diffractograms were collected using a Rigaku SmartLab diffractometer system with the SmartLab Guidance system control software for system automation and data collection (Rigaku, The Woodlands, TX). Cu-K-alpha radiation (40 kV, 44 mA) was used with a scintillation detector and diffracted beam monochromator. Data analysis was completed using Rigaku PDXL analytical software with the ICDD (International Center for Diffraction Data) PDF2 database (release 2010 RDB) for phase identification.

Concentrated solutions of samples suspended in hexanes were injected into glass capillary tubes with a 1.0 mm diameter (Charles Supper Company, Natick, Mass.). Samples were analyzed using a Rigaku SmartLab diffractometer system with the SmartLab Guidance system control software. Cu-K-alpha radiation (40 kV, 44 mA) was used in transmission geometry with a scintillation detector. Data analysis was performed using Rigaku NANO-Solver v. 3.5 software, assuming a spherical particle shape, and calculating a volume average diameter.

Samples were prepared by applying a drop of a dilute suspension of nanoparticles in hexanes onto a carbon-coated copper grid (SPI, Westchester, Pa.) and wicking excess liquid away with a Kimwipe. Bright field TEM studies were performed using a JEOL 1200EX TEM operating at 120 kV (JEOL USA, Inc., Peabody, Mass.). High resolution images were acquired using a Tecnai F30 G² Twin TEM with a 300 keV acceleration voltage. Size analysis of imaged particles was performed using ImageJ software. The size distribution was calculated by deriving the particle diameter from the measured cross-sectional area, effectively assuming a spherical morphology, and calculating a number average and volume average diameter.

Magnetization measurements were collected using a Quantum Design MPMS-7 SQUID magnetometer. Samples were prepared by depositing a small amount of the synthesized nanoparticles suspended in hexanes onto the end of a Q-tip™ cotton swab and flame-sealing the sample in an NMR tube under vacuum. Magnetization curves were recorded from −50 kOe to +50 kOe (−4000 kA/m-+4000 kA/m) at 293K. Data were corrected for the slight paramagnetic signal contributed by the NMR tube at high fields. Zero-field cooled (ZFC) magnetization curves were obtained by cooling the sample to 5K with no applied field, then applying a field of 10 Oe (0.8 kA/m), and recording the magnetization from 5K to 345K. With the 10 Oe field still applied, the sample was then cooled from 345K to 5K to obtain the field-cooled (FC) magnetization. The precise iron mass of each sample was determined destructively by heating the Q-tip™ in a 600° C. furnace for 1 hour to incinerate the organic material and then dissolving the iron containing residue in hydrochloric acid. A phenanthroline/Fe²⁺ complex was formed in solution and spectrophotometrically quantified using the concentration of a known dilution.

We have applied the concepts developed by LaMer and Dinegar in the “heating-up method” for the one-pot, thermolytic synthesis of iron oxide nanoparticles. In this approach, thermal decomposition of the precursor leads to the increase of monomer units in solution until a critical, supersaturating concentration induces formation of nuclei, and growth proceeds by diffusion of monomer units to the particle surface. We adopt the “heating-up method” to include the in situ synthesis of iron oleate from a crystalline precursor. A simplified reaction is presented in FIG. 17. FIG. 17 illustrates a reaction scheme for the formation of iron oxide nanoparticles by the heating and decomposition of the iron precursor, Fe(acac)3; the formation and consumption of an iron oleate intermediate; the formation of oleic acid-stabilized iron oxide nanoparticles.

An example embodiment comprises a four step reaction sequence for the current system: 1) Conversion of Fe(acac)3 to iron oleate at temperatures above the decomposition temperature of Fe(acac)3, 2) High temperature decomposition of iron oleate leading to an accumulation of iron oxide precursor (stabilized by oleic acid), 3) nanoparticle nucleation at a critical concentration of the iron oxide precursor to partially relieve supersaturation, and 4) particle growth without nucleation. Evidence for this sequence of reactions was obtained through infrared spectroscopy of the reaction mixture during the course of the reaction.

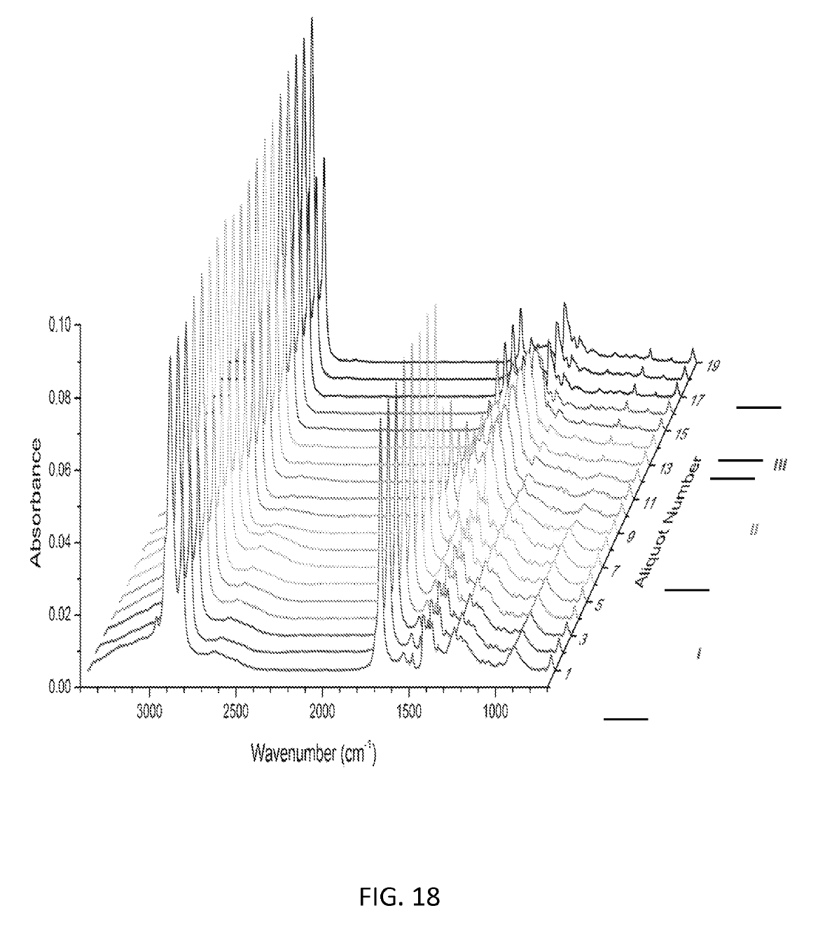

Fourier transform infrared spectroscopy (FTIR) was chosen as a semi-quantitative method to identify the proposed iron intermediate in sample aliquots. By comparing peaks found in the infrared spectra of reaction aliquots with those known to be characteristic of the vibrations of carboxylate ions occurring in the salts of carboxylic acids, we demonstrate that iron oleate is formed as an intermediate to iron oxide nanoparticle formation. The emergence and later disappearance of specific vibrational frequencies in the carboxylate region of the IR spectra during the reaction can be used to demonstrate the generation and consumption of an iron oleate intermediate (FIG. 16). The full spectra of the collected aliquots (3400-700 cm⁻¹) are presented in FIG. 18 with the peak assignments of the most significant figures listed in Table 5-1. FIG. 18 shows FTIR spectra of collected aliquots from 3400 cm⁻¹-700 cm⁻¹.

TABLE 8

| | Peak (cm⁻¹) | Assignment | Comments | Ref. |
|---|---|---|---|---|
| Phase I | 3050 ± 150 | —OH stretching | Broad, disappears with formation | 112, 121 |
| | | vibration from | of iron oleate | |
| | | COOH dimers | | |
| | 2925 | Asymmetric C—H | Strong, constant throughout | 112 |
| | | stretches | reaction | |
| | 2854 | Symmetric C—H | Strong, constant throughout | 112 |
| | | stretches | reaction | |
| | 1710 | C═O stretch of | Strong, diminishes with the | 83, 112, |
| | | carboxylic acid | formation of iron oleate | 121 |
| | 1589 | C—O stretch of | Moderate, disappears with the | 124 |
| | | Fe(acac)3 | formation of iron oleate | |
| | 1530 | CH stretch of Fe(acac)3 | Moderate, disappear with | 124 |
| | | | formation of iron oleate | |
| | 1300 − 1200 | —OH in plane | Broad, medium intensity, couples | 112, 121 |
| | | deformation | to the C—Ostretching vibration, | |
| | | | disappears with the | |
| | | | formation of iron oleate | |
| | 1250 ± 80 | C—O stretching | Moderate, couples to —OH in | 112 |
| | | vibration | plane deformation, disappears | |
| | | | with the formation of iron oleate | |
| | 905 ± 65 | —OH out of plane | “V” shaped band, disappears with | 112, 121 |
| | | deformation | the formation of iron oleate | |
| Phase II | 1710 | C═O stretch of | Reaches a minimum in this phase | |
| | | carboxylic acid | | |
| | 1650 − 1510 | Asymmetric COO⁻ | Reaches a maximum in this phase | 83, 112, |
| | | stretches | | 121, 122 |
| | 1444 − 1280 | Symmetric COO⁻ | Reaches a maximum in this phase | 40, 47, 48, |
| | | stretches | | 50 |
| Phase III | Nucleation | | | |
| Phase IV | 1710 | C═O stretch of | Intensity increases slightly | |
| | | carboxylic acid | following the formation of particles | |

Specifically, a brief review of some of the vibrations that are contributed by carboxyl and carboxylate groups in the range of 1800-1300 cm⁻¹ is beneficial. The C═O stretching vibration (vC═O) in carboxylic acids exhibits a strong band at 1725±65 cm⁻¹, and in free oleic acid can be found at 1710 cm⁻¹. Conversion of the carboxylic acid to an iron carboxylate gives rise to the asymmetric COO⁻ stretch (vasymCOO—) from 1650-1510 cm⁻¹ and the symmetric COO⁻ stretching vibrations (vsymCOO—) from 1444-1280 cm⁻¹. In our analysis, we assign the peak at 1578 cm⁻¹ to vasymCOO— and the peak at 1444 cm⁻¹ to vsymCOO—, consistent with previous studies. It should be noted that C—H vibrations that superimpose on the carboxylate stretches in this region can make precise assignment of wavenumbers challenging. Further, multiple coordination modes of carboxylate moieties to iron ions may cause additional overlapping vibrations. Though it is conceivable that various carboxylate compounds may be formed during the decomposition of Fe(acac)3, the large excess of oleic acid present in the reaction warrants our belief that the carboxylate stretches are contributed predominantly by iron (III) oleate.

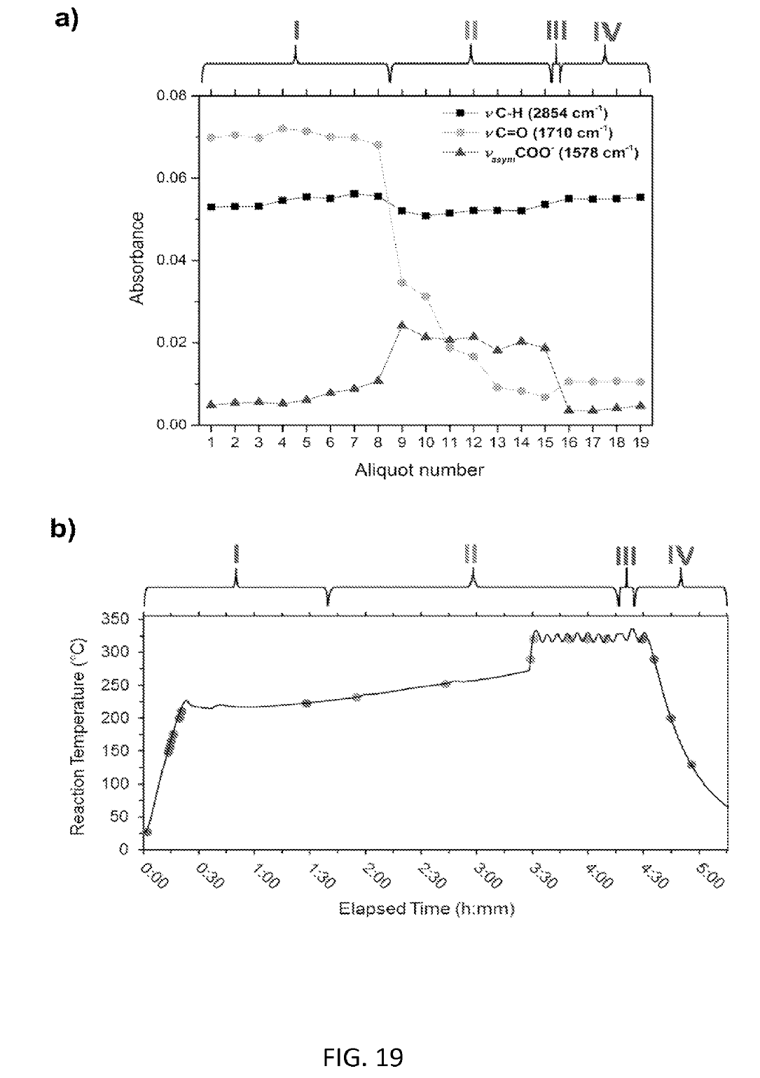

To illustrate this concept more concisely, four vibrational frequencies considered to be most relevant to this study have been plotted as a function of the reaction progress: 2854 cm⁻¹, 1710 cm⁻¹, and 1578 cm⁻¹ (FIG. 19). FIG. 19 shows a) Selected IR absorbance of successive reaction aliquots are plotted: vC—H is presented for reference, while vC═O and vasymCOO— allow four distinct phases to be identified in the reaction corresponding to (I) heating and thermal decomposition of the iron precursor, (II) formation and decomposition of iron oleate intermediate (III) particle nucleation, and (IV) nanoparticle growth. b) The corresponding reaction temperature profile. Time points for aliquot withdrawals are indicated by filled circles that have been colored to identify the reaction phase. The peak at 2854 cm⁻¹ represents alkyl C—H stretches (vC—H), and is expected to remain constant throughout the duration of the reaction. The remaining peaks correspond to vC═O and vasymCOO—, as discussed previously. An inspection of this plot makes it clear that the asymmetric carboxylate stretch we attribute to iron oleate is initially absent, increases significantly above the background, suddenly drops, then remains at a low level as the reaction terminates. This phenomenon makes it straightforward to divide the reaction into four phases, which we describe as: I. Heating and thermal decomposition of Fe(acac)3, II. Accumulation and decomposition of the iron oleate intermediate, Ill. Particle nucleation, and IV. Particle growth.

Phase I: Heating and thermal decomposition of Fe(acac)3. During phase I, the reaction mixture is heated from room temperature to 220° C., the decomposition temperature of Fe(acac)3, and the point at which the reaction mixture was observed to boil (FIG. 19). Here, the rapid heating of the reaction ceases, despite the temperature controller applying full power to heat the reaction. For an extended period of time, we see only a gradual increase in temperature as the reaction mixture refluxes. The temperature of reflux is consistent and reproducible and is attributed to the release of acetylacetone upon reaching the decomposition temperature of Fe(acac)3. Acetylacetone boils at 140° C., and would be expected to vigorously reflux at this temperature, providing cooling to thereaction and slowing the heating. Simultaneously, a gradual decrease of the vC═O peak can be observed and is accompanied by a commensurate increase in the vasymCOO— peak, as free oleic acid begins to combine with iron liberated during Fe(acac)3 decomposition and iron oleate is formed.

Phase II: Formation and decomposition of iron oleate intermediate. In phase II, the reaction temperature slowly increases from 229° C. to about 250° C., despite the continued application of full heating power. At 250° C. the reaction resumes its rapid heating and no further boiling is noted, as the byproducts of acetylacetone decomposition have largely escaped the reflux condenser. The time required for this evaporation can be dramatically shortened by omitting the reflux condenser from the reaction apparatus. The reaction then rapidly heats to the reaction set point of 320° C., where it is held for 40 minutes with only minor oscillations in temperature, characteristic of PID controllers. A sharp decline of the vC═O peak and the increase of vasymCOO— at the first time point (aliquot 9) indicate the coordination of unbound oleic acid to iron ions forming the iron oleate intermediate. After the initial spike, vasymCOO— remains relatively constant as the concentration of iron oleate plateaus. The continued decline and near disappearance of vC═O may reflect the high temperature decarboxylation of the carboxylic acid moiety. At the final time point in this phase (aliquot 15), when the reaction has been held at 320° C. for 40 minutes, íC═O reaches a minimum.

FIG. 19 shows a) Selected IR absorbance of successive reaction aliquots: vC—H is presented for reference, while vC═O and vasymCOO— allow four distinct phases to be identified in the reaction corresponding to (I) heating and thermal decomposition of the iron precursor, (II) formation and decomposition of iron oleate intermediate (III) particle nucleation, and (IV) nanoparticle growth. b) The corresponding reaction temperature profile. Time points for aliquot withdrawals are indicated by filled circles that have been colored to identify the reaction phase.

Phase III: Particle nucleation. Though no aliquots are withdrawn during this brief phase, nucleation of particles during this step can be inferred by analysis of aliquot 15, taken at the end of Phase II and aliquot 16, taken at the beginning of Phase IV. The spectral changes that occur between Phase II and Phase IV are accompanied by a sudden darkening of the reaction solution from a dark orange-brown color to black, indicating the formation of iron oxide nanoparticles.

Phase IV: Particle growth. This phase of the reaction, represented by aliquots 16-19, is spectroscopically characterized by a dramatic decrease in vasymCOO—, and a slight increase in vC═O. The decrease in vasymCOO— is due to a sudden decrease in iron oleate concentration resulting from the rapid growth of nanoparticles, while the increase in íC═O may be caused by the liberation of oleic acid from the iron oleate. SAXS and TEM analysis of aliquot 16 confirms the presence of large particles, approximately 21 nm in diameter. This range of spectra is characterized by diminished but fairly constant vasymCOO— peak, reflecting the near complete consumption of the iron oleate intermediate in the previous phase. The absence of the vasymCOO— peak in this region also suggests that additional changes to the particle size/shape dispersity in this regime can be attributed to ripening effects.

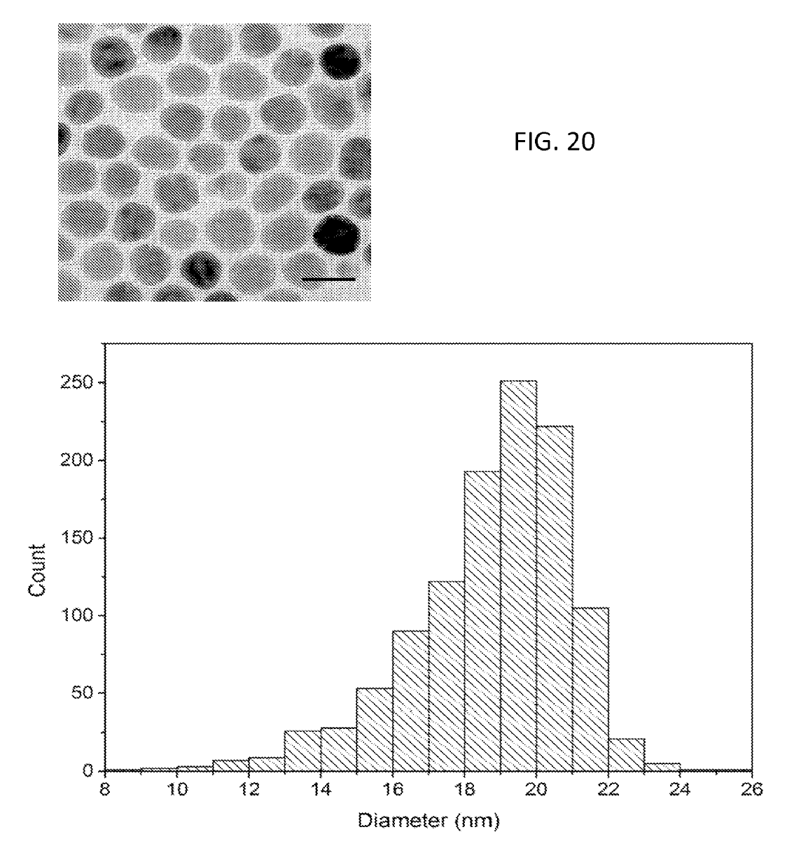

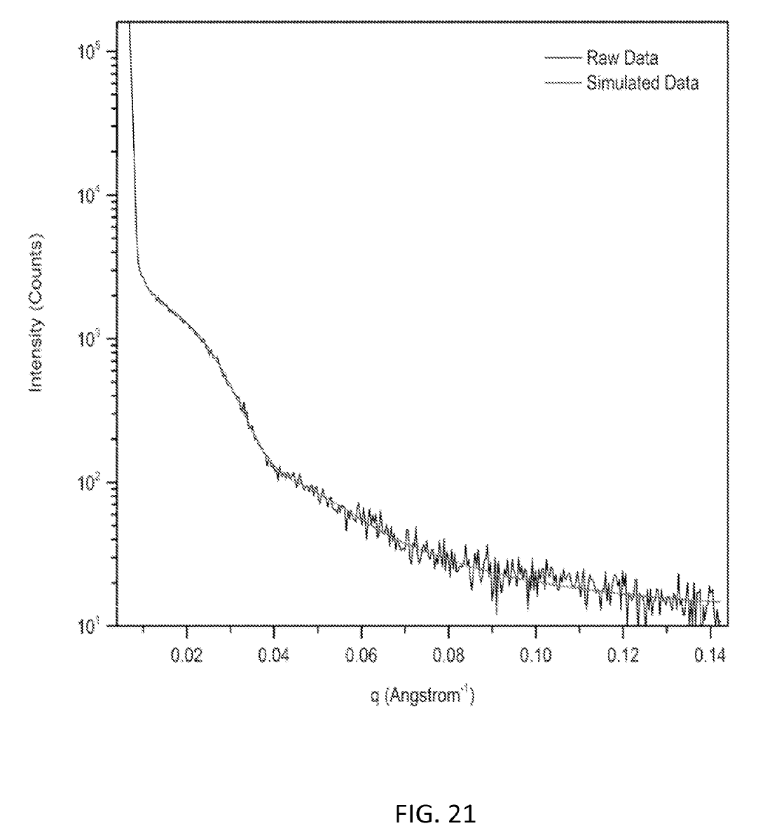

A representative TEM image of particles isolated from aliquot 16 is given with an accompanying histogram in FIG. 20. FIG. 20 shows a) TEM image of particles isolated from aliquot 16 and b) the accompanying TEM size distribution. The scale bar represents 25 nm. The number average of particles analyzed by TEM was 18.7 nm (11.9% dispersity) with a volume average particle diameter of 19.44 nm. These measurements agree reasonably well with the volume average particle diameter of 21.0 nm (15.9% dispersity) measured with SAXS (FIG. 21). FIG. 21 shows raw SAXS data of particles isolated from aliquot 16 and the fit used to obtain the volume average diameter of 21.0 nm and dispersity of 15.9%.

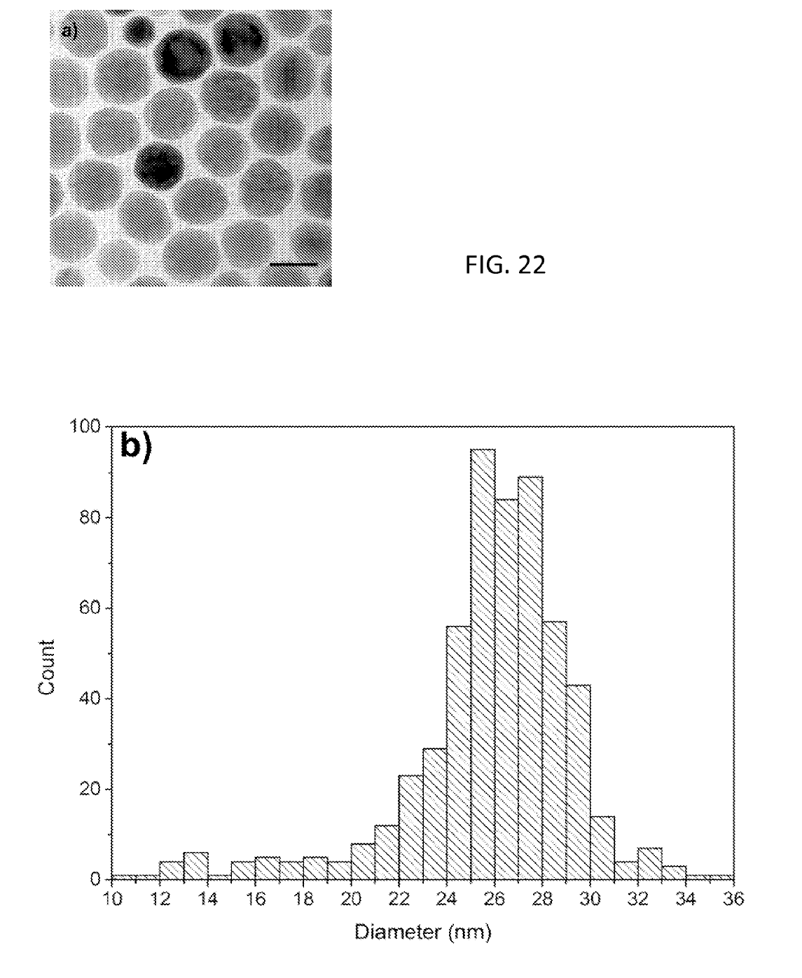

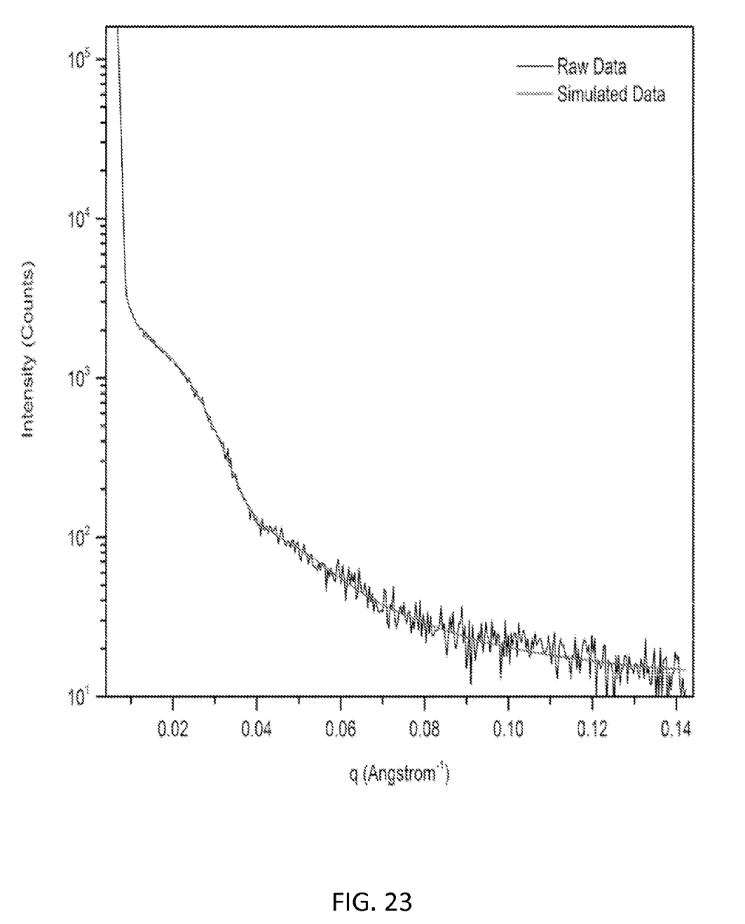

A representative TEM image of particles synthesized without aliquot removal is presented along with an accompanying size distribution histogram in FIG. 22. FIG. 22 shows a) representative TEM image of synthesized iron oxide nanoparticles and b) the accompanying TEM size distribution. The scale bar represents 25 nm. TEM analysis of particle size resulted in a number average particle diameter of 25.8 (13.7% dispersity) and a volume average diameter of 27.0 nm. This agreed with the volume average diameter of 27.0 (12.1% dispersity) obtained by SAXS measurements (FIG. 23). FIG. 23 shows raw SAXS data of particles isolated from a reaction with no aliquots withdrawn and the fit used to obtain the volume average diameter of 27.0 nm and dispersity of 12.2%.

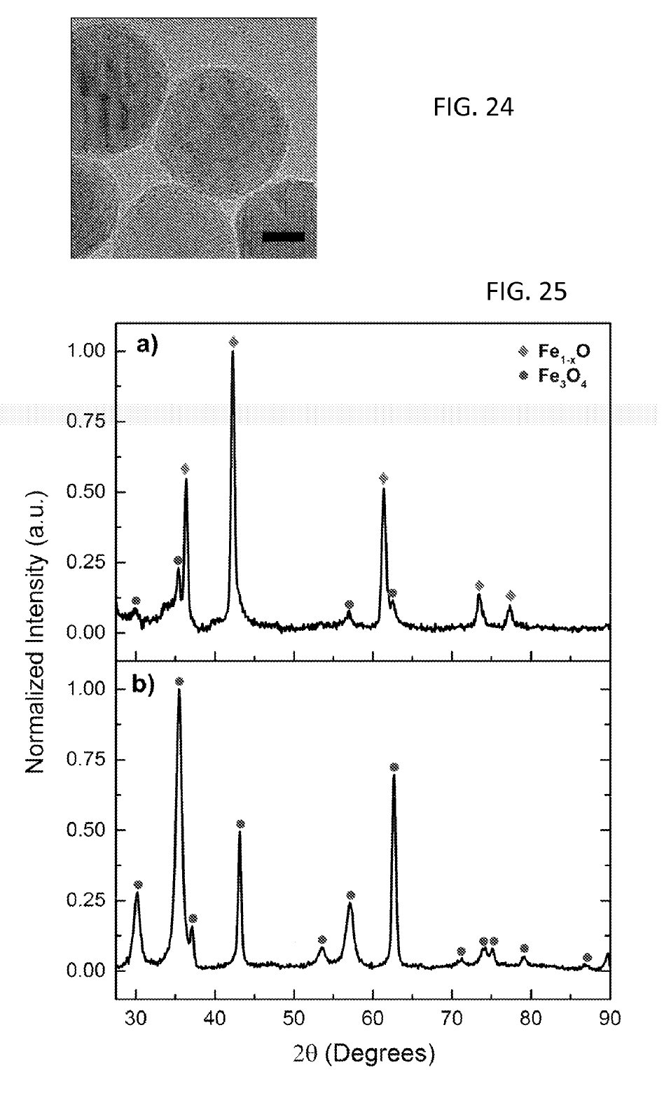

The TEM images reveal the formation of approximately spherical particles with a size distribution skewed toward smaller sizes, indicative of Ostwald ripening. The quality of the synthesized particles is comparable to particles of a similar size synthesized using a custom synthesized iron oleate precursor. Optimal reaction conditions that minimize ripening effects and allow size control will be discussed in the proceeding chapters. A high resolution TEM image shows that several of the particles are single crystalline, with parallel lattice planes extending through the particle, while others appear to be polycrystalline (FIG. 24). FIG. 24 shows an HRTEM image showing several single crystalline particles with parallel lattice planes extending through the particle, while others appear to be polycrystalline. The scale bar represents 10 nm.

XRD measurements were performed on particles isolated at the end of a typical reaction performed without aliquot withdrawal. The diffractogram obtained for the as-synthesized nanoparticles was indexed to wüstite (Fe0.925O, ICDD 01-089-0686), and magnetite (Fe3O4, ICDD 01-076-7165) (FIG. 25). FIG. 25 shows XRD diffractograms of a) as-synthesized particles composed predominantly of Fe1−xO with small Fe3O4 peaks and b) oxidized nanoparticles showing the disappearance of the Fe1−xO phase and the emergence and growth of Fe3O4 peaks. Wüstite is a non-stoichiometric ferrous iron oxide with the general formula Fe1−xO. The formation of wüstite requires the reduction of Fe³⁺ in the precursor, which may result from the mode of decomposition of the Fe-carboxylate species. One proposed decomposition route involves one of the carboxylates leaving as a neutral radical, which leads to the formal reduction of Fe³⁺ to Fe²⁺. At room temperature, Fe1−xO exhibits paramagnetic behavior and exists as a metastable compound that can be converted to α-Fe and Fe3O4 through disproportionation or oxidation. The presence of Fe3O4 peaks in the diffractogram indicates that some oxidation has taken place during handling and measurement. Complete conversion of Fe1−xO to the desired Fe3O4 product can be accomplished by moderate heating of the particle suspension under atmosphere. As-synthesized nanoparticles were oxidized in-situ under atmosphere for six hours at 120° C. and the XRD spectrum collected (FIG. 5-9b). As evidenced by the XRD data, Fe1−xO peaks have disappeared, Fe3O4 peaks initially present in the as-synthesized sample have significantly increased, and several new peaks indexed to Fe3O4 have emerged. However, because Fe3O4 and Fe2O3 peaks overlap in the XRD spectrum, this technique alone is not sufficient to confirm the presence of magnetite. DC SQUID magnetometry was used to verify these findings, as discussed below.

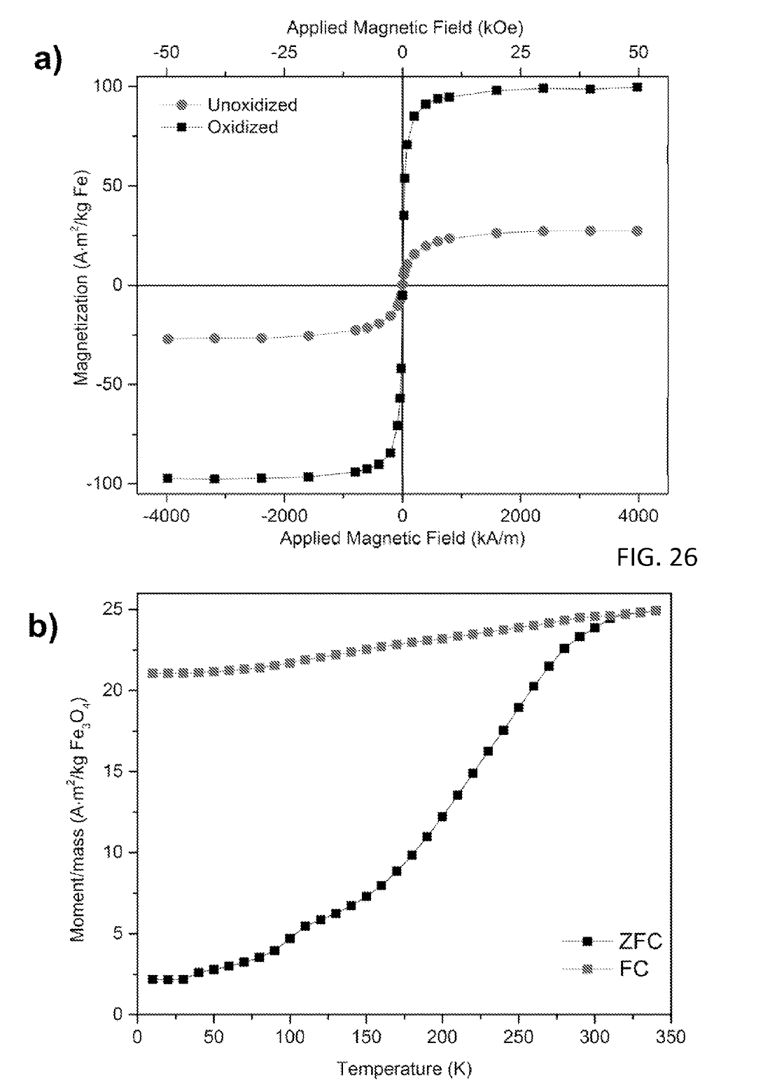

Magnetometry was performed on particles isolated at the end of a typical reaction performed without aliquot withdrawal. The magnetization curves of unoxidized and oxidized particles at 293K are illustrated in FIG. 26. FIG. 26 shows a) Magnetization curves of unoxidized and oxidized particles at 293K. The near quadrupling of the σₛₐₜ reflects conversion of the Fe1−xO particles to Fe3O4 following oxidation. b) ZFC/FC magnetization curves for particles with an applied field of 10 Oe. The magnetization per unit mass (σsat) of the oxidized particles is more than 3.5 times that of the unoxidized particles (99.6 vs. 27.2 A·m²/kg Fe), indicating the conversion of Fe1−xO to Fe3O4 following the oxidation step. The unoxidized particles are, in fact, partially oxidized from exposure to air during handling, as shown in the XRD data, explaining the modest σₛₐₜ value. If the oxidized particles are assumed to be comprised completely of Fe3O4, the calculated σsat is 71.8 A·m²/kg Fe3O4, 78% of bulk Fe3O4 at 293K⁶³, considerably greater than particles of a similar size synthesized using a conventional iron oleate precursor.

The temperature dependent ZFC and FC curves are plotted in FIG. 26. No definitive blocking temperature (TB) was identified within the measured temperature range, attributable to the large size of the particles and the maximum temperature limit achievable using the current apparatus. The Verwey transition, a spontaneous increase in magnetization at ˜120K that is characteristic of Fe3O4, is observed at 111K in this system.

We have demonstrated that iron (III) acetylacetonate can be used as a precursor for the in situ generation of an iron oleate intermediate, and that this intermediate can be thermally decomposed in a one-pot reaction to generate high quality iron oxide nanoparticles. The reaction directly forms wüstite nanoparticles, which readily forms a magnetite shell when exposed to air at room temperature. The wüstite particles can be fully converted to magnetite through moderate heating in air. The magnetite nanoparticles formed in this fashion are highly magnetic, with saturation magnetizations of greater than 78% of bulk.

An advantage is that this reaction contains only commercially available materials, used as received. No prior synthesis or purification of precursors is required, eliminating the irreproducibility introduced by the non-stoichiometric iron oleate precursor. Removing the variation in iron content of the precursor should dramatically improve batch to batch reproducibility and will be explored in the proceeding chapters.

Example embodiment. A Mechanism for Growth of Iron Oxide Nanoparticles with Narrow Shape and Size Dispersity. Rational design of a synthetic method that yields particles with low shape and size dispersity requires knowledge of the nucleation and growth mechanism for a given system. As a particle grows in solution, its structure changes continuously, reflecting the most kinetically preferred morphology until the thermodynamically stable phase is reached. By altering the ligand used in the system or tuning reaction parameters such as temperature, duration, or precursor concentration, the desired particle morphology can be achieved. An example embodiment provides a method that produces spherical particles with low size dispersity, following transformation from kinetically preferred, irregular morphologies.

A kinetic model for the “heating-up” method was first developed by Hyeon et al. for the synthesis of small (<10 nm) nanoparticles from the decomposition of a custom synthesized iron(III) oleate precursor in octadecene. The report demonstrated the utility of the LaMer mechanism in this system: burst nucleation followed by growth of uniformly sized spherical nanoparticles, and then size broadening as Ostwald ripening rapidly led to the formation of larger, cubic-shaped particles. Hyeon's experimental findings also illustrate the evolution of particle shapes for different growth processes. As particle size increased from the diffusion of available monomer species in solution, the particles maintained a spherical shape. As the monomer species was depleted, Ostwald ripening resulted in the formation of increasingly more faceted particles with high size dispersity. Because spherical particles are required for the applications presented previously, identifying a reaction mechanism in our system that favors this morphology is desirable.

The thermal decomposition of Fe(acac)3 in oleic acid was demonstrated to produce 27 nm particles that were approximately spherical in shape. However, the synthesized particles possessed an unacceptably high size dispersity of 12.1%. Employing the same reaction scheme, we show that increasing the reaction temperature to 350° C., just below the boiling point of oleic acid (360° C.), drives the rapid formation of uniformly sized spherical particles. In addition, by developing a mechanism for growth of the nanoparticles, we are able to optimize the reaction duration to prevent unwanted ripening processes from occurring.

A 100 mL three-necked round bottom flask was charged with 1.34 g (3.79 mmol) Fe(acac)3 (99+%, Acros Organics, Fair Lawn, N.J.) and 20 mL (63.0 mmol) oleic acid (technical grade, 90%, Sigma-Aldrich, St. Louis, Mo.). Reaction flasks were equipped with a magnetic stir bar and a thermocouple for monitoring the reaction temperature. Reactions were performed with vigorous stirring under a nitrogen atmosphere, and heated to 350° C. using a heating mantle controlled by a J-KEM 210T PID temperature controller (J-KEM, St. Louis, Mo.). For SAXS/TEM analysis, 8 aliquots of approximately 500 μL each were withdrawn at selected time intervals following nucleation.

Concentrated solutions of samples suspended in hexanes were injected into glass capillary tubes with a 1.0 mm diameter (Charles Supper Company, Natick, Mass.). Samples were analyzed using a Rigaku SmartLab diffractometer system with the SmartLab Guidance system control software. Cu-K-alpha radiation (40 kV, 44 mA) was used in transmission geometry with a scintillation detector. Data analysis was performed using Rigaku NANO-Solver v. 3.5 software, assuming a spherical particle shape, and calculating a volume average diameter.

Samples were prepared by applying a drop of a dilute suspension of nanoparticles in hexanes onto a carbon-coated copper grid (SPI, Westchester, Pa.) and wicking excess liquid away with a Kimwipe. Bright field TEM studies were performed using a JEOL 1200EX TEM operating at 120 kV (JEOL USA, Inc., Peabody, Mass.). Images were collected on a Gatan (Gatan, Pleasonton, Calif.) slow scan CCD camera. Size analysis of imaged particles was performed using ImageJ software.

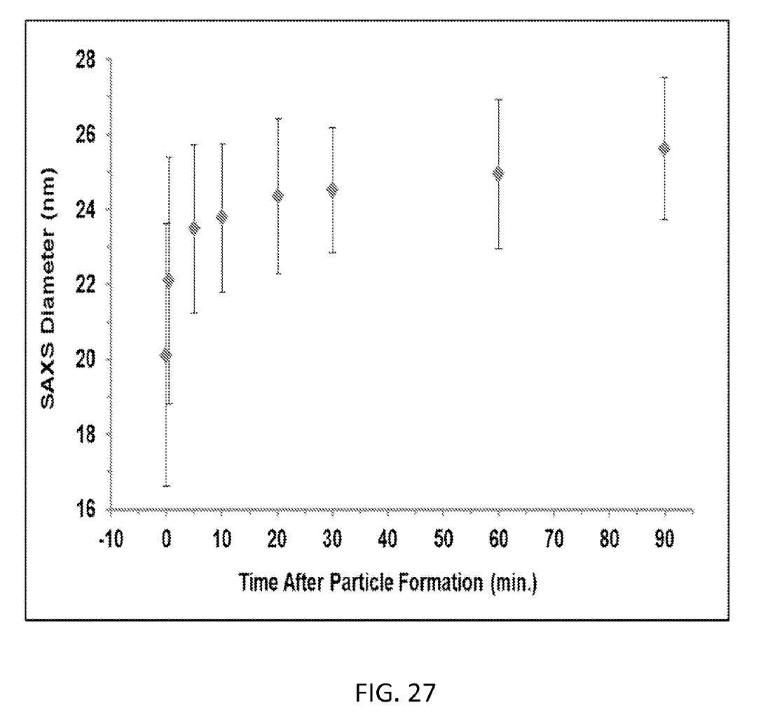

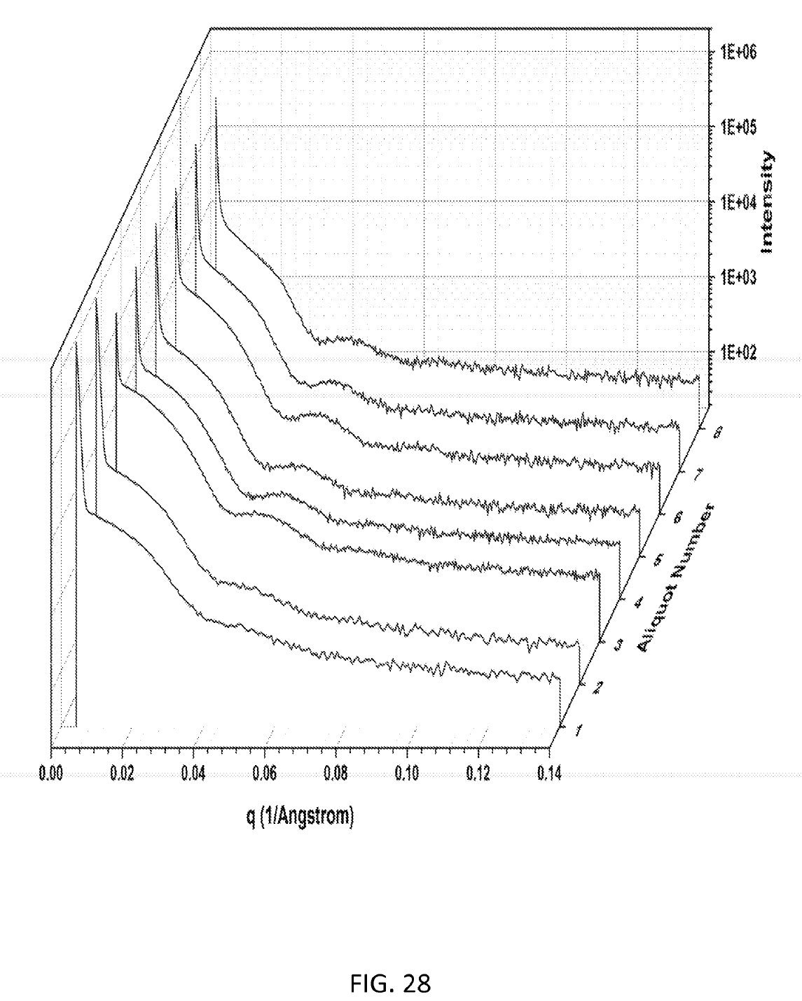

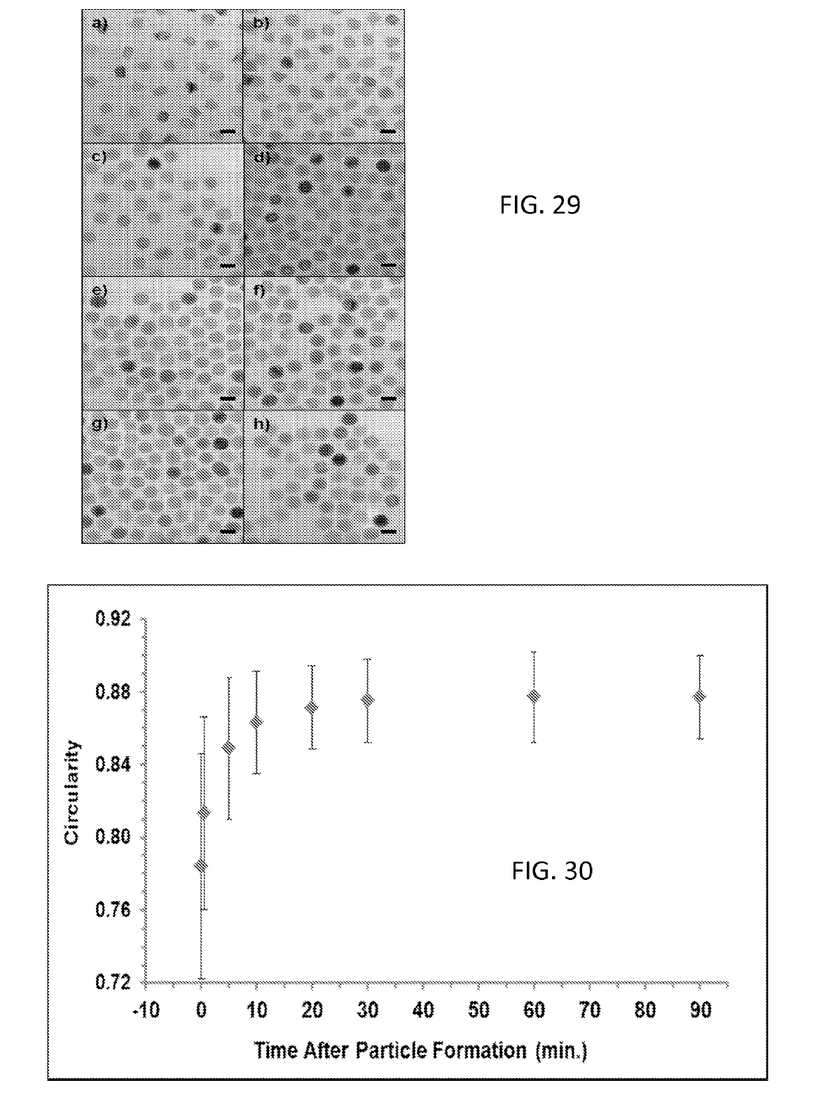

Aliquots were withdrawn immediately upon nucleation, which was observed by the change in color of the reaction solution from brown to black, and at periodic intervals thereafter. The aliquots were subsequently characterized with SAXS and TEM. The SAXS data are summarized in Table 9 and plotted in FIG. 27, with the RAW SAXS data in FIG. 28. FIG. 27 shows the growth of nanoparticles as measured using SAXS. Particle growth and size focusing are rapid in the first five minutes of the reaction and then slow over the remainder of the reaction. TEM image and data analysis follow in FIG. 29, FIG. 30, and Table 10. FIG. 29 shows TEM images for aliquots taken during particle formation and subsequent growth: a) t=0 min., b) t=0.5 min., c) t=5 min., d) t=10 min., e) t=20 min., f) t=30 min., g) t=60 min., and h) t=90 min. Scale bars represent 20 nm. FIG. 30 shows the evolution of particle circularity with reaction time. The particle shape changes most rapidly in the first five minutes of the reaction, with additional shape change slowing as the reaction progresses, with a similar trend occurring for the shape dispersity.

TABLE 9

| Aliquot | Time after particle | SAXS | Size |
|---|---|---|---|
| number | formation (min.) | Diameter (nm) | Dispersity |
| A1 | 0 | 20.11 | 17.4% |
| A2 | 0.5 | 22.10 | 14.9% |
| A3 | 5 | 23.48 | 9.6% |
| A4 | 10 | 23.77 | 8.3% |
| A5 | 20 | 24.34 | 8.5% |
| A6 | 30 | 24.52 | 6.8% |
| A7 | 60 | 24.94 | 8.0% |
| A8 | 90 | 25.62 | 7.4% |

TABLE 10

| Aliquot | Reaction | Average | Shape | |
|---|---|---|---|---|
| number | Time (min.) | Circularity | Dispersity | N |
| A1 | 0 | 0.784 | 7.9% | 244 |
| A2 | 0.5 | 0.813 | 6.5% | 293 |
| A3 | 5 | 0.849 | 4.6% | 313 |
| A4 | 10 | 0.863 | 3.2% | 291 |
| A5 | 20 | 0.871 | 2.6% | 294 |
| A6 | 30 | 0.875 | 2.6% | 297 |
| A7 | 60 | 0.877 | 2.9% | 311 |
| A8 | 90 | 0.877 | 2.6% | 312 |

Inspection of the SAXS data shows that the particle growth can be divided into two regions: rapid growth occurring in the first 5 minutes after nucleation, and a slower growth region from 5-90 minutes after nucleation. The SAXS data show that particles in the first aliquot are relatively large, with a diameter of 20.11 nm and high size dispersity of 17.4%. Within the following 30 seconds, the particle diameter increased significantly by 10%, with a 2.5% decrease in size dispersity. At the five minute time point, particle size increased by an additional 5.9% to 23.48 nm and size dispersity decreased to 9.6%. After this time point, particle growth slows until particles reach a maximum size of approximately 25 nm.

The rapid size focusing in the first few minutes of the reaction results from the high concentration of monomer species in the solution. The Gibbs-Thomson effect, which describes the relationship between the chemical potential of a particle and its radius, drives the growth of the particles to reduce the surface free energy of the system. The irregularly shaped particles observed in the early stages of the reaction gradually transform into an increasingly spherical shape, which represents a stable, minimal surface energy morphology. This is evidenced by the sustained narrowing of size dispersity measured by SAXS, with a minimum at 30 minutes following particle formation. Though SAXS measurements show that the size dispersity increased slightly as the reaction progressed further, the dispersity of the particles measured at the end of the reaction remained quite narrow at 7.4%.

The SAXS data fits are performed assuming a spherical particle shape, so TEM analysis provides a more realistic physical picture of the changing particle morphology as the reaction progresses. TEM images of the sample aliquots are shown in FIG. 6-3. The circularity of the particles was extracted from images analysis data using the formula 4π(area/perimeter²), where a circularity of 1.0 describes a perfect circle. Assuming a Gaussian distribution of circularity values, the average values and standard deviations for each sample are provided in Table 10 and plotted in FIG. 30. The trend toward increasing particle circularity is visible in FIG. 29, with what appear to be perfectly circular particles in images taken of the last three aliquots.

Analysis of the TEM images in FIG. 29 shows that the particles formed in the first 30 seconds of the reaction have an irregular polyhedral shape with high size dispersity. The circularity of the particles increases rapidly, from 0.784 at the first time point, to 0.849 five minutes later. There is a sharp decrease in the shape dispersity during this time as well, from 7.9% to 4.6%. In agreement with the SAXS data, this trend slows as the reaction proceeds, with additional narrowing of shape dispersity stabilizing at 2.6%. Tp109he circularity calculations, however, are not close to the expected value of 1.0, but have values close to 0.87. This can be explained by considering the image analysis procedure. Slight roughness can develop around the particle edge when the grayscale image is converted to an 8-bit black and white image through the thresholding algorithm. This would naturally increase the perimeter of the particles, and the error would be exaggerated by the perimeter² term in the denominator of the calculation.

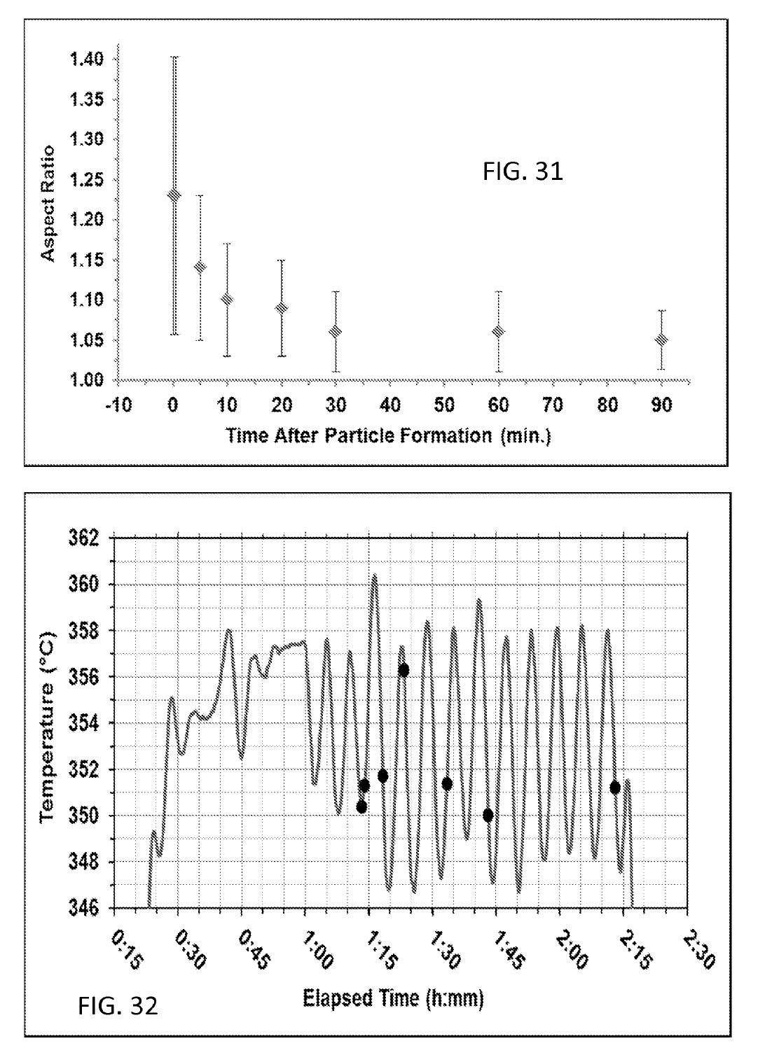

To further support that the particles are nearly perfectly spherical by the end of the reaction, the aspect ratio of the measured particles was also acquired from the image analysis data. Aspect ratio is the length of the major axis divided by the length of the minor axis, so a perfect circle would have an aspect ratio of 1. The measured aspect ratio of the imaged particles is shown in Table 11, plotted in FIG. 31, and shows the same trend of increasing circularity and decreasing shape dispersity as the reaction progresses. FIG. 31 shows the change in the aspect ratio of the particles as the reaction progresses. At the end of the reaction, the particles have and average aspect ratio of 1.05, nearly perfectly circular. Initially, the aspect ratio of the particles is 1.23 with a large dispersity of 14.1%. This value decreases rapidly in the first five minutes of the reaction, and by the 30 minute time point, the average aspect ratio decreased to a nearly perfectly circular value of 1.06. By the final time point, the aspect ratio reached a minimum value of 1.05 with a shape dispersity of 3.5%.

TABLE 11

| Aliquot | Reaction | Aspect | Shape | |
|---|---|---|---|---|
| number | Time (min.) | Ratio | Dispersity | N |
| A1 | 0 | 1.23 | 14.1% | 244 |
| A2 | 0.5 | 1.23 | 14.1% | 293 |
| A3 | 5 | 1.14 | 7.9% | 313 |
| A4 | 10 | 1.10 | 6.4% | 291 |
| A5 | 20 | 1.09 | 5.5% | 294 |
| A6 | 30 | 1.06 | 4.7% | 297 |
| A7 | 60 | 1.06 | 4.7% | 311 |
| A8 | 90 | 1.05 | 3.5% | 312 |

The TEM images illustrate the evolution of particle morphology following nucleation. The first particles observed to form in this reaction are highly anisotropic, and exist for a brief period as a lower surface energy, spherical morphology is assumed. 30 minutes after nucleation, this process is complete.

The temperature profile of the reaction is given in FIG. 32, with time points for aliquot withdrawals following indicated with black markers. FIG. 32 shows the temperature profile for the experiment. Time points for aliquot withdrawals following particle nucleation are indicated by black circles. A final aliquot (A*) was withdrawn when the reaction had cooled to 120° C. A final aliquot not shown in the temperature range plotted, was withdrawn when the reaction cooled to 120° C. The oscillations of the temperature of ±10° C. about the 350° C. set point are characteristic of the commercial PID temperature controller used.

The iron oxide nanoparticle growth study illustrated the process by which spherical particles with nearly uniform size dispersity are formed at high temperatures using the “heating-up” method. Knowledge of the growth mechanism is critical, particularly when determining the reaction parameters required for minimizing shape and size dispersity. With this approach, we have shown that a kinetically preferred morphology present in the early stages of the reaction is replaced by a spherical morphology with nearly uniform shape and size dispersity.

Example embodiment. Exquisite Control of Particle Size Using an “Extended” LaMer Mechanism. The properties of magnetic nanoparticles vary dramatically with size, and precise, reproducible control of size is critical if their full potential is to be realized in clinical applications. Typical approaches to achieving reproducible control of nanoparticle size have focused on the ligand used to stabilize the particles, or parameters reported to be influential for nucleation, such as the temperature ramp rate. Temperature ramp rate is a difficult parameter to maintain reproducibly between reactions, while modifying the ligand concentration in a series of closed reactions results in discrete nanoparticle sizes that do not reflect true size control over a range of particle diameters. Here, we present an approach for synthesis of nanoparticles using an open system. Precursor species are supplied to the reaction solution in a constant and quantifiable manner, providing precise control of particle sizes over a broad range. The growth of particles can then be extended for an arbitrarily long time, allowing particle size to be tuned by reaction duration. This synthetic approach reproducibly yields spherical particles with nearly uniform size dispersity.

This example embodiment, which we refer to hereafter as the “Extended” LaMer mechanism, is to use a continuous addition of precursor to maintain a steady state concentration of the monomer species in solution while maintaining all other parameters constant. The result is a slow, steady growth of particles with a predictable growth trajectory that can be altered by changing details such as addition rate and ligand concentration. Homogeneous nucleation and growth of nanoparticles in an open system has not been demonstrated for high temperature, thermolytic nanoparticle synthesis.

With respect to iron oxide nanoparticle synthesis, continuous addition of a stoichiometric iron precursor species has been limited by the properties of the compounds themselves. As discussed previously, conventionally prepared iron(III) oleate cannot be reliably synthesized in a reproducible way. Fe(acac)3, on the other hand, while crystalline, has limited solubility in organic solvents that would lend to its slow, controlled addition to a reaction. However, we showed that iron(III) oleate can be prepared in situ from the decomposition of Fe(acac)3 in oleic acid. In situ preparation of iron(III) oleate provides a means by which an iron precursor with a known quantity of iron can be prepared. Additionally, the iron(III) oleate prepared in this way requires no further manipulation such as washing that can lead to uncertainty regarding the final iron content.

By continuous addition of iron(III) oleate to a heated solvent solution, we demonstrate reproducible control of a kinetic growth mechanism that dictates spherical crystal morphology over a range of particle diameters with low size dispersity. Further, we demonstrate the reaction parameters necessary for achieving isotropic growth of particles with time.

Iron(III) oleate synthesis. For these experiments, iron(III) oleate compounds were prepared in situ using methods similar to those presented previously. Briefly, three iron(III) oleate precursors were prepared using varying concentrations of Fe(acac)3 in oleic acid. In a typical preparation, 15 mL (47.3 mmol) of oleic acid (technical grade, 90%, Sigma-Aldrich, St. Louis, Mo.), was combined with 14.16 mmol (0.94M), 9.34 mmol (0.62M), or 4.73 mmol (0.32M) Fe(acac)3 (99+%, Acros Organics, Fair Lawn, N.J.). The reagents were combined in a 100 mL round bottom flask and submerged in a custom molten metal bath using Bolton 174*, a low melting point metal alloy (Bolton Metal Products, Bellefonte, Pa.). The reaction was stirred vigorously using a compact overhead stirrer (Caframo, Ontario, Calif.) under a nitrogen atmosphere. The reaction was heated to a set point of 320° C. for the length of time necessary to form the iron(III) oleate complex. At the end of the heating period, the reaction was removed from the metal bath and cooled to room temperature. Iron(III) oleate formation was confirmed using FTIR spectroscopy.

Infrared spectra of synthesized precursors were collected on a Bruker IFS 66vS infrared spectrometer (Bruker Optik GmbH, Germany). Aliquots were characterized using a grazing angle attenuated total reflectance (GATR) accessory with a fixed 65° incidence angle and a hemispherical germanium crystal (Harrick Scientific Products Inc., Pleasantville, N.Y.). 256 scans of each sample were collected at 2 cm⁻¹ resolution from 3400 cm⁻¹ to 700 cm⁻¹ using a liquid nitrogen cooled MCT detector. Extended ATR correction was performed on the collected spectra using Opus 6.5 software assuming an index of refraction of 1.5 for the aliquots. No additional baseline corrections were performed.

To demonstrate nucleation and growth of iron oxide nanoparticles by continuous addition of iron(III) oleate precursor, and to understand the parameters that influenced particle growth rates, several types of experiments were performed. These experiments varied the concentration of the iron in the precursor solution, the addition rate of the iron precursor, and the amount of excess oleic acid in the solvent solution.

Growth of iron oxide nanoparticles by continuous addition of iron(III) oleate. To facilitate injection with a syringe, the synthesized iron(III) oleate precursors were diluted in 1-octadecene, a non-interacting, high boiling point solvent (Table 12). The diluted iron(III) oleate solutions were loaded into a Norm-Ject syringe, to which a 6″ penetration needle was attached.

TABLE 12

| [Iron(III) Oleate] | [Iron(III) Oleate] after |
|---|---|
| as prepared (M) | dilution with octadecene (M) |
| 0.94 | 0.33 |
| 0.62 | 0.22 |
| 0.32 | 0.11 |

Typically, a reaction flask containing a 8.0 mmol docosane and 5.5 mmol (1.1M) oleic acid was heated to 350° C. in a molten metal bath with rapid stirring under a nitrogen atmosphere. For some experiments, no oleic acid was added to the reaction flask. When the reaction temperature stabilized at 350° C., the precursor was dripped into the solution at 3 mL/hr using a Chemyx syringe pump (Chemyx Inc., Stafford, Tex.). To explore the effect of drip rate on particle growth rate, the injection rate was varied by decreasing to 1.5 mL/hr or increasing to 6 mL/hr. The reaction was timed from the moment the first drop of precursor was injected into the flask. Nucleation of particles was observed by an instantaneous change in the color of the reaction solution from dark brown to black. Aliquots were withdrawn from the reaction as close as possible to the nucleation event and at periodic intervals thereafter.

Concentrated solutions of samples suspended in hexanes were injected into glass capillary tubes with a 1.0 mm diameter (Charles Supper Company, Natick, Mass.). Samples were analyzed using a Rigaku SmartLab diffractometer system with the SmartLab Guidance system control software. Cu-K-alpha radiation (40 kV, 44 mA) was used in transmission geometry with a scintillation detector. Data analysis was performed using Rigaku NANO-Solver v. 3.5 software, assum198

Samples were prepared by applying a drop of a dilute suspension of nanoparticles in hexanes onto a carbon-coated copper grid (SPI, Westchester, Pa.) and wicking excess liquid away with a Kimwipe. Bright field TEM studies were performed using a JEOL 1200EX TEM operating at 120 kV (JEOL USA, Inc., Peabody, Mass.). HRTEM images were acquired using a Tecnai G² F30 TEM using a 300 keV acceleration voltage (FEI, Hillsboro, Oreg.). Size analysis of imaged particles was performed using ImageJ software.

Magnetization measurements were collected using a Quantum Design MPMS-7 SQUID magnetometer. Samples were prepared by depositing a small amount of the synthesized nanoparticles suspended in hexanes onto the end of a Q-tip™ cotton swab and flame-sealing the sample in an NMR tube under vacuum. Magnetization curves were recorded from −50 kOe to +50 kOe (−4000 kA/m-+4000 kA/m) at 293K. Data were corrected for the slight paramagnetic signal contributed by the NMR tube at high fields. Zero-field cooled (ZFC) magnetization curves were obtained by cooling the sample to 5K with no applied field, then applying a field of 10 Oe (0.8 kA/m), and recording the magnetization from 5K to 345K. With the 10 Oe field still applied, the sample was then cooled from 345K to 5K to obtain the field-cooled (FC) magnetization. The precise iron mass of each sample was determined destructively by heating the Q-tip™ in a 600° C. furnace for 1 hour to incinerate the organic material and then dissolving the iron containing residue in hydrochloric acid. A phenanthroline/Fe²⁺ complex was formed in solution and spectrophotometrically quantified using the concentration of a known dilution.

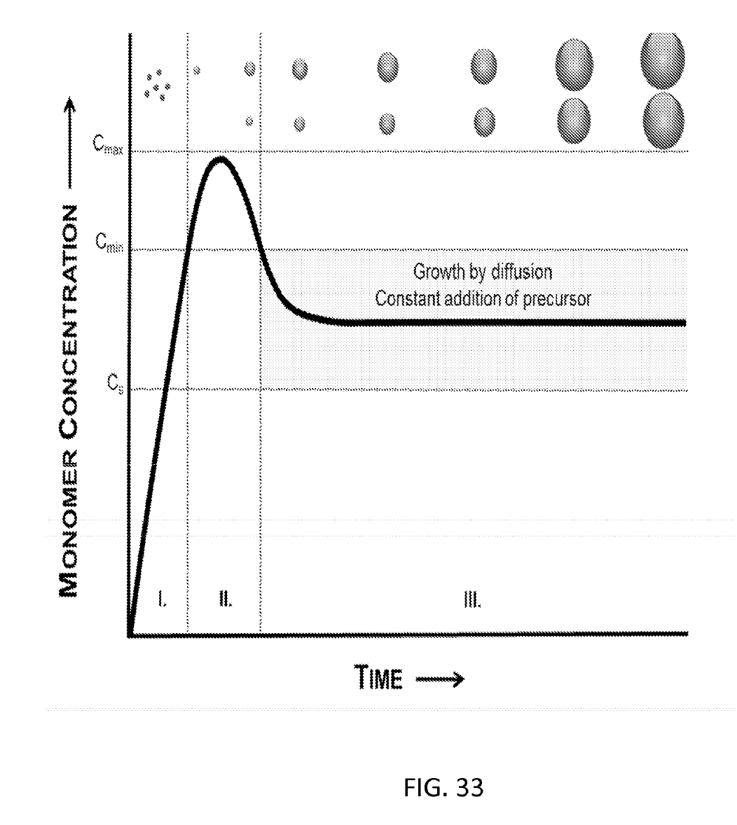

We describe the growth of nanoparticles by continuous addition of precursor species as the “Extended” LaMer mechanism (FIG. 33). FIG. 33 shows an example embodiment for the “Extended” LaMer Mechanism: stages I and II are identical to the original formalism devised by LaMer, but continuous addition of precursor in stage III allows steady growth of particles to an arbitrarily large size, while suppressing Ostwald ripening. The top panel shows the nucleation of particles in stage II, with an intrinsic size dispersity that is narrowed in the presence of a constant supply of precursor. The underlying principles of the LaMer mechanism still apply to this method: in stage I, the monomer concentration increases in solution until a critical, supersaturation concentration is reached. In stage II, burst nucleation occurs and partially relieves the supersaturation condition, and in stage III, particle growth proceeds by diffusion of the monomer species to the particle surface. It is in this stage that a novel modification to the classical LaMer mechanism is introduced. The steady addition of monomer species in stage III facilitates the continuous growth of particles to an arbitrarily large size while maintaining low size and shape dispersity. In the classical LaMer mechanism, particle growth in this stage is initially subject to the availability of the monomer species. In a solution that has been depleted of monomer species, Ostwald ripening leads to the dissolution of small particles and the growth of larger particles. In nanoparticle synthesis, ripening is a process that is often associated with highly undesirable increases in size dispersity. However, by maintaining a sufficiently high concentration of monomer species in Stage III, ripening processes can be suppressed, resulting in a decrease, rather than an increase of the size distribution.

Focusing and broadening of the size distribution can both be explained by the Gibbs-Thomson relationship given in Equation (1-1) that describes the relationship between the chemical potential of a particle and its radius, i.e., smaller particles have a higher chemical potential than larger particles. When the concentration of the monomer species in solution is supersaturated, smaller particles grow faster than larger particles to reduce the surface free energy and size focusing occurs. In a limiting concentration of monomer, the high chemical potential of smaller particles results in their dissolution in favor of the growth of larger particles and broadening of size dispersity results.

We demonstrate the application of the Extended LaMer mechanism to the current system with the following scheme: in stage I, iron(III) oleate is added at a constant rate to a heated solution of docosane and oleic acid. The thermal decomposition of iron (III) oleate results in the accrual of an oleic acid-stabilized iron monomer species. In stage II, a critical supersaturation concentration is reached, inducing nucleation of iron oxide nanoparticles and partially relieving the supersaturation of iron monomer species. In stage III, the continued addition of iron(III) oleate at a constant rate establishes a steady-state concentration of monomer species that allow growth of stable nuclei without an additional nucleation event. Particles can be grown to an arbitrarily large size, which can be tuned simply by changing the reaction duration. Here, we demonstrate that this approach yields steady, isotropic growth of spherical iron oxide nanoparticles with nearly uniform shape and size dispersity.

The formation of the iron(III) oleate precursor was verified by the presence of characteristic peaks in the FTIR spectrum. The decline of íC═O contributed by free oleic at 1710 cm⁻¹ and the growth of strong peaks at 1613 and 1578 cm⁻¹ from íasymCOO⁻ and 1444 cm⁻¹ from ísymCOO⁻, confirm the formation of the iron(III) oleate species. Further, the intensities of the characteristic peaks provide a quantifiable measure by which reproducible synthesis of the precursor can be ensured between batches.

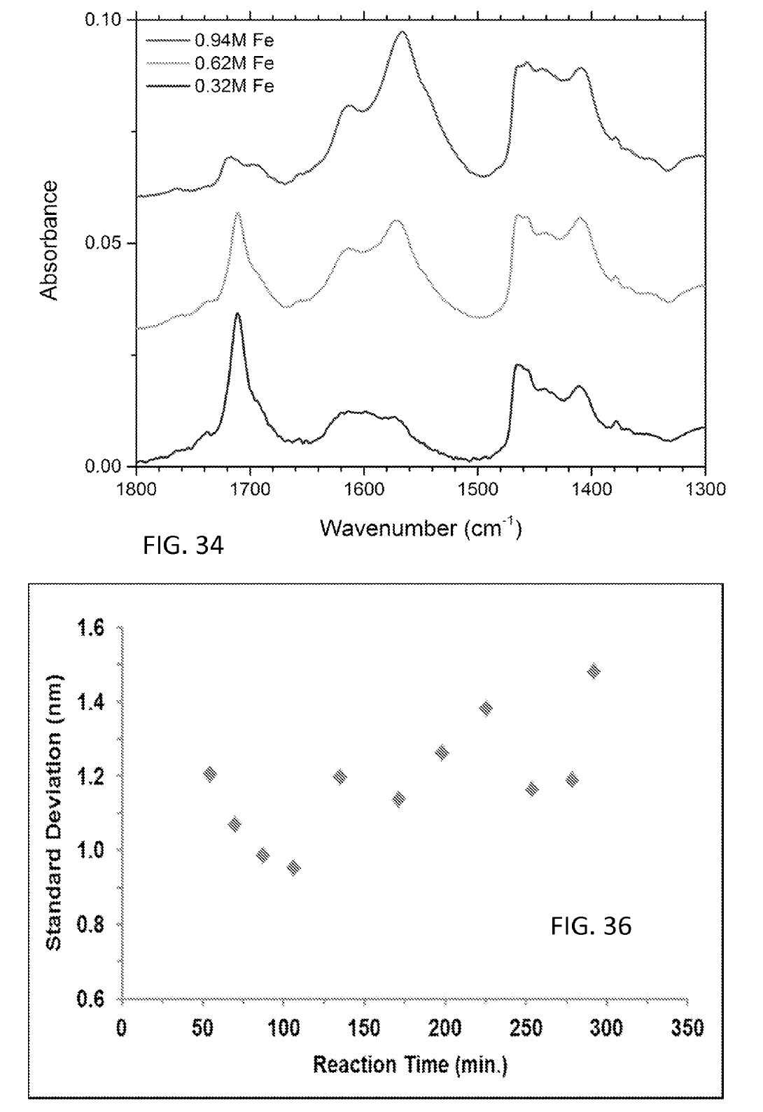

For the experiments presented here, three iron(III) oleate compounds with decreasing concentrations of Fe(acac)3 were prepared: 0.94M, 0.62M, and 0.32M The FTIR spectra of these three iron oleate compounds is shown in FIG. 34. FIG. 34 shows IR spectra of iron oleate precursor material prepared with 0.94M, 0.62M, and 0.32M Fe(acac)3. The characteristic vasymCOO— and vsymCOO— peaks are strongest in the sample prepared with 0.94M Fe(acac)3, and lowest in the sample prepared with 0.32M Fe(acac)3, reflecting the amount of iron oleate present in the sample. As expected, the change in intensity of vC═O peak from free oleic acid is inversely proportional to the intensities of the vCOO— peaks. The prepared iron(III) oleate compounds were subsequently used in the nanoparticle growth experiments described below.

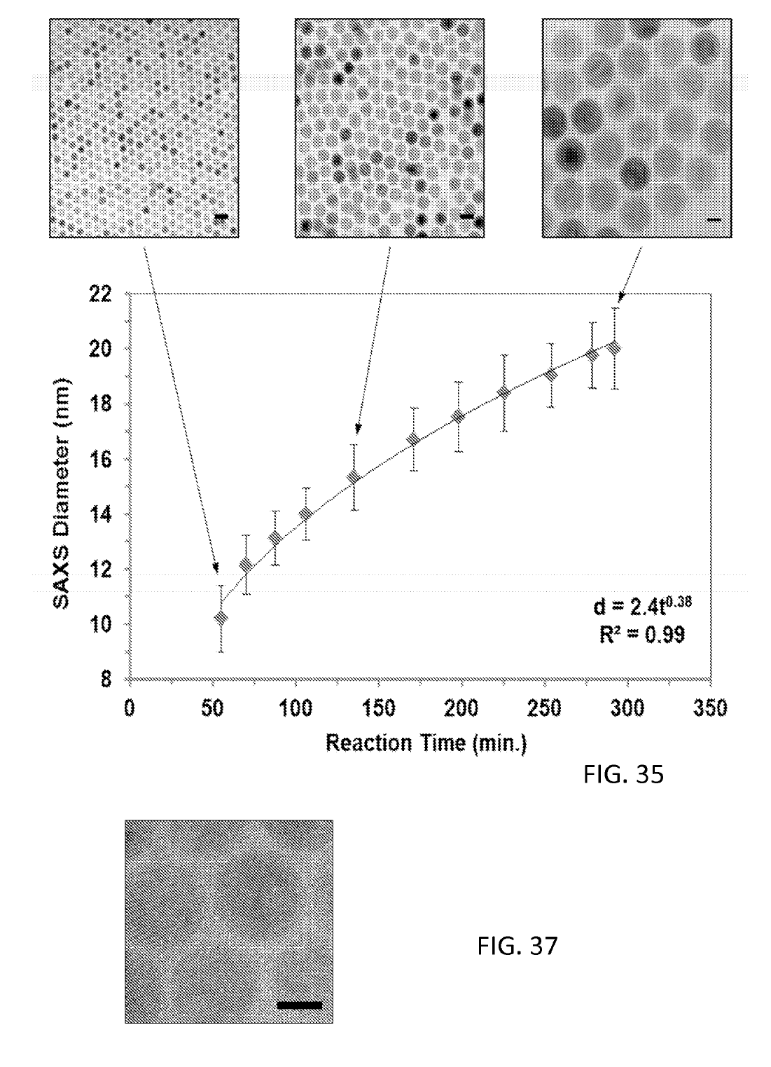

For the nanoparticle synthesis, a 0.22M solution of iron(III) oleate was added to a heated solution containing 1.1M oleic acid in docosane at 3.0 mL/hr. The reaction time began when the first drop of iron fell into the solvent solution and ended when the addition was stopped five hours later. An aliquot was withdrawn when nucleation was observed and at periodic intervals thereafter. Nucleation can be visibly observed by a sudden change of the reaction solution from brown to black. SAXS data is summarized in Table 13 and plotted in FIG. 35. FIG. 35 shows a growth curve of iron oxide nanoparticles as measured using SAXS. Isotropic growth of particles with low shape and size dispersity is observed for the duration of the reaction. Scale bars on TEM images represent 20 nm. TEM images of selected aliquots are included in the plot of SAXS data to illustrate the particle size and morphology as the reaction progresses.

The particles sampled in the first aliquot are uniformly circular in shape, with a relatively low size dispersity of 11.8%. Approximately 15 minutes later, the particles have increased in size, and the size dispersity has decreased to 8.8%. Particle growth continues and size dispersity decreases until the 135 minute time point, when dispersity increases slightly. However, TEM analysis shows that the particles withdrawn at this time point have maintained a spherical shape. As the reaction progresses, the particles continue to grow, while the size dispersity as calculated by SAXS shows small increases. FIG. 36 plots the change in size dispersity as a function of reaction time, illustrating the size focusing in the beginning of the reaction and the gradual trend toward increasing size dispersity at extended reaction times. FIG. 36 shows the change in standard deviation of particle size as a function of reaction time. Size focusing occurs early in the reaction, with a trend of increasing size dispersity as the reaction proceeds. However, after five hours, the size dispersity is still just 7.4%, with a standard deviation of 1.48 nm from the mean particle size of 20 nm. A high resolution TEM image of 20 nm nanoparticles shows uniformly circular particles with good crystallinity. Lattice planes extending to the surface of particles can be seen, indicating that the particles are single crystalline (FIG. 36). FIG. 37 is an HRTEM image of 20 nm iron oxide nanoparticles. Lattice planes extend to the surface of the particle, indicating that particles are single-crystalline. The scale bar represents 20 nm.

TABLE 13

| | Reaction | Fe | SAXS | | |
|---|---|---|---|---|---|
| Aliquot | Time | Injected | Diameter | Standard | Size |
| number | (min.) | (mmol) | (nm) | Dev. (nm) | Dispersity |
| A1 | 54.8 | 0.60 | 10.21 | 1.20 | 11.8% |
| A2 | 70.0 | 0.77 | 12.14 | 1.07 | 8.8% |
| A3 | 87.4 | 0.96 | 13.11 | 0.98 | 7.5% |
| A4 | 106.2 | 1.17 | 13.99 | 0.95 | 6.8% |
| A5 | 135.2 | 1.49 | 15.32 | 1.19 | 7.8% |
| A6 | 171.2 | 1.88 | 16.70 | 1.14 | 6.8% |
| A7 | 198.0 | 2.18 | 17.53 | 1.26 | 7.2% |
| A8 | 225.6 | 2.48 | 18.39 | 1.38 | 7.5% |
| A9 | 253.8 | 2.79 | 19.03 | 1.16 | 6.1% |
| A10 | 278.6 | 3.06 | 19.78 | 1.19 | 6.0% |
| A11 | 292.2 | 3.21 | 20.01 | 1.48 | 7.4% |

Plotting the particle diameter as a function of reaction time allows for the growth rate to be fitted with a power law. We endeavor to identify the reaction parameters that will yield isotropic growth of spherical particles, thus a power law fit of diameter vs. reaction time should have a t^{0.33} dependence. For the reaction plotted in FIG. 35, the particle growth rate follows a t^{0.38} dependence. If we consider the case of isotropic particle growth, particle volume increases linearly with time. Since V≈d³, it follows that d³ will increase linearly with time, or that d will increase as t^{1/3}. As t is raised by an increasing exponential value, the growth rate of the particle actually decreases. Thus, a t^{0.38} fit means that the particle volume is no longer growing linearly in time, but has decreased to d^{2.6} growth with time.

Knowledge of the growth trajectory allows prediction of the maximum particle size attainable for a given reaction time, in turn providing size tenability of particle growth. Further, the power law dependence can provide insight to the mode of particle growth. t^{0.33} dependence is characteristic of diffusion limited particle growth (Equation (1-16)), while a t^{0.5} dependence reflects surface reaction limited growth (equation 1-19). A value of the exponent between 0.33 and 0.5 suggests mixed diffusion and surface reaction control. Additional experiments describe below illuminate whether the t^{0.33} dependence is intrinsic to the system or if it is subject to change as a function of reaction parameters such as iron concentration or addition rate.

From the reaction plotted in FIG. 35, the particle size obtained after a five hour reaction time is 20.01 nm. Following the t^{0.38} dependence of particle growth, a doubling of the reaction time to 10 hours would only result in the growth of particles by an additional 7 nm. It is apparent that for a given concentration of iron(III) oleate, there is a maximum particle size that can be achieved in a reasonable reaction timeframe. Increasing the iron concentration in the precursor solution is one approach by which the maximum particle size can be increased within a given timeframe.

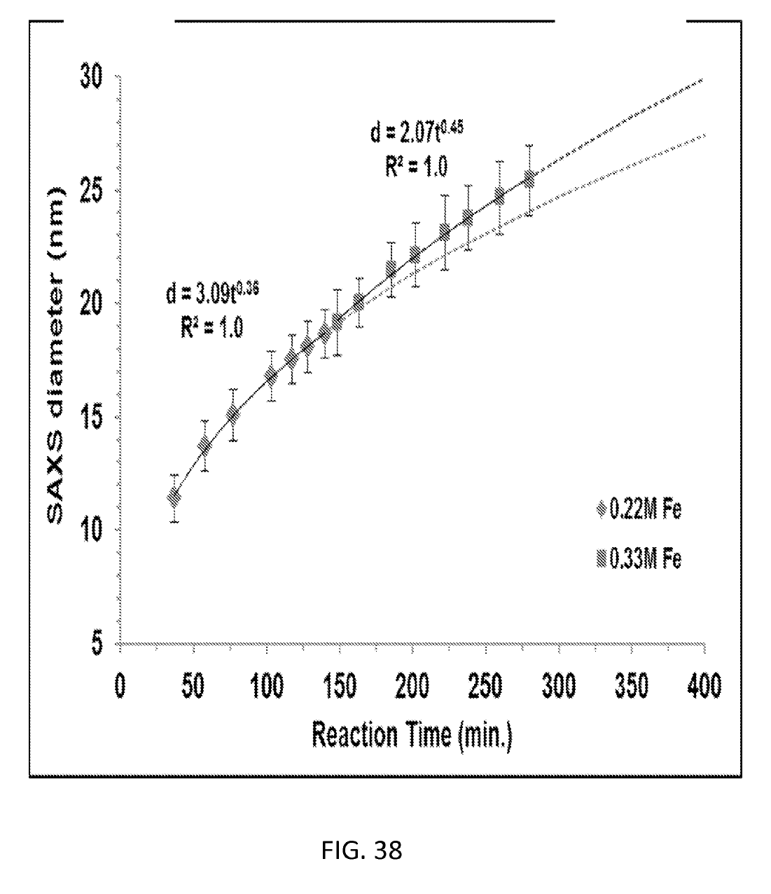

For the experiments described in this section, a 0.22M solution of iron(III) oleate in octadecene was added to a heated solution containing 1.1M oleic acid in docosane at 3.0 mL/hr. The reaction time began when the first drop of iron fell into the solvent solution. An aliquot was withdrawn when nucleation was observed and at periodic intervals thereafter. After approximately 2 hours, the 0.22M solution was exchanged for a 0.33M solution of iron(III) oleate in octadecene, with the same 3.0 mL addition rate. Particle growth was allowed to continue for an additional 2.5 hours, with aliquots withdrawn at periodic intervals. Aliquots were characterized using SAXS, the results of which are summarized in Table 14 and plotted in FIG. 38. Table 14 shows a summary of SAXS data for aliquots drawn over the course of a reaction performed by continuous addition of 0.22M Fe(III) oleate at 3.0 mL/hr followed by continuous addition of 0.33M Fe(III) oleate at 3.0 mL/hr. FIG. 38 shows a growth curve of iron oxide nanoparticles as a 0.22M Fe solution is injected (blue) and then exchanged for a 0.33M Fe solution. Particle growth rate for the 0.22M Fe solution is slightly faster than that of the 0.33M Fe solution.

TABLE 14

| | | | | | |
|---|---|---|---|---|---|
| | Reaction | Fe | SAXS | | |
| Aliquot | Time | Injected | Diameter | Standard | Size |
| number | (min.) | (mmol) | (nm) | Dev. (nm) | Dispersity |

0.22M Fe(III) Oleate

| | | | | | |
|---|---|---|---|---|---|
| A1 | 23 | 0.41 | 11.42 | 1.04 | 9.1% |
| A2 | 43 | 0.64 | 13.71 | 1.12 | 8.2% |
| A3 | 63 | 0.85 | 15.06 | 1.14 | 7.6% |
| A4 | 90 | 1.13 | 16.78 | 1.11 | 6.6% |
| A5 | 103 | 1.29 | 17.51 | 1.05 | 6.0% |
| A6 | 114 | 1.41 | 18.07 | 1.14 | 6.3% |
| A7 | 127 | 1.54 | 18.67 | 1.06 | 5.7% |

0.33M Fe(III) Oleate

| | | | | | |
|---|---|---|---|---|---|
| A8 | 143 | 1.68 | 19.16 | 1.42 | 7.4% |
| A9 | 158 | 1.93 | 20.04 | 1.08 | 5.4% |
| A10 | 180 | 2.29 | 21.47 | 1.18 | 5.5% |
| A11 | 197 | 2.56 | 22.14 | 1.45 | 6.5% |
| A12 | 217 | 2.89 | 23.11 | 1.64 | 7.1% |
| A13 | 233 | 3.15 | 23.77 | 1.43 | 6.0% |
| A14 | 254 | 3.51 | 24.68 | 1.60 | 6.5% |
| A15 | 275 | 3.85 | 25.42 | 1.53 | 6.0% |

The trajectory of particle growth in the first segment of the reaction using the 0.22M iron(III) oleate precursor is nearly identical to the reaction detailed in the previous section. Particles grow with a t^{0.36} dependence, very close to the t^{0.38} dependence observed previously. Rapid size focusing and sustained, nearly uniform size dispersity further demonstrate that the 0.22M iron(III) oleate precursor can be used for reproducible synthesis of particles for the reaction times tested here.

In the second segment of the reaction, following the increase of iron(III) oleate precursor concentration to 0.33M, the particles continue to grow with very narrow size dispersity. The increase in iron concentration appears to have induced a slight increase in the observed size dispersity from 5.7% at the end of the first segment to 7.4% in the second segment, but this increase was temporary, with additional size focusing resulting in a decrease of the size dispersity to 5.4% 15 minutes later. Though the size dispersity remains relatively low for the remainder of the reaction, it increases slightly as the reaction proceeds. The maximum standard deviation of 1.1 nm in the first segment of the reaction increases to a maximum of 1.6 nm in the second segment of the reaction. In addition, there is another important difference in the growth rate of particles in the second segment with respect to the first. The t^{0.36} dependence of particle diameter observed in the first segment decreases to a t^{0.45} dependence in the second segment. The value of the exponent suggests that particle growth is surface reaction limited. This change in time dependence may simply reflect that there are not enough available sites at the particle surface to accommodate the additional monomer species in solution. This growth mode is generally not preferred in a limiting concentration of monomer species, since the Gibbs-Thomson effect results in a broadening of the size dispersity (Equation (1-25)). For the range of particle sizes shown here, this effect is not observed, most likely because the high supersaturation of monomer species in solution suppresses Ostwald ripening. Thus, increasing the precursor concentration appears to be a viable way to increase the maximum particle size for a given reaction time. In FIG. 38, the calculated growth trajectory is plotted with dashed lines to indicate the maximum particle size that might be expected for a given reaction time. At 400 minutes, the 0.33M precursor solution would produce particles 14% large than would be attainable using the 0.22M solution. FIG. 38 shows a growth curve of iron oxide nanoparticles as a 0.22M Fe solution is injected (blue) and then exchanged for a 0.33M Fe solution. Particle growth rate for the 0.22M Fe solution is slightly faster than that of the 0.33M Fe solution.

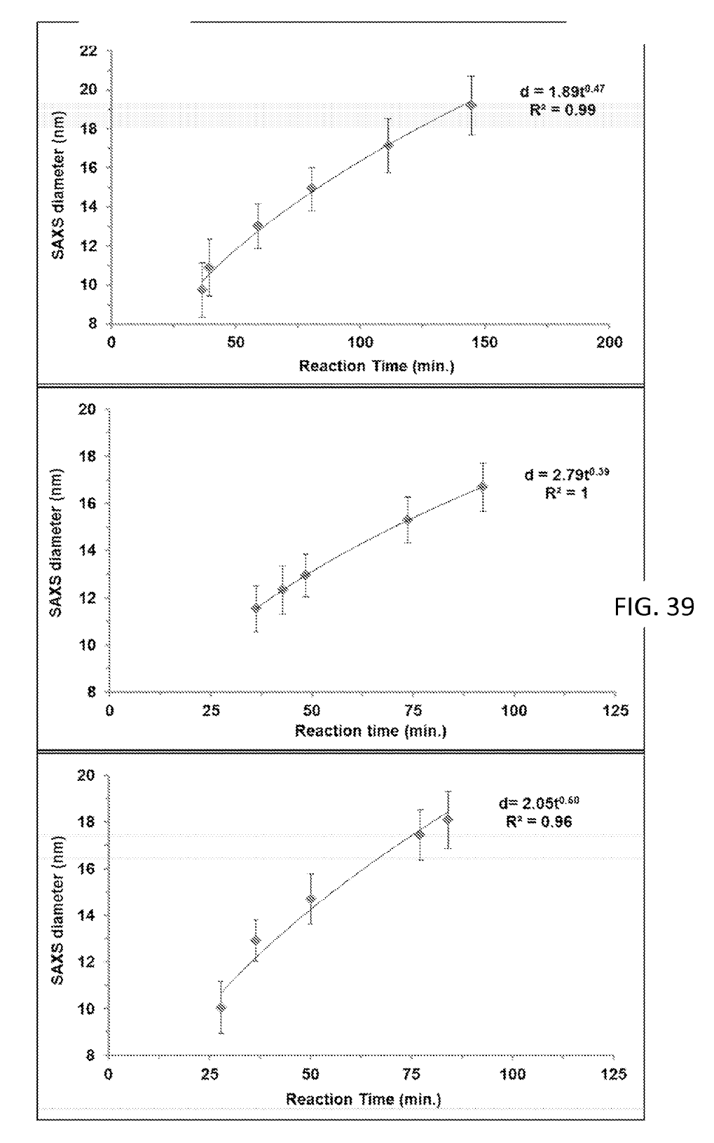

Nanoparticle growth with variable addition rate of iron(III) oleate. Rather than physically exchanging the iron precursor solution, which can be tedious and lead to irreproducibility in the synthesis, the effective iron concentration in solution can be more elegantly controlled by changing the injection rate. To test the effect of precursor addition rate on the corresponding growth rate of particles, a precursor solution containing 0.22M iron(III) oleate was added to the reaction flask in three separate reactions at 1.5 mL/hr, 3.0 mL/hr, and 6.0 mL/hr (Table 15 and FIG. 39). The first aliquot was drawn as close as possible to observed nucleation.

The initial particle size is approximately equivalent for each addition rate, but the data show that an increased addition rate ultimately results in the formation of larger particles within a given time after nucleation. For example, in the1.5 mL/hr addition, 15 nm particles are observed 40 minutes after nucleation. In the 3.0 mL/hr reaction, 15 nm particles are observed 38 minutes after nucleation, and in the 6.0 mL/hr reaction, approximately 15 nm particles are observed 22 minutes after nucleation.

TABLE 15

| | | | | | |
|---|---|---|---|---|---|
| | Reaction | Fe | SAXS | Standard | |
| Aliquot | Time | Injected | Diameter | Dev. | Size |
| number | (min.) | (mmol) | (nm) | (nm) | Dispersity |

1.5 mL/hr

| | | | | | |
|---|---|---|---|---|---|
| A1 | 23 | 0.10 | 11.42 | 1.04 | 9.1% |
| A2 | 43 | 0.11 | 13.71 | 1.12 | 8.2% |
| A3 | 63 | 0.16 | 15.06 | 1.14 | 7.6% |
| A4 | 90 | 0.22 | 16.78 | 1.11 | 6.6% |
| A5 | 103 | 0.31 | 17.51 | 1.05 | 6.0% |
| A6 | 127 | 0.40 | 18.67 | 1.06 | 5.7% |

3.0 mL/hr

| | | | | | |
|---|---|---|---|---|---|
| A1 | 36 | 0.20 | 11.53 | 0.97 | 8.4% |
| A2 | 43 | 0.24 | 12.32 | 1.04 | 8.4% |
| A3 | 49 | 0.27 | 12.94 | 0.91 | 7.0% |
| A4 | 74 | 0.41 | 15.31 | 0.96 | 6.3% |
| A5 | 92 | 0.51 | 16.69 | 1.02 | 6.1% |

6.0 mL/hr

| | | | | | |
|---|---|---|---|---|---|
| A1 | 28 | 0.31 | 10.04 | 1.12 | 11.2% |
| A2 | 36 | 0.40 | 12.92 | 0.89 | 6.9% |
| A3 | 50 | 0.55 | 14.69 | 1.09 | 7.4% |
| A4 | 77 | 0.85 | 17.45 | 1.08 | 6.2% |
| A5 | 84 | 0.92 | 18.08 | 1.23 | 6.8% |

The initial particle size is approximately equivalent for each addition rate, but the data show that an increased addition rate ultimately results in the formation of larger particles within a given time after nucleation. For example, in the1.5 mL/hr addition, 15 nm particles are observed 40 minutes after nucleation. In the 3.0 mL/hr reaction, 15 nm particles are observed 38 minutes after nucleation, and in the 6.0 mL/hr reaction, approximately 15 nm particles are observed 22 minutes after nucleation.

More can be revealed about the particular growth mode for each experiment by looking at the power law fit for the growth curves. The 3.0 mL/hr addition results in a growth curve with t^{0.39} dependence, while the 1.5 mL addition results in a slightly slower growth trajectory, with a t^{0.47} dependence. Both addition rates suggest a mix of diffusion limited and surface reaction limited particle growth, though the latter is far more pronounced for the 1.5 mL addition rate. In both cases, size focusing is observed, and the size dispersity in the range of sizes tested is very narrow. The 6.0 mL/hr addition rate still produces particles with narrow size dispersity, though the t^{0.50} dependence of particle size indicates surface reaction limited growth.

To summarize this data, increasing the addition rate increases the growth rate of the particles, but the maximum growth rate achievable for a given set of conditions only occurs when there is a t^{0.33} dependence, indicative of diffusion limited growth.

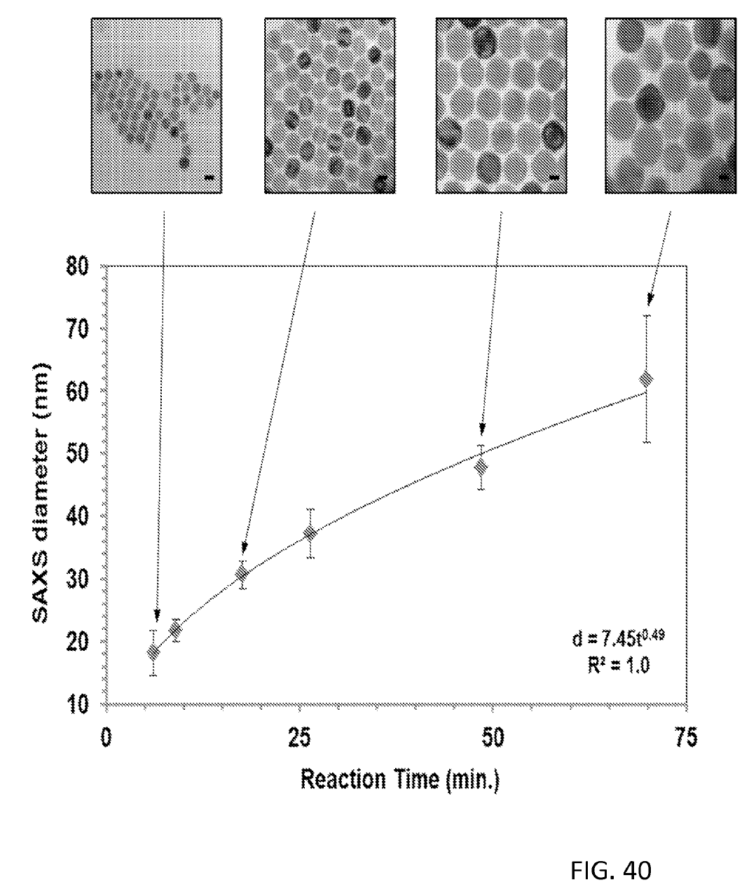

Nanoparticle growth in the absence of excess oleic acid. The slow, isotropic growth of uniformly sized spherical particles in the previous experiments may be due to the large excess of oleic acid. A 0.22M solution was injected into a heated reaction flask containing only 8.0 mmol docosane, the growth rate of particles dramatically increased, as shown in Table 16 and FIG. 40. FIG. 40 shows particle growth when no oleic acid is present in the reaction flask. Growth is very rapid compared to reactions in which a large excess of oleic acid is present. Scale bars on TEM images represent 20 nm.

TABLE 16

| | Reaction | Fe | SAXS | Standard | |
|---|---|---|---|---|---|
| Aliquot | Time | Injected | Diameter | Dev. | Size |
| number | (min.) | (mmol) | (nm) | (nm) | Dispersity |
| A1 | 6 | 0.07 | 18.12 | 3.66 | 20.2% |
| A2 | 9 | 0.10 | 21.77 | 1.89 | 8.2% |
| A3 | 18 | 0.19 | 30.64 | 2.18 | 7.1% |
| A4 | 26 | 0.29 | 37.15 | 3.86 | 10.4% |
| A5 | 48 | 0.53 | 47.76 | 3.53 | 7.4% |
| A6 | 70 | 0.77 | 61.91 | 10.09 | 16.3% |

Inset TEM images in FIG. 40 show an interesting trend as the particles grow. The particles from the first aliquot are approximately spherical, with a diameter of 18 nm and a high size dispersity of 20.2%. Within 3 minutes, the particle size increases to 21.77 nm, accompanied by a substantial reduction of size dispersity to 8.2%. Rapid growth of particles continues, but as the TEM image of the aliquot drawn at 18 minutes shows, the particles have assumed a slightly more cubic shape. These particles reach nearly 50 nm in diameter after just 48 minutes, with a relatively uniform shape and size dispersity. However, when the final aliquot is withdrawn 22 minutes later, the particle size dispersity has increased quite substantially. It is evident Ostwald ripening is dominating particle growth at this step, in spite of the continuous addition of precursor. It is possible that the monomer concentration in solution was not high enough sufficient to sustain growth of particles, and that Ostwald ripening became the dominant mechanism of growth in this limit. The overall growth trajectory of this reaction had a t^{0.49} dependence, suggesting surface reaction limited growth of the particles in this system. This study shows the importance of excess of oleic acid in the slow, controlled growth of spherical nanoparticles.

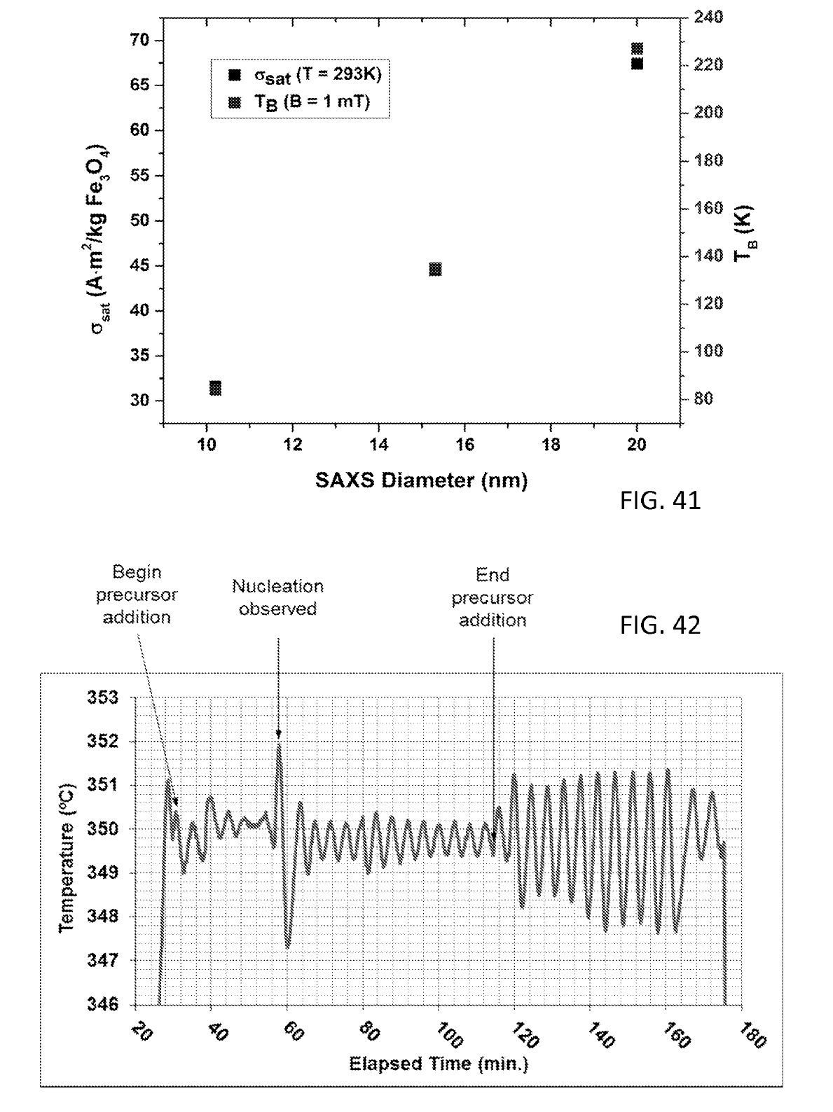

SQUID magnetometry was performed on three samples from the reaction plotted in 9: aliquot 1 (10.2 nm), aliquot 5 (15.3 nm) and aliquot 11 (20.0 nm). The σsat of the synthesized particles at 293K is co-plotted with the TB identified from ZFC/FC curves in FIG. 41. FIG. 41 shows σsat and TB for aliquot numbers 1 (10.21 nm), 5 (15.32 nm), and 11 (20.01 nm). Both properties increase with increasing particle diameter.

The measured σsat of the 10.21 nm particles is 31.6 A·m²/kg Fe3O4, increases to 44.5 A·m²/kg Fe3O4 for the 15.32 nm particles, and then 67.4 A·m²/kg Fe3O4 for 20.01 nm particles, 73% of bulk Fe3O4 at 293K, and many times larger than the σsat reported for similarly sized particles by Park et al. The trend observed here can be attributed to the increased surface area/volume ratio of small particles. Broken crystal symmetry at the particle surface and spin disorder introduced by ligand binding have an increasingly deleterious effect on the saturation magnetization. The blocking temperature, also a size dependent effect (Equation 1-29), increases with increasing from 84K for 10.21 nm particles, to 135K for 15.32 nm particles, and 227K for 20.01 nm particles.

Stable temperature control was demonstrated for the reactions performed here using a custom molten metal bath with PID control using a custom National Instruments interface. The temperature profile of a typical reaction is shown in FIG. 42. FIG. 42 shows temperature profile for a typical reaction with continuous addition of precursor. When the reaction temperature stabilized at the 350° C. set point, precursor addition began. Upon nucleation of particles, a rapid increase of temperature was observed. During the addition of the precursor, temperature variations were ˜1° C. or less. Following the termination of precursor addition, temperature fluctuations increased to ˜2° C. When the temperature of the reaction stabilized at the 350° C. set point, injection of the iron precursor was initiated. After a period of time, nucleation of particles occurred, causing instantaneous heating of the reaction solution by ˜2° C. The increase in temperature results in part from the decrease in the Gibbs free energy of the system following nucleation, but may result in part from the autocatalytic nature of the nucleation process. The temperature decrease following nucleation is the result of negative feedback from the temperature controller software, as it attempted to restore the reaction to the 350° C. set point. Within several minutes, the reaction temperature stabilized to within 1° C. of the set point for the remainder of the precursor addition. Once the precursor addition ended, the decreased thermal load caused increased oscillations of the reaction temperature from the set point. It was later discovered that tuning the maximum power settings at this point helped to dampen these oscillations. A significant improvement in temperature control is achieved using the custom molten metal bath with respect to the commercial instrument used previously that had oscillations of ±10° C. (FIG. 32).

We have demonstrated a robust approach to the synthesis of spherical iron oxide nanoparticles with narrow size dispersity using an iron(III) oleate precursor synthesized in situ. The novel preparation of the iron(III) oleate compound provides stoichiometric control over starting materials that cannot be achieved using conventional methods. Continuous addition of the precursor allows a broad range of particles sizes to be reproducibly synthesized, with a demonstrated span of 10-25 nm for the system in which oleic acid was present in excess. The true upper limit of this system has yet to be determined empirically, but is expected to be far greater than 25 nm. Using a large excess of oleic acid in the reaction solution, 3.0 mL/hr addition of a 0.22M iron(III) oleate solution consistently resulted in the production of uniformly spherical particles with a standard deviation not greater than 1.1 nm of the mean particle size for all sizes measured. These parameters were determined to be optimal for isotropic, diffusion limited growth of particles with very low size dispersity.

Modifying the iron concentration in the growth solution directly or increasing the addition rate of the precursor was demonstrated to influence the maximum particle size accessible within a given timeframe. Particles with low size dispersity were produced in all cases, although deviation from the conditions outlined above changed the growth trajectory to one associated with surface reaction limited, rather than faster, diffusion limited, particle growth.

The importance of a large excess of oleic acid was demonstrated for ensuring slow growth of spherical nanoparticles. In the absence of a large excess, rapid growth of large, slightly cubic particles were synthesized. With a constant addition rate, growth of the particles remained stable to nearly 50 nm in diameter. Beyond this point, iron addition was not sufficient to suppress Ostwald ripening processes that dominated further particle growth, resulting in a significant broadening of particle sizes.

Size dependent magnetic properties were determined for several particle sizes, with σsat values 73% of bulk values for 20 nm particles, further illustrating the high quality of particles produced using this method.

Though this system was designed for small scale reactions, it is amenable to scaling for enhanced product yield. The “Extended” LaMer mechanism described here can be widely applied to other thermolytic nanoparticle synthesis methods.

The ‘Hot Injection’ Method Using Anhydrous Iron Oleate. An anhydrous synthesis of the iron(III) oleate compound was developed to remove the variability in the stoichiometry of the compound that cause irreproducibility in magnetite nanoparticle synthesis. The conventionally prepared iron(III) oleate compound is affected by the presence of minuscule quantities of atmospheric water that result in the formation of polymeric complexes. These complexes are subject to dissociation and loss of iron material during subsequent washing steps. The ‘hot injection’ method, e.g., the rapid addition of the anhydrous precursor to a heated solvent, was used to evaluate the resulting synthetic reproducibility attainable with the anhydrous compound. The anhydrous iron(III) oleate was mixed with oleic acid to make it amenable to injection, although the use of a coordinating solvent was later thought to effect the reproducibility of this approach. The role of oleic acid on the nucleation and growth was demonstrated in experiments in which the concentration of oleic acid in solution was varied. Nucleation times and resulting particle sizes increased with increasing oleic acid concentration, while the size dispersity decreased. The present invention provides a new route to preparing stoichiometric iron(III) oleate and achieving size control in this system.

In Situ Generation of Iron Oleate for Synthesis of High Quality Iron Oxide Nanoparticles. The present invention provides for the formation of iron(III) oleate in situ following the decomposition of Fe(acac)3 in oleic acid through ex situ FTIR measurements over the course of a reaction. The present invention provides a route to producing iron(III) oleate using stoichiometric quantities of starting material. Spherical, 27 nm particles with 12% size dispersity were synthesized using an example embodiment. As-synthesized particles are composed of wüstite, a non-stoichiometric iron oxide that is not strongly magnetic. Conversion of the particles to magnetite was achieved by oxidation of the particles at moderate temperature under ambient conditions. Phase control of synthesized particles was demonstrated by enhanced magnetic saturation, measured to be 78% of bulk Fe3O4.

Exquisite Control of Particle Size Using the “Extended” LaMer Mechanism. The present invention provides a method for the synthesis of magnetite nanoparticles using the continuous addition of iron(III) oleate to a heated solvent solution. The iron(III) oleate used in the synthesis was prepared in situ, provides stoichiometric control over starting materials that cannot be achieved using conventional methods. Continuous addition of the precursor allows a broad range of particles sizes to be reproducibly synthesized, with a demonstrated span of 10-25 nm for the system in which oleic acid was present in excess.

Molten Metal Bath. The high temperatures used for our reactions necessitated the development of a new heating source that could maintain a stable set point temperature for a relatively small (<50 mL) reaction volume. For a reaction of this size, a heating mantle sized for a 100 mL flask would typically be used and coupled to a commercial PID temperature controller. A 100 mL capacity heating mantle has an 80 W output, and requires maximum power to reach temperatures in excess of 300° C. Maintaining a stable reaction temperature at 350° C. proved to be very challenging using the commercial controllers we tested, often resulting in large oscillations about the set point temperature. Considering that oleic acid boils at 360° C., large temperature fluctuations could not be tolerated, as they caused the reaction to boil over.

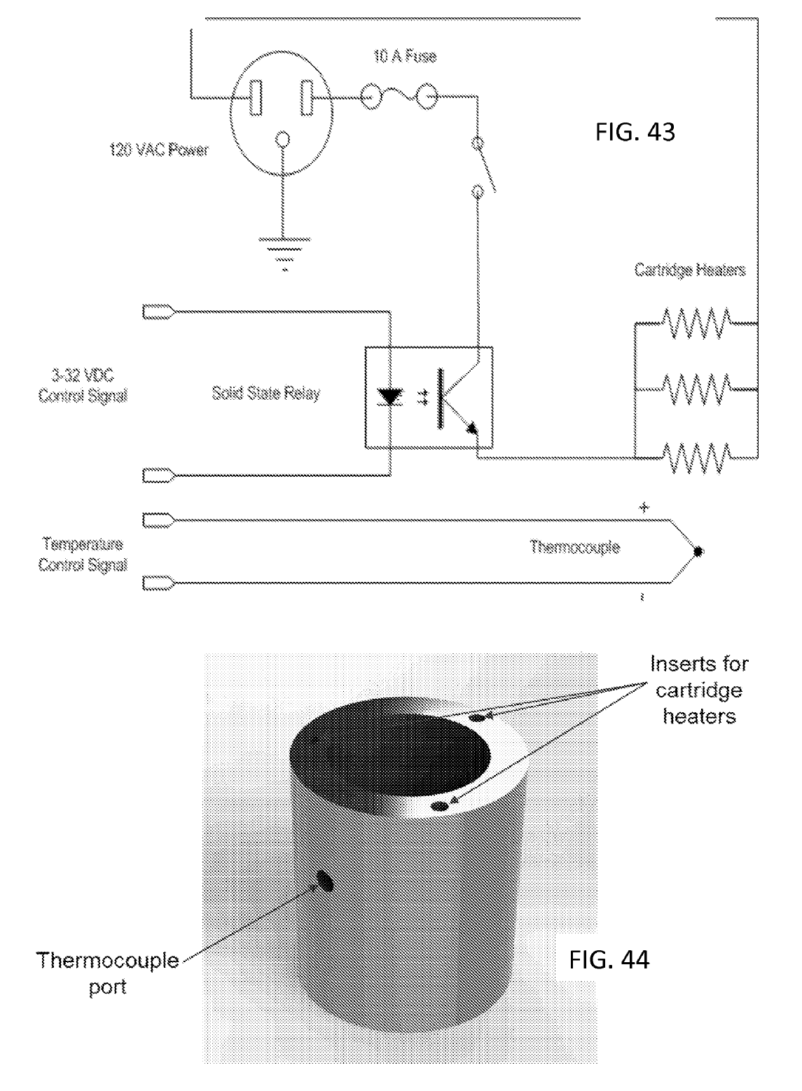

The device design presented here employs three cartridge heaters, with a combined output of 600 W, a significant increase over the maximum power attainable using a heating mantle. A control loop minimizes the difference between the reaction temperature and the set point by making adjustments in the power delivered to the cartridge heaters The improved tunability of the PID control and power settings in this system through a custom designed National Instruments interface provides superior control of reaction temperature over the commercial standard. FIG. 43 is a schematic drawing of heating source used for molten metal bath. Three cartridge heaters deliver a combined 600 W of power. FIG. 44 is an illustration of a brass heating block heated by three cartridge heaters. A low melting point alloy, Bolton 174F is contained within the core of block. The temperature of the alloy is measured with a thermocouple for feedback to the control software.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

What is claimed is:

1. A method of producing a metal carboxylate compound, comprising:
(a) combining an organometallic compound with a stoichiometric excess of fatty acid;
(b) heating the combination to a temperature sufficient to lead to thermal decomposition of the organometallic compound, until the metal carboxylate compound is formed;
(c) cooling the combination.

2. A method as in claim 1, wherein step (b) is performed under a nitrogen atmosphere.

3. A method as in claim 1, wherein step (b) is performed with vigorous stirring.

4. A method as in claim 2, wherein step (b) is performed with vigorous stirring.

5. A method as in claim 1, further comprising monitoring the temperature of the combination.

6. A method as in claim 5, further comprising controlling the temperature of the combination responsive to the monitored temperature.

7. A method as in claim 6, wherein the monitoring and control is performed continuously.

8. A method as in claim 7, wherein the monitoring and control is performed in real time.

9. A method as in claim 1, wherein the combination is heated to a temperature below the temperature at which the compound would undergo further decomposition.

10. A method of producing an organometallic compound, comprising producing a metal carboxylate compound according to the method of claim 1, and then producing the organometallic compound using the metal carboxylate compound.

11. A method of producing metal oxide nanoparticles, comprising producing a metal carboxylate compound according to the method of claim 1, and then producing the metal oxide nanoparticles using the metal carboxylate compound.

12. A method as in claim 11, further comprising monitoring and controlling the temperature of the compound continuously.

13. A method as in claim 11, wherein producing the metal oxide nanoparticles comprises continuous addition of the metal carboxylate compound until a desired nanoparticle size is attained.

14. A method as in claim 13, further comprising monitoring the size of the nanoparticles as the metal carboxylate compound is added.

15. A method as in claim 11, wherein the metal oxide nanoparticles comprise iron oxide nanoparticles.
